(19) United States
(12) Patent Application Publication
(10) Pub. No.: US 2010/0119993 A1
(43) Pub. Date: May 13, 2010

(54) DENTAL IMPLANT

(75) Inventors: Carl W. Schulter, Germantown, TN (US); Denis J. DiAngelo, Germantown, TN (US); Charles S. Sullivan, III, Germantown, TN (US); Andrew J. Schulter, Germantown, TN (US)

Correspondence Address: John Steckler Schwab, 44 N Yates Rd, Memphis, TN, 38120, US

(73) Assignee: CAGENIX, INC., Memphis, TN (US)

(21) Appl. No.: 12/268,517

(22) Filed: Nov. 11, 2008

(51) Int. Cl. A61C 8/00

(52) U.S. Cl. 433/173; 433/215

(57) ABSTRACT

An oral implant for mounting in a patient's maxilla or mandible is provided that includes an abutment and a fixture. The implants may be arranged in a system including two or more adjacent implants disposed in predetermined locations and bearing a predetermined locational relationship to each other.

### FIELD OF THE INVENTION

This invention relates to dental implants.

### BACKGROUND OF THE INVENTION

Dental implants are used as replacements for missing teeth. Implants are typically in the form of a fixture that is coupled to an abutment. The fixture portion of a dental implant is that portion which extends into the maxilla or mandible, where it is anchored in a bone in the maxilla or mandible. The fixture typically includes a top portion that extends out of the maxilla or mandible and provides an anchoring point for an abutment. The abutment portion of a dental implant is the portion that is fixed to the fixture and extends above the gingiva. It has an upper surface that is configured to receive and support a crown.

There are several common problems with such two piece dental implants. First, the bone into which they are inserted often does not bond (e.g. integrate) well with the implant, or, if bonded, degrades causing the implant to loosen over time.

Microgaps between the fixture and the abutment are one cause of this loss of bone. The fixture is often positioned within the maxilla or mandible such that its upper surface is below the gingiva. When an abutment is fixed to the fixture, there is a tiny gap between the abutment and the fixture that is at least partially disposed beneath the gingiva. This microgap becomes a haven or reservoir for oral bacteria. By cultivating oral bacteria so close to the fixture/bone junction itself, the gingiva may become irritated or infected, and the bond between the fixture and the maxilla or mandible weakened.

Loosening may also be caused by the poor distribution of forces from the implant to the maxilla or mandible. If the load is concentrated on a particular portion of the maxilla or mandible, this stress concentration may cause the bond between fixture and maxilla or mandible to weaken. Stress concentrations are typically caused by improper fixture design or positioning, or a fixture that is not shaped to distribute the tooth load relatively evenly.

Teeth are naturally designed to resist stress of chewing by their root shape, position and coronal contours. An implant that would closely simulate these same root and coronal contours and would best be surgically placed in the position of the natural tooth, should be the best design to prevent the noted clinical problems in implant dentistry. This new design would allow the bone and tissue contours to appear normal and prevent the loss of bone and tissue contours seen with the current implant systems. An enhanced esthetic and functional outcome could be realized by appropriately defining the shape, contours and position of a new implant design.

At times there are many or all of the teeth missing. Teeth work in harmony with each other by distributing chewing forces, by contouring the bone and tissue by their shape and outline form and by creating a mutually protected biological environment. When multiple teeth are lost, it compounds the mentioned problems. As the bone heals to the implant, it assumes the contour of the implant. If it is round, it will heal to a round shape, thus remodeling the bone to the shape of the implant. This remodeling is the main cause for loss of bone and tissue contours and implant stability. If we surgically place a number of adjacent implants, the bone remodeling is magnified because we have lost the adjacent teeth which helps keep the contours of the bone. Therefore, a implant system that individually and mutually helps to maintain the normal contours of the bone would be beneficial. This system of implants may have individual contours for each teeth that are replaced and as a group are beneficially related to each other in orientation. The system of implants should be positioned correctly from a mesial-distal, a facial-lingual and from an incisal/occlusal-cervical and have root contours similar to teeth. This new system will function to restore and maintain bone contours, stabilize the implant during chewing and restore esthetic tissue contours to the implants replacing the missing teeth. This new system would give the best opportunity to regain the normal biological response of natural teeth.

Another problem often encountered with implants is the failure of the crown that is attached to the abutment. Large loads placed on the crown when chewing cause the crown to fatigue and ultimately to fracture or fail. These large loads can also weaken the cement that bonds the crown to the abutment if the crown-to-abutment joint design unduly concentrates the load. Current abutment designs are shaped in a similar shape as the connecting fixture. If the fixture is round, the abutment is round with flat sides. In preparing a tooth for a crown a specific outline form of the preparation helps to distribute forces with proper retention and resistance form. Similarly an implant abutment should follow similar principles in creating proper outline forms for resistance and retention.

### SUMMARY OF THE INVENTION

In accordance with a first aspect of the invention, an oral implant for mounting in a patient's maxilla or mandible is provided, including an abutment having a longitudinal axis, the abutment having a first portion extending upward from a junction line and a second portion extending downward from the junction line; wherein the junction line defines the intersection between the first and second portions and extends circumferentially about the entire periphery of the abutment; wherein the first portion has a surface that extends about the entire periphery of the abutment, said surface terminating at the junction line, said surface further tapering inwardly in a direction extending upwardly from the junction line; and wherein the second portion has a surface that extends about the entire periphery of the abutment, said surface terminating at the junction line, said surface further tapering inwardly in a direction extending downwardly from the junction line; and a fixture having a longitudinal axis, the fixture being configured to be embedded in the patient's maxilla or mandible; wherein the fixture has a top surface with an aperture therein, said aperture extending downwardly into the fixture and tapering inwardly in a direction extending downwardly into the fixture.

The surface of the first portion of the abutment may taper inwardly at an angle of between 0.5 and 10 degrees with respect to the longitudinal axis and wherein the surface of the second portion of the abutment tapers inwardly at an angle of between 0.5 and 20 degrees with respect to the longitudinal axis. An inward angle of taper of both a mesial and a distal side of the first portion with respect to the longitudinal axis of the abutment may be between 0.5 and 6 degrees. An inward angle of taper of a lingual side of the first portion with respect to the longitudinal axis of the abutment may be between 6 and 8 degrees. An inward angle of taper of a facial side of the first portion with respect to the longitudinal axis of the abutment is between 6 and 8 degrees. An inward angle of taper of a facial side of the second portion with respect to the longitudinal axis of the abutment may be between 10 and 20 degrees. An inward angle of taper of a lingual side of the second portion with respect to the longitudinal axis of the abutment may be between 10 and 20 degrees. An inward angle of taper of both a mesial and a distal side of the second portion with respect to the longitudinal axis of the abutment may be between 0.5 and 10 degrees. The junction line may be higher on both the mesial side and the distal side than it is on both the lingual and facial sides. The top edge of the aperture may be between 0.0 and 1.5 mm from the junction line around substantially all the periphery of the abutment. The top surface of the fixture may extend laterally outward from the abutment a relatively constant distance of between 0.5 and 1.5 mm about the complete periphery of the fixture. The abutment may define a through hole extending through the abutment with a longitudinal axis coaxial with the longitudinal axis of the abutment. The through hole may have an internal shoulder axially disposed above a minima of the junction line and below a maxima of the junction line, wherein a threaded aperture is disposed at the bottom of the aperture in the fixture, and further wherein the implant further comprises a threaded fastener having a head abutting the shoulder and a threaded portion threaded into the threaded aperture. The second portion of the abutment may have a first plurality of nodes and the first portion of the abutment may have a second plurality of nodes and further wherein the first plurality of nodes may be aligned with the second plurality of nodes at the junction line. The first portion of the abutment may have a generally elliptical axial cross section and the second portion of the abutment may have a generally elliptical axial cross section. The major axes of the generally elliptical cross sections of both the first and second portions may extend in a lingual-facial direction. The junction line may have peaks disposed at the mesial and distal sides of the abutment and valleys disposed at the lingual and facial sides of the abutment. An angle between the first portion and the second portion on both a mesial and a distal side of the abutment may be between 115 and 180 degrees, and the angle may lie in a plane that includes the longitudinal axis. An angle between the first portion and the second portion on the lingual side of the abutment may be between 135 and 170 degrees, and the angle may lie in a plane that includes the longitudinal axis. An angle between the first portion and the second portion on the facial side of the abutment may be between 135 and 175 degrees, and the angle may lie in a plane that includes the longitudinal axis. The fixture may have a lower portion configured to be received in an osteotomy to a first depth, the lower portion defining at least one longitudinal groove extending substantially the entire length of the lower portion. The abutment may define a facial plane extending from the top of the abutment down a facial side of the abutment. The abutment may define a lingual plane extending from the top of the abutment down a lingual side of the abutment. The aperture of the fixture may have a bottom, and a threaded aperture may extend longitudinally into the bottom of the aperture, and the threaded aperture may have a flat bottom. The fixture may be threaded on its outer surface, having threads extending upward, said threads having an upper terminus below the flat bottom of the threaded aperture. A top surface of the fixture may define at least one maximum and at least one minimum, and a hole extending through the abutment may have an internal shoulder axially disposed above the at least one minimum of the top surface and below the at least one maximum of the top surface.

In accordance with a second aspect of the invention, a system of implants for implantation into a maxilla in a plurality of tooth apertures previously occupied by natural teeth is provided, the system including a first implant having a fixture with an upper surface defining a first mesial maximum, a first distal maximum, a first facial minimum, and a first lingual minimum; a second implant having a fixture with an upper surface defining a second mesial maximum, a second distal maximum, a second facial minimum, and a second lingual minimum; wherein the first implant is configured to be disposed in a first tooth aperture, wherein the second implant is configured to be disposed in a second tooth aperture, wherein the first tooth aperture is immediately adjacent to and mesial to the second tooth aperture, and further wherein the first and second implants are configured to be held in predetermined relative positions with respect to each other within their respective apertures when they are fixed in a maxilla.

The first implant may be configured to be received in a central incisor aperture, and the second implant may be configured to be received in a lateral incisor aperture when the first and second implants are in said predetermined relative positions. The first distal maximum may be higher than the second mesial maximum when the first and second implants are in said predetermined relative positions. The overall width in a facial-lingual direction of the first implant may be greater than the overall width in a facial-lingual direction of the second implant when the first and second implants are in said predetermined relative positions. The first implant may extend farther forward in a facial direction than the second implant when the first and second implants are in said predetermined relative positions. The overall width in a mesial-distal direction of the first implant may be greater than the overall width in a mesial-distal direction of the second implant when the first and second implants are in said predetermined relative positions. The first implant may extend farther in a lingual direction than the second implant when the first and second implants are in said predetermined relative positions. The first implant may be configured to be received in a lateral incisor aperture, and the second implant may be configured to be received in a cuspid aperture when the first and second implants are in said predetermined relative positions. The first distal maximum may be lower than the second mesial maximum when the first and second implants are in said predetermined relative positions. The overall width in a facial-lingual direction of the first implant may be less than the overall width in a facial-lingual direction of the second implant when the first and second implants are in said predetermined relative positions. The second implant may extend farther forward in a facial direction than the first implant when the first and second implants are in said predetermined relative positions. The overall width in a mesial-distal direction of the first implant may be less than the overall width in a mesial-distal direction of the second implant when the first and second implants are in said predetermined relative positions. The second implant may extend farther in a lingual direction than the first implant when the first and second implants are in said predetermined relative positions. An overall width of the first implant in the facial-lingual direction may be greater than an overall width of the first implant in the mesial-distal direction, and an overall width of the second implant in the facial-lingual direction may be greater than an overall width of the second implant in the mesial-distal direction when the first and second implants are in said predetermined relative positions.

In accordance to a third aspect of the invention, a system of implants for implantation into a maxilla in a plurality of tooth apertures previously occupied by natural teeth is provided, the system including a first implant having a fixture with an upper surface defining two first maxima, said first maxima being disposed on opposite sides of the implant along a mesial/distal axis, a first facial minimum and a second lingual minimum; a second implant having a fixture with an upper surface defining two second maxima, the second maxima being disposed on opposite sides of the implant along a mesial/distal axis, a second facial minimum, and a second lingual minimum; wherein the first implant is configured to be disposed in a first tooth aperture, wherein the second implant is configured to be disposed in a second tooth aperture, wherein the first tooth aperture is immediately adjacent to the second tooth aperture, and wherein the first and second implants are configured to be held in predetermined relative positions with respect to each other within their respective apertures when they are fixed in a maxilla.

The first implant may be configured to be received in a left central incisor aperture, and the second implant may be configured to be received in a right central incisor aperture when the first and second implants are in said predetermined relative positions. One of the first maxima may be adjacent to one of the second maxima and the two adjacent maxima may be at the same height when the first and second implants are in said predetermined relative positions. The overall width in a facial-lingual direction of the first implant may be the same as the overall width in a facial-lingual direction of the second implant when the first and second implants are in said predetermined relative positions. The first implant may extend the same distance forward in a facial direction as the second implant when the first and second implants are in said predetermined relative positions. The overall width in a mesial-distal direction of the first implant may be the same as the overall width in a mesial-distal direction of the second implant when the first and second implants are in said predetermined relative positions. The first implant may extend the same distance in a lingual direction as the second implant when the first and second implants are in said predetermined relative positions. Another of the first maxima and another of the second maxima may be disposed at different heights from said adjacent ones of said first maxima.

### BRIEF DESCRIPTION OF THE DRAWINGS

FIGS. 1-7 are perspective, top, right-side, front, left-side, rear and bottom views of a unitary right central mandibular incisor implant.

FIGS. 8-14 are perspective, top, right-side, front, left-side, rear and bottom views of a unitary right lateral maxillar incisor implant.

FIG. 15 is a cross-section of both of the implants of FIGS. 1-14 at any of cross-sections A-A, B-B, and C-C.

FIG. 16 is an alternative cross-section of any of the implants of FIGS. 1-14 showing a faceted outer surface and taking at sections A-A, B-B, and C-C.

FIG. 17 is a cross-section of either of the implants of FIGS. 1-14 taken at section line D-D.

FIG. 18 is a cross-section of any of the implants of FIGS. 1-14 taken at section line E-E.

FIG. 19A is a fragmentary front view of any of the implants of the foregoing figures showing how the flare angle measured at the sides of the implant increases as one travels upward along the shaft of the implant.

FIG. 19B similarly illustrates how the flare angle increases as one travels upward along the implant as measured on the front side of the implant.

FIG. 20 is a top view of any of the foregoing implants illustrating the narrow band having a Width that extends circumferentially around the entire implant.

FIG. 21 is a fragmentary rear view of any of the foregoing implants showing a local minima (low point) of the narrow band extending around the implant that is located on the center of the back side of the implant.

FIG. 22 is a fragmentary side view of any of the foregoing implants showing the local minima at the rear of the implant and a slightly higher local minima at the front of the implant, as well as the two imaginary planes 142 and 144 that define the front portion and rear portion of the narrow band.

FIG. 23 is a fragmentary front view of any of the foregoing implants showing the local minima at the front center of the implant.

FIG. 24 is a top view of any of the foregoing implants showing the numeral 3-node configuration of both the lower portion of the implant and the upper portion of the implant and also illustrating how each of the three (3) nodes of the upper portion of the implant are disposed immediately adjacent to each of the three (3) nodes of the lower portion of the implant.

FIGS. 25A-25D illustrate top, side, rear and bottom views of an alternative upper abutment portion of the implant that can be employed together with an alternative form of the lower portion of the implant shown in FIGS. 26A-26C.

FIGS. 26A-26C are top, side, and rear views of an alternative lower portion of the implant that may be coupled together with the upper portion shown in FIGS. 25A-25D to form a two-piece implant having the identical structure, configuration, arrangement, dimensions, features, and capabilities as the implants described in the foregoing FIGURES with one (1) difference: the implant is made of two pieces coupled together by a cylinder extending downward from the upper portion in FIGS. 25A-25C into the cylindrical recess shown in FIGS. 26A-26C.

FIG. 26D is a partial cross-sectional left side view of the implant formed by coupling the implant upper portion or abutment of FIG. 25A-25D and the implant lower portion illustrated in FIGS. 26A-26C in which a cylindrical portion of the upper portion extending downward therefrom is received in a matching cylindrical hole in the top of the lower portion shown in FIGS. 26A-26C held together by a screw recessed into the top of the upper portion, extending through the upper portion, and threadedly engaged with mating internal threads disposed in the upper part of the lower portion of the implant.

FIG. 27 is an alternative cross-sectional profile of the cylinder of the upper portion of the implants in FIGS. 25A-25D and the cylindrical hole in the lower portion of the implant shown in FIGS. 26A-26C illustrating a triangular sharp-edged protrusion that extends the length of the cylinder in place of the existing protrusion 214 and corresponding recess or slot 190.

FIG. 28 illustrates an alternative cross-section of the cylinder and cylindrical hole of the foregoing figures showing the protrusion and recess as a three-sided trapezoidal shape.

FIG. 29 is yet another alternative profile of the cylinder and cylindrical recess of foregoing figures showing the protrusion and slot as a rectangular (for example square) shape extending outward from the cylinder.

FIG. 30 illustrates an alternative profile of the cylinder and cylindrical hole in the foregoing figures in which the protrusion and recess of those figures has been removed and the cylinder (and cylindrical hole) faceted with longitudinally extending facets that extend the length of the cylinder and cylindrical hole. Facets shall mean flat planar surfaces.

FIG. 31 is an alternative profile of the cylinder and cylindrical hole in the foregoing figures showing the position of the protrusion and the slot reversed: the cylinder extending downward from the upper portion of the implant has a hemispherical slot and the cylindrical hole in the lower portion of the implant has an inwardly extending hemispherical protrusion.

FIGS. 32-45 illustrate the upper portion and the lower portion of a two-piece implant intended to be used in place of an upper cuspid having the same mating construction as that described above with regard to FIGS. 25-31 wherein FIGS. 32-38 are perspective, top, right-side, front, left-side, rear, and bottom views of the upper portion of the implant and FIGS. 39-45 are perspective, top, right-side, front, left-side, rear, and bottom views of the lower portion into which the upper portion is inserted.

FIGS. 46-59 illustrate the upper and lower portion of a two-piece implant intended for use as a lower cuspid in which FIGS. 46-52 are perspective, top, right-side, front, left-side, rear, and bottom views of the upper portion of the implant and further wherein FIGS. 53-59 are perspective, top, right-side, front, left-side, rear and bottom views of the lower portion of the implant.

FIGS. 60-73 illustrate the upper and lower portions of a two-piece implant intended for use as a first lower pre-molar, wherein FIGS. 60-66 are perspective, top, right-side, front, left-side, rear and bottom views of the upper portion of the implant and FIGS. 67-73 are perspective, top, right-side, front, left-side, rear and bottom views of the lower portion of the implant.

FIGS. 74-87 illustrate an alternative two-piece implant intended for use as a first upper pre-molar implant, in which FIGS. 74-80 illustrate perspective, top, right-side, front, left-side, rear and bottom views of the upper portion of the implant and FIGS. 81-87 illustrate perspective, top, right-side, front, left-side, rear, and bottom views of the lower portion of the implant.

FIGS. 88-101 illustrate the upper and lower portions of a two-piece implant intended to replace a lower molar, in which FIGS. 88-94 illustrate perspective, top, right-side, front, left-side, rear, and bottom views of the upper portion of the implant and FIGS. 95-101 illustrate perspective, top, right-side, front, left-side, rear, and bottom views of the lower portion of the implant.

FIGS. 102-115 illustrate an alternative two-piece implant intended to be used as an upper molar, wherein FIGS. 102-108 are perspective, top, right-side, front, left-side, rear, and bottom views of the upper portion of the implant and FIGS. 109-115 illustrate perspective, top, right-side, front, left-side, rear and bottom views of the lower portion of the implant.

FIGS. 116-130 illustrate an abutment and fixture of an alternative two-piece implant configured for use to replace a lateral #7 incisor. An identical but mirror image two-piece implant (not illustrated) is configured for use to replace a lateral #10 incisor.

FIGS. 131-146 illustrate an abutment and fixture of an alternative two-piece implant configured for use to replace a central #8 incisor. An identical but mirror image two-piece implant (not illustrated) is configured for use to replace a central #9 incisor.

FIGS. 147-162 illustrate an abutment and fixture of an alternative two-piece implant configured for use to replace a #6 cuspid. And identical but mirror image two-piece implant (not illustrated) is configured for use to replace a #11 cuspid.

FIGS. 163-164 are left side cross-sectional and rear views (respectively) of the two piece implant of FIGS. 116-130 in assembled form with a fastener holding the components together.

FIGS. 165-166 are left side cross-sectional and rear views (respectively) of the two piece implant of FIGS. 131-146 in assembled form with a fastener holding the components together.

FIGS. 167-168 are left side cross-sectional and rear views (respectively) of the two piece implant of FIGS. 147-162 in assembled form with a fastener holding the components together.

FIGS. 169-171 are facial, bottom and lingual views, respectively, of a fragmentary portion of a maxilla with a plurality of implants in accordance with the present invention.

### DETAILED DESCRIPTION OF THE INVENTION

In the discussion below, the applicants describe a dental implant that is inserted into prepared holes in a mandible or maxilla. To describe several features of the implant, the Applicants use several terms that are here defined or described.

“Up” used herein with reference to teeth, implants, fixtures, or abutments, refers to the direction generally parallel to the longitudinal axis of the implant or tooth and extending away from the bone in which it is intended to be implanted (i.e. away from the root and toward the crown).

“Down” is the direction opposite to “up” (i.e. away from the crown and toward the root).

A “side”, as used with reference to teeth, implants, fixtures, or abutments, refers to the portions of the tooth or implant facing the adjacent teeth or implants when the tooth, implant, fixture, or abutment is embedded in the mandible or maxilla. The side surfaces of teeth or implants directly face the adjacent teeth or implants.

A “side” can be either “mesial” or “distal” depending upon whether the side faces toward the dental mid-line or away from the dental mid-line, respectively.

“Front” when used with reference to a tooth, implant, fixture, or abutment refers to the portion that faces outward away from the maxilla or mandible and may also be referred to as “facial” or “buccal”.

“Rear” when used with reference to a tooth, implant, fixture, or abutment refers to the portion that faces the inside of the mouth and may also be referred to as “lingual”.

The term “CEJ” or “cement-enamel junction”, is the line on a tooth defined by the junction of the enameled upper portion and the cementum of the root. It extends around the surface of the tooth generally perpendicular to the longitudinal axis of the tooth and is generally oval in shape. Since the upper portion of a tooth is covered with enamel, the CEJ typically extends around the outer surface of the tooth at the lowest extent of the enamel. If the tooth is eroded, however, the cementum and enamel may not be in contact and therefore the location of the CEJ may be unclear.

The term “CRJ” or “coronal-root junction” refers to the junction between the coronal portion and the root portion of a tooth. It extends around each tooth in a generally oval shape, and is a little higher on the sides of the tooth than on the front or back of the tooth.

A “facial CRJ line” (also “frontal CRJ line”) refers to an imaginary line extending across the face of a mandible or maxilla that passes through the front and lowermost portion of the CRJ of each tooth or implant in the mandible or maxilla. Since the mandible and maxilla each have a row of teeth, there are two facial CRJ lines—one wrapping around the outside of maxilla and one wrapping around the outside of the mandible.

A “lingual CRJ line” (also “rear CRJ line”) refers to an imaginary line extending across the face of a maxilla or mandible that passes through the rear and lowermost portion of the CRJ of each tooth or implant in the maxilla or mandible. Since the maxilla and mandible each have a row of teeth, there are two lingual CRJ lines—one extending along the inside of the maxilla and one extending along the inside of the mandible.

The “center” a two dimensional shape, such as cross-sections of the various implants described herein, shall mean the location on that two-dimensional body where the first moment of area equals zero.

The “mirror plane” that term is used herein is a plane that extends vertically through the implant from top to bottom, and extending front-to-back from the lingual side to the facial side of the implant. Each illustrated implant has a mirror plane.

The description below is of the dental implants that in whole or in part embody the invention described in the claims following this detailed description. In the discussion below, we explain several features and benefits of the dental implants—features and benefits that may or may not be incorporated in the device or methods described in the following claims.

The implants illustrated and described herein are all configured for use on the right side of the mandible and maxilla. The claims are intended to cover not only implants on the right side, but those on the left side as well. Non-illustrated implants for the left side of the mandible and maxilla are identical in construction to those on the right side, but are in mirror image form in the same manner as human teeth on one side of the mouth are mirror images of teeth on the opposite side of the mouth.

The features, capabilities and construction of each implant on the left side of the mouth (being of identical mirrored construction to those on the right side) are identical to the corresponding implant on the right side of the mouth.

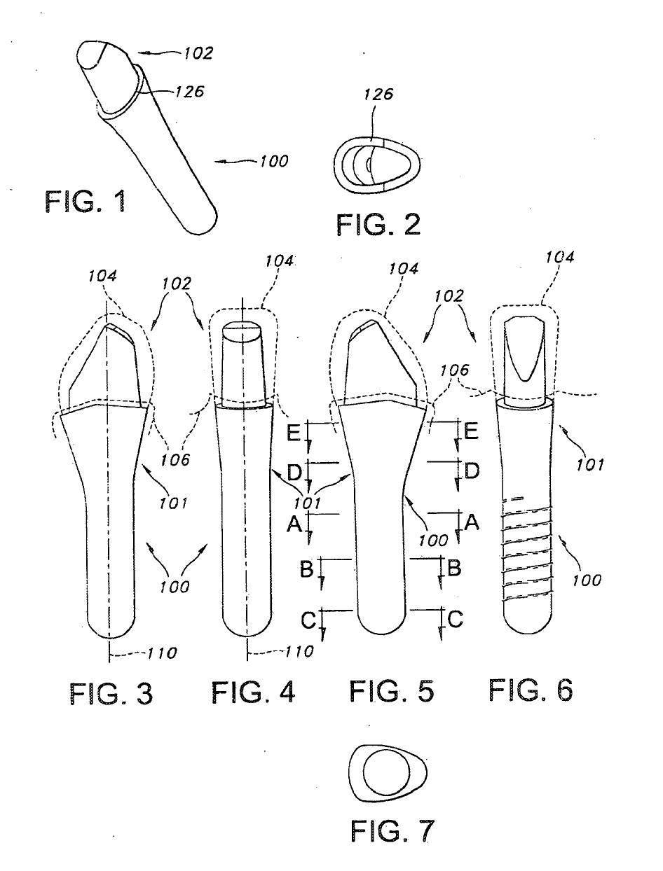

FIGS. 1-7 illustrate a dental implant. The implant is a generally elongate member, with a lower portion or fixture 100 that is configured to be embedded or implanted in a maxilla or mandible, and an upper portion or abutment 102 that extends out of the maxilla or mandible and provides a structure on which a dental prosthesis 104 such as a crown, (colloquially called a “cap” and illustrated in FIGS. 3-6), bridge or framework can be attached.

In the embodiment shown here, the crown 104 (which is illustrated as a dashed line) surrounds the upper portion of the implant, providing a smooth outer surface to simulate a natural tooth. The crown 104 extends above the marginal gingiva 106 (dashed) and for example slightly below the marginal gingiva.

Dental implants are generally provided either in one or in two pieces. By “one piece,” mean that the implant is a single integral body that is made to be implanted in a maxilla or mandible as a single unit, with an upper portion extending upward away from an out of the gingiva.

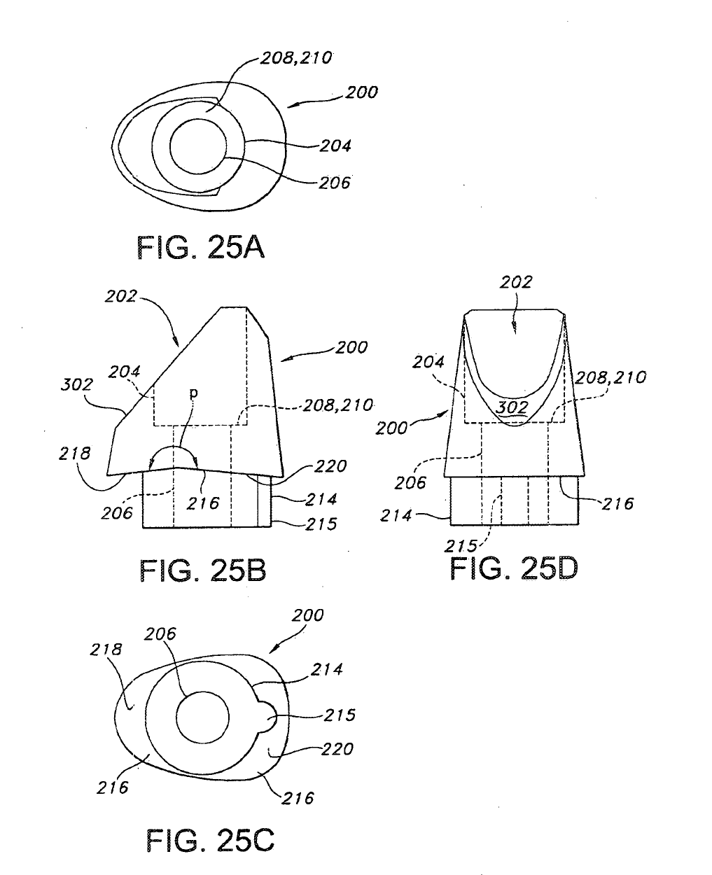

A two-piece implant, such as those shown in FIGS. 25A et. se. is made of two portions, the upper portion being generally referred to as the abutment and the lower portion being generally referred to as the fixture. In a two-piece implant, the abutment and fixture are coupled together, typically by a threaded fastener, and typically after the fixture has been implanted.

A “fixture” includes at least that portion of a dental implant that is inserted into a maxilla or mandible, or otherwise embedded in bone when in use. An “abutment” includes at least that portion of a dental implant that is configured to be coupled to and support a crown. Of course, there are combined fixtures and abutment arrangements in which the fixture and abutment are formed as a single unit. Examples include the one-piece implants illustrated in FIGS. 1-24. Thus, the terms “abutment” and “fixture” should not be interpreted as requiring a single piece dental implant.

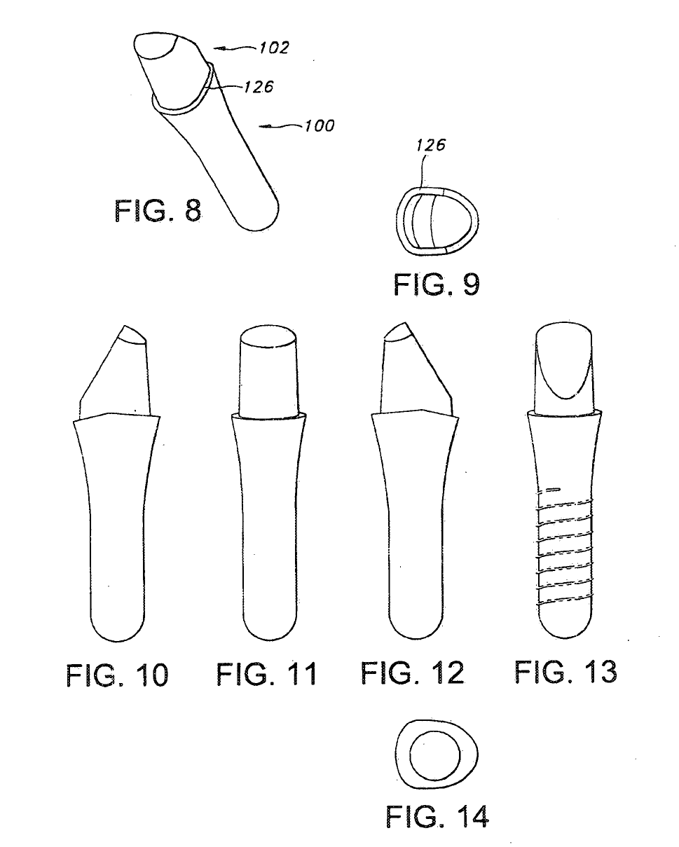

The implant of FIGS. 1-7 is a single piece implant, having an integrated abutment and fixture. It is intended for use as a lower central and lateral incisor. A similar single piece implant can be seen in FIGS. 8-14. It is intended for use as an upper lateral incisor. The description herein regarding the implant of FIGS. 1-7 applies equally to the implant of FIGS. 8-14 except where specifically noted as being applicable only to the implant of FIGS. 1-7 or the implant of FIGS. 8-14.

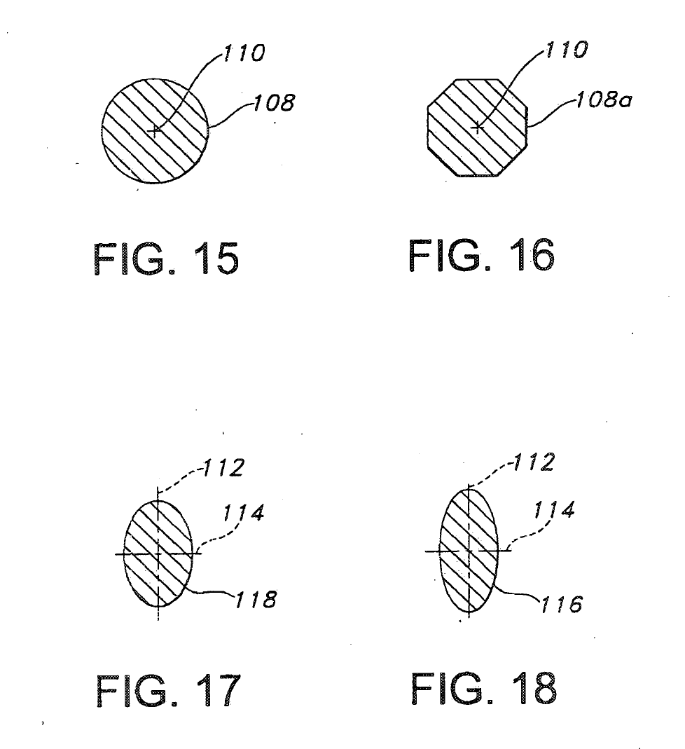

FIG. 15 illustrates cross-sections of the fixtures or lower portions 100 of the implants FIGS. 1-15 taken at cutting lines A-A, B-B, and C-C. These sections are sections through the lower portion 100 of the fixture. The cross-sectional shape 108 as shown in FIG. 15 is circular. Each section in the lower portion of the fixture may have the same diameter or the same cross-sectional area. The lower section of the fixture and between cutting lines A-A, B-B, and C-C can have an irregular cross section, however, such as an oval or a polygon. The polygonal shape can be regular or irregular. The polygonal shape can have radiused corners. The polygon can be an convex or concavo-convex polygon. FIG. 16 illustrates a regular convex polygon and cross-section 108A having ten sides. The number of sides is not critical, however, although a range of between 6 and 15 would be beneficial.

There are advantages to using a fixture with a polygonal lower portion: when a fixture having a polygonal outer surface is inserted into a hole drilled into maxilla or mandible to receive the fixture, the gaps between the outer surface of the polygon and the circular drilled hole in which the fixture is inserted can be filled with a bone growth enhancer, autograft, allograft, or cement, for example. If the material is cement, it may help bond the fixture to the bone in which it is inserted. If the material is a bone growth enhancer, it may encourage bone growth between the fixture and the bone in which it is inserted, thereby providing more rapid healing and a better bond between the fixture and the bone in which it is inserted. Alternatively, the hole may be made by or profiled by an osteotome which may have an outer profile similar to the outer surface of the fixture. In this alternative method, a drill may be used to make the initial hole and the hole may then be expanded and profiled by inserting the osteotome straight down into the hole.

The implants of FIGS. 1-14 have a longitudinal axis 110 that extends generally up-and-down through the length of the fixture (or lower portion 100) and through the abutment (or upper portion 102) as well. This axis is defined as a line as close to the center of mass of the lower portion of the fixture as possible. In at least some of the embodiments shown here, the cross-sections A-A, B-B and C-C are circular, and the longitudinal axis 110 goes through the center of the circular cross-sections. Were the cross-sections irregular, the longitudinal axis would pass through each cross section as close as possible to the real center of the cross sections as possible.

One can see from FIGS. 15 and 16 that the longitudinal axis 110 goes through the center of each cross section. This indicates that in one embodiment, the lower portion 100 is not bent or curved, but is substantially straight (although the outer surface may taper in the shape of a flaring horn) along the length of the longitudinal axis such that the longitudinal axis extends through the center of all the cross-sections of the lower portion of the fixture 100.

FIGS. 17 and 18 are cross sections of the upper portion of the fixture 100. Note that the cross-sections may be not circular but extend irregularly, being narrower about one axis 112, than about axis 114. The cross-sections of FIGS. 17 and 18 have the general cross-sectional shape of an ellipse. They also may be slightly flattened at one end of the major axis 112 to more accurately represent the profile of an incisor. Elliptical cross-section 116 (FIG. 18), the upper cross section E-E of FIG. 5 is larger in area and has a more distinct elliptical shape than elliptical cross-section 118.

If one compares the lower circular cross-section 108 (i.e., A-A, B-B, and C-C) with elliptical cross-sections 118 and 116, it is clear that the higher one moves up the fixture, the more elliptical and less circular the fixture becomes. Thus, the elliptical cross-section 118 shown in FIG. 17 is more elliptical than the circular cross-section 108 shown in FIG. 15 and the elliptical cross-section 116 shown in FIG. 18 is more elliptical than the elliptical cross-section 118 shown in FIG. 17.

The more elliptical a cross-section of an ellipse is, the greater the major/minor axis length ratio of that ellipse as compared to another ellipse. For example, the major/minor axis length ratio of the ellipse 116 of FIG. 18 is greater than the major/minor axis ratio of the ellipse 118 of FIG. 17, which in turn is greater than the major/minor axis ratio of the circle of FIG. 15. The ratio of FIG. 15 is unity, since the cross-section shown in FIG. 15 is a circle.

Note that the major/minor axis ratio of FIG. 17 (1.05-1.25) is between that of FIG. 15 (about 1.000) and FIG. 18 (about 1.15-1.30). By providing a gradually increasing ellipticality (i.e. increasing major/minor axis ratio) as one progresses from the lower portion of the fixture to the upper portion of the fixture, the load provided by the abutment can be more equally distributed to the lower portion of the fixture and then to the mandible or maxilla.

One benefit to the increasing outward taper as one approaches the top of the fixture is that it more accurately represents the shape of a tooth at the equivalent height above the jawbone. Incisors, for example, have generally elliptical cross-sections at a height that corresponds to the height of section E-E (FIG. 18).

By shaping the cross-section of the upper portion of the fixture as closely as possible to the cross-section of the real tooth that it replaces, the maxilla or mandible and the abutting mucosal tissue will better surround the implant in a contour that more closely resembles the bone contour of a natural, undamaged when the bone heals.

Furthermore, by helping the bone and tissue contour to regenerate closer to its natural shape, the gingiva which covers the bone will more closely imitate the original gingiva giving the patient a smile that is more regular, lifelike, and symmetric.

If the upper portion 101 of the fixture 100 is circular in cross-section, it is believed that bone will not heal along the natural bone contour. This could make the bone-to-implant junction weaker, and the gingiva more asymmetric and displeasing to the eye. By making the width of the upper portion of the fixture narrower in the interproximal direction, a gap is provided on either side of the fixture that gives the gingiva more room to grow between adjacent teeth or fixtures and to better surround the base of the tooth.

While the upper portion 101 of the fixtures 100 of FIGS. 1-14 may have this irregular cross-sectional shape wider in the facial-lingual direction and narrower in the mesial-distal direction (see FIGS. 17 and 18), it should be understood that an irregular shape is not essential. Indeed, any cross-sectional shape, such as the circular and regular polygonal shapes described above as possibilities for the lower portion of the fixture (see FIGS. 15 and 16) are equally useful for the upper portion 101 of the fixture as well.

As we have shown, the lower portion of the fixture 100 may be circular and has a constant cross section as one moves up the fixture. The upper portion 101 of fixture 100 has a cross-section that may be non-circular and elongate in a fore-and-aft direction. The cross-sections of the upper portion 101 of the fixture 100 may be elliptical and may increase in cross-sectional area and irregularity (or out-of-roundness) as one moves up the upper portion of the fixture.

The cross-sectional area of each successive cross-section of the upper portion of the fixture may increase and make the fixture surface flare outward. This gives a greater and greater flare angle the farther one goes upward along the upper portion 101 of the fixture 100.

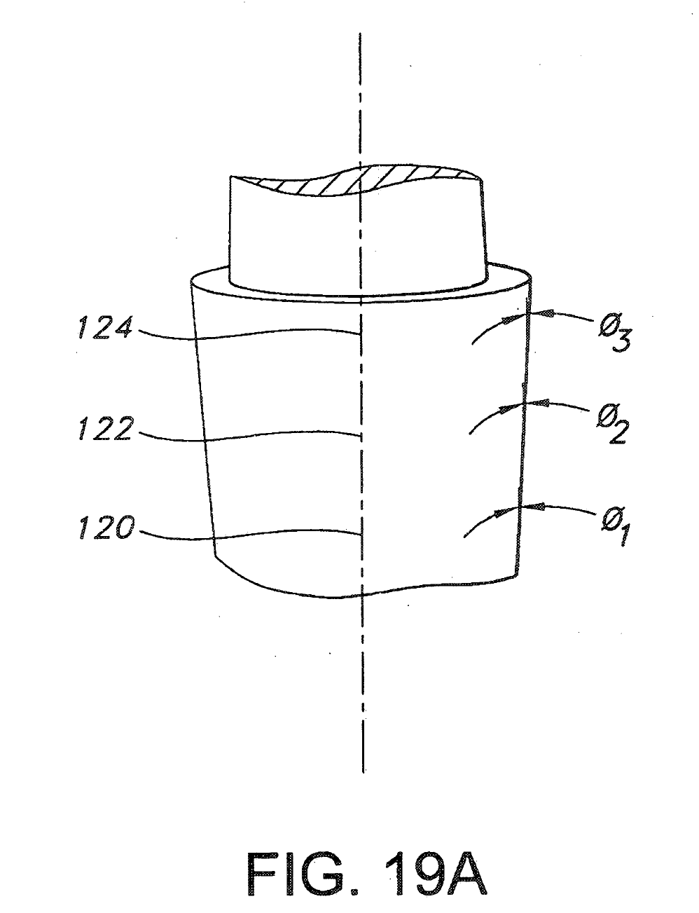

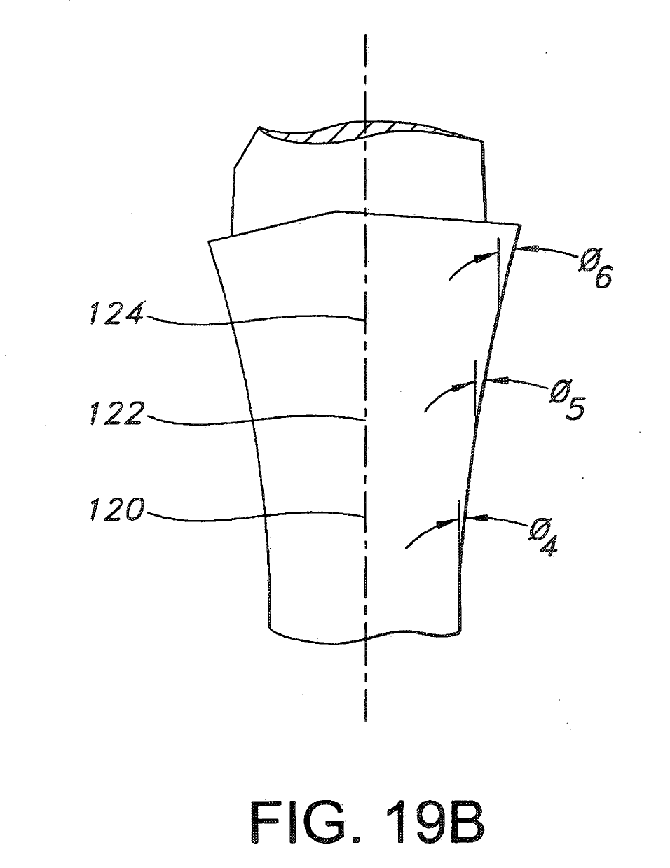

By “flare angle” mean the angle between the longitudinal axis of the fixture and a line segment tangent to the surface of the fixture, wherein the line segment tangent lies in the same plane as the longitudinal axis of the fixture. The further up the upper portion of the fixture one goes, the greater the flare angle. As one moves up the fixture, the outer surface or wall of the fixture increases its angle with respect to the longitudinal axis or increasingly flares away from. FIGS. 19A and 19B illustrate this. FIG. 19A is a partial front and FIG. 19B is a partial side view of the implant of FIGS. 1-7 showing the upper portion of the fixture. In FIG. 19A, the flare angle of the outer surface or wall of the fixture is shown in three (3) locations 120,122, and 124 along the longitudinal axis, where location 122 is above location 120 and location 124 is above location 122.

The flare angle Ø at position 120 may be between 1 and 3 degrees. Traveling up the upper portion 101 of the fixture, the flare angle Ø at position 122 may be 2 and 5 degrees. Traveling even further up the upper portion of the fixture, the flare angle Ø at position 124 may be between 4 and 8 degrees.

Referring now to FIG. 19B, the flare angle between the front wall of the upper portion of the fixture and the longitudinal axis is illustrated.

The flare angle Ø at location 120 may be between 3 and 8 degrees. The flare angle Ø at location 122 along the longitudinal axis may be between 6 and 12 degrees. The flare angle Ø at location 124 along the longitudinal axis of the fixture may be between 10 and 25 degrees. The flare angles of the back wall of the fixture are similar to those of the front wall at each location 120, 122, and 124 flare angle at the front and back of the fixture is greater than the flare angles at each side of the fixture.

Another characteristic of the fixture is the increasing irregularity of its cross sections as one moves up along the upper portion of the fixture. For example, the cross-section shown in FIG. 15 is regular: a circle. The cross-sections shown in FIGS. 17 and 18 are less regular and more elliptical, with their area distributed farther from the center (or centric) of the area of the lower cross-sections A-A, B-B, C-C (FIGS. 15 and 17).

Another characteristic of the fixture is the increasing normalized second moment of area of each of the fixture's successive cross-sections about the centroid of each said successive cross-section, as one progresses from cross-sections at the bottom of the upper portion of the fixture to and through successive cross-sections near or at the top of the upper portion of the fixture.

The second moment of an area (such as the cross-sections through the fixture) about a centric of that area is the sum over the entire area of each constituent infinitesimal area times the square of the distance of that infinitesimal area from the centroid of the overall area. In this case, the second moment of area is calculated about an axis that passes through the centroid of the cross-sectional area and is parallel with the longitudinal axis of the fixture. A normalized second moment of a (cross-sectional) area is the second moment of that (cross-sectional) area divided by the second moment of a circular disk having the same area as that (cross-sectional) area.

By this definition, the normalized second moment of the cross-sectional area of FIG. 15 is one (1.0) since the actual cross-section of FIG. 15 is a circular disk, and the longitudinal axis passes through the center. The normalized second moment of area of the circular cross-section 108 is the second moment of a circle having the area of cross-section 108 divided by the second moment of a circle of the same area. The illustrated cross-sections A-A, B-B, and C-C are already circles, the numerator and the denominator are the same, and therefore the ratio of second moments is one, regardless of the actual area of the circular cross-section of FIG. 15. By extension (1.0), the normalized second moments of area of the cross-sections of FIGS. 17 and 18 are greater than one (1.0). Furthermore, the normalized second moment of area of the cross-section of FIG. 18 is greater than that of the cross-section of FIG. 17.

By increasing the second moment of area in successive cross-sections of the upper portion of the fixture, loads placed on the abutment can be more effectively distributed and transferred to the bone that surrounds the lower portion of the fixture.

The normalized second moment of area may increase as one moves upward through successive cross-sections of the upper portion of the fixture, as explained immediately above. This increase in normalized second moment may be continuous and unbroken as one moves upward through the fixture. By “continuous and unbroken” it is meant that successive cross-sectional areas of the upper fixture's cross-sections meet the requirement that their normalized second moment (as described above) is greater than the normalized second moment of the cross-section immediately below, and is smaller than that of the cross-section immediately above.

Another characteristic of a possible embodiment of the fixture is that the flare angle of its walls changes at different rates depending upon circumferential position around the longitudinal axis where that flare angle is measured.

FIGS. 19A and 19B show how the outer surface of the fixture flares at four different locations around its periphery at three successively higher longitudinal positions 120, 122, and 124. Note that the flare angle increases at different rates depending upon the location around the periphery or circumference of the fixture. The term “rate of flare” used here means the rate at which the flare angle increases per unit of distance traveled upward along the longitudinal axis of the fixture. In FIG. 19A, the flare angle of the side walls of the upper portion of the fixture, change from Ø1 equals 2 degrees at location 120 to Ø2 equals 3.5 degrees at location 122. This gives a rate of increase of the side wall flare angle of 1.5 degrees over the distance traveled from location 120 to location 122. In FIG. 19B, at location 120, the flare angle is Ø4 equals 4.5 degrees and at location 122, the flare angle is Ø5 equals 9 degrees. The rate of change of the flare angle as one travels from location 120 to location 122 along the longitudinal axis of the fixture is 9 degrees minus 5.5 degrees or 3.5 degrees. This is greater than the 1.5 degrees increase in flare angle measured along the side wall of the fixture as shown in FIG. 19A. Locations 120, 122 and 124 are spaced equally far apart. Thus, depending on one's position around the periphery of the upper portion of the fixture at a particular position along the longitudinal axis, the flare angle varies and the rate of change of the flare angle (the rate of flare) varies as well.

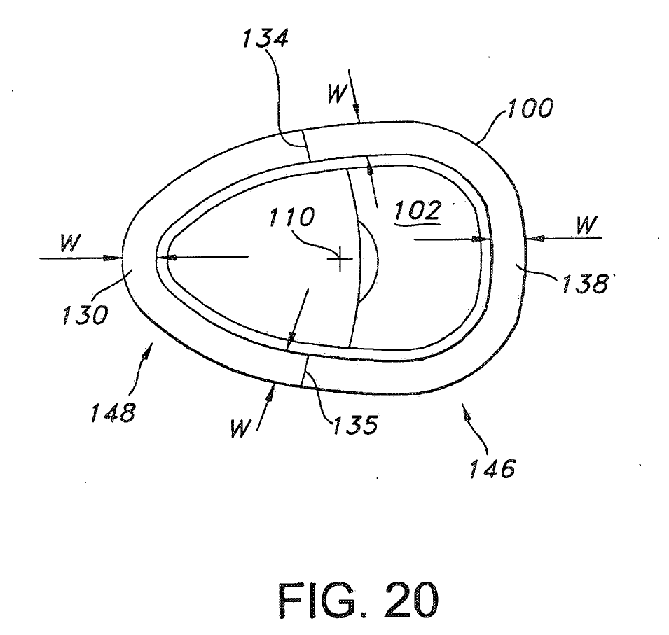

FIGS. 2 and 9 are top views of the fixtures of FIGS. 1-14 showing how the tops of the fixtures may extend radially outward away from the base of the abutment, may face upward and define a narrow band 126 that extends outward away from the lower portion of the abutment and generally perpendicular to axis 110. This narrow band 126 may be not circular in plane view, but instead has an irregular outer profile such as the elliptical profile shown in the cross-sections D-D and E-E of FIGS. 1-14. The width (“W” in FIG. 20) of the narrow bands 126 (i.e. their extent in the radial direction—the directions perpendicular to axis 110) may be constant as one travels around the periphery of the fixture and may measure between 0.25 mm and 1 mm.

The top of the fixtures intended for different tooth positions along the mandible may have different contours, each contour mimicking the contours of the tooth that is being replaced since the shape of the upper portion of the fixture in the mouth may have different contours. The contours of this narrow band may vary from implant to implant depending upon the location along the mandibles.

As one follows the band around the circumference of the fixture the path described by band may rise and fall—it may move up and down along the longitudinal axis of the implant as shown in the embodiments herein. By “rising” it is meant that it moves upward. By “falling”, it is meant that it moves downward.

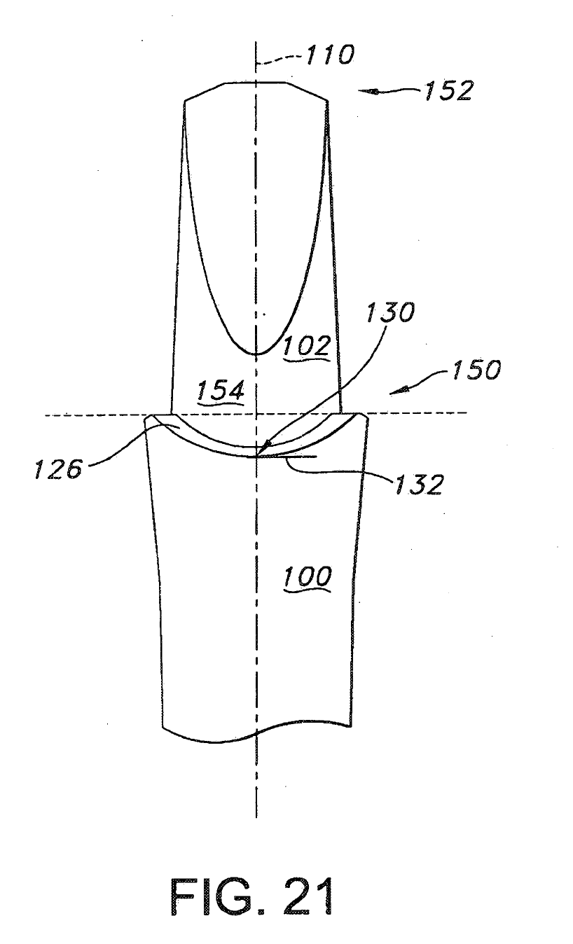

Referring now to the front views of the incisor implant shown in FIGS. 21-23 note how in each case the band falls to a lowest point or minima 130 at the rear of the implant at a position 132 along the implant's longitudinal axis.

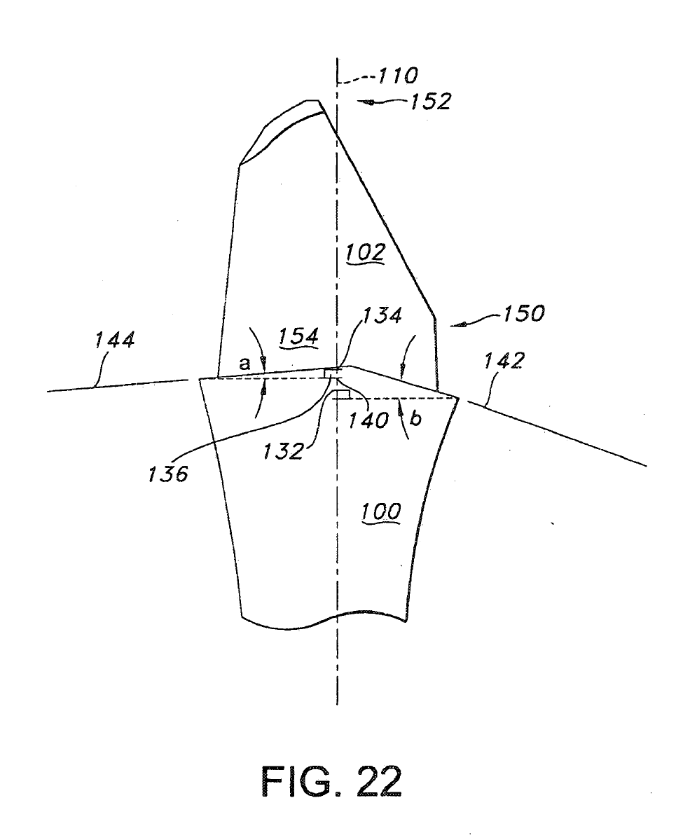

In the left side view of the implants, shown in FIG. 22, note how the band rises to a local high point or maxima 134 at a position 136 along the longitudinal axis of the implant. There is a similar maxima 135 on the opposite side of the implant at the same position 136.

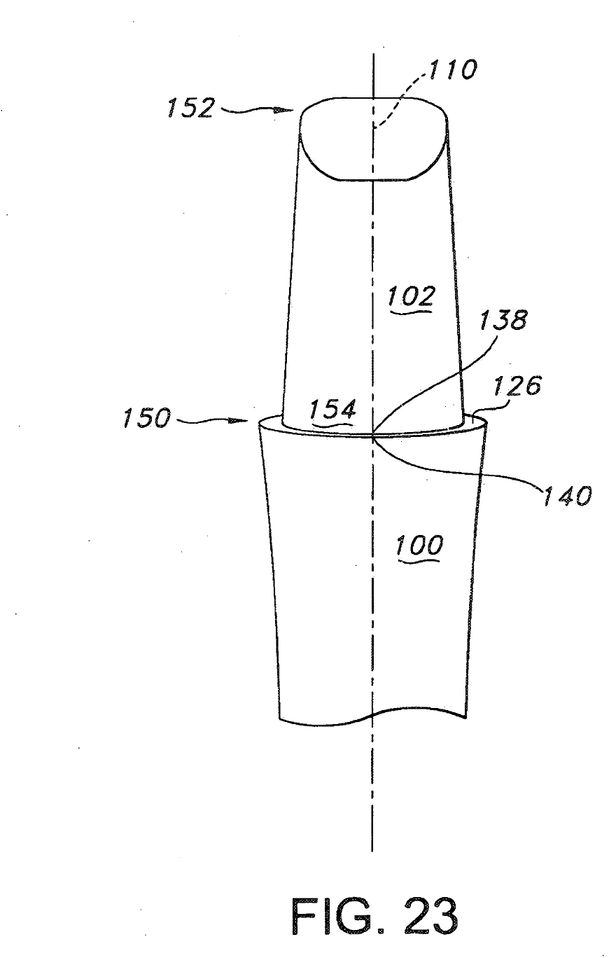

In the front view of the incisor implant shown in FIG. 23, note that the band again falls to a second local low point or minima 138 at position 140 along the longitudinal axis at the rear of the implants.

Thus, each implant has two local minima located at the front and the back of the implant, and two local maxima located at both sides of the implants. Looking at the implants in a direction perpendicular to the implant's longitudinal axes, such as the views shown in FIGS. 21-23, one can see a relative relationship of the local minima with respect to the longitudinal axis. Note that the highest points on the band are the two local maxima 134 and 135 located on either side of the band. The front local minima 138 is below the two local maxima 134 and 135 and the rear local minima 130 is below the front local minima 138.

By locating the minima and maxima as shown, the thrust loads of the tooth are more evenly resisted when the crown (see FIGS. 3-6) presses down against the surface of the narrow band.

This rise and fall of the band from maxima to minima to maxima to minima and back to maxima as it extends around the circumference of the implant varies depending upon the intended installed location of the implant, since the loads are different in each location.

The narrow band 126 may define a planar surface or a plurality of intersecting planar surfaces. As best shown in the side view of FIG. 22, the band 126 defines two imaginary planes 142 and 144 that intersect at the upper maxima 134 and 135.

Since the intersecting planes 142 and 144 intersect, they are, by definition, at an angle to one another. They also may be at an angle to the longitudinal axis 110. As shown in FIG. 22, the plane 144 defining the front half of the narrow band 126 may be at an angle alpha of between 5 and 15 degrees with respect to the longitudinal axis. It may also be at an angle of between 7 and 30 degrees.

The above angles are the angles between the plane and the longitudinal axis as it would appear when projected into a view normal to the longitudinal axis, which in this embodiment is the side view.

The other intersecting plane 142 defines the rear half of the narrow band 126 of the incisor implants of FIGS. 1-15. It, too, may be at an angle with respect to the longitudinal axis. The angle beta may be between 10 and 50 degrees. It may be between 15 and 40 degrees. It may be between 20 and 55 degrees.

The above angles are the angles between the rear plane and the longitudinal axis as it would appear when projected into a view normal to the longitudinal axis, which in this embodiment are the side views.

The abutment or upper portion 102 of the implants of FIGS. 1-14 may taper inwardly (i.e. toward axis 110) from the base as the abutment extends upward away from the fixture. Successive cross-sections of the abutment (by a plane perpendicular to axis 110) get smaller and smaller in area as one moves upward along the longitudinal axis 110 from the base 150 of the abutment 102 to the top 152 of the abutment. See, for example, FIGS. 21-23. The base 150 of the abutment adjacent to the fixture may be one continuous curved surface 154 extending circumferentially around the implant. Surface 154 is tapered inwardly toward the longitudinal axis as it moves upward, having a smaller and smaller cross-sectional area.

The base 150 of the abutment where the abutment meets the fixture 100 may be disposed radially inward around the entire circumference of the implant. It is this inward spacing of the abutment away from the edge of the top of the fixture that defines the narrow band 126 described in greater detail above.

The base 150 of the abutment may have a cross-sectional shape similar to that of the fixture to which it is coupled. For example, the implants of FIGS. 1-14 have fixtures with upper surfaces and cross-sections that are generally flattened ellipses and hence have major and minor axes. The abutments that extend upward from these fixtures have cross-sections similar to the top portions of the fixture to which they are coupled. They also may be flattened ellipses.

Another similarity is that the base of the abutment and the top portion of the fixture have the same number of “nodes”. A “node”, as the term is used here, describes local protrusions of curvilinear shapes (e.g. regions wherein the circumferential periphery of the implant has a reduced radius of curvature or regions where the periphery curves more sharply). A node exists on each flattened ellipse wherever there is a local minima in the radius of curvature. The three nodes (the three local minima) on the flattened ellipse 159 defined by base of the abutment are identified as items 160, 162 and 164. The three nodes on the flattened ellipse 161 defined by the top of the fixture and corresponding in circumferential location to nodes 160, 162 and 164 are 166, 168 and 170. There are as many nodes as there are minimas of the radius of curvature function as one travels around the periphery of the ellipse. These nodes protrude from their respective flattened ellipses, two at the flattened end 172 of the ellipse at one end 174 of the major axis 176, and one at the other end 178 of the ellipse at the other end of the major axis 176.

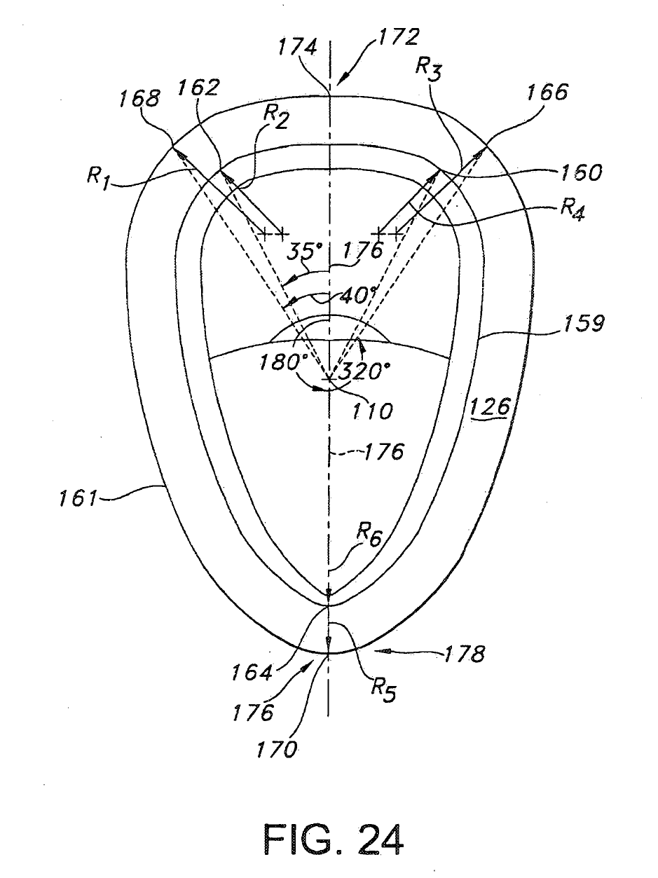

Note that the nodes 160, 162 and 164 of the abutment are aligned with corresponding nodes 166, 168 and 170 of the fixture as best seen in FIG. 24. The nodes of each fixture and its corresponding abutment are distributed at the same angular locations around the longitudinal axis of the implant. For the fixture of FIG. 24, node 168 is disposed at 40 degrees, node 170 is disposed at 180 degrees and node 166 is disposed at 320 degrees. For the abutment of FIG. 24, node 162 is disposed at 35 degrees, 164 is disposed at 180 degrees and node 160 is disposed at 325 degrees. These angles are measured with respect to a plane extending fore-and-aft and passing through longitudinal axis 110 of the implant.

FIGS. 3-6 illustrate an exemplary orientation of an implant and its associated prosthesis, shown as crown 104. The implant shown in FIGS. 3-6 shows a coupling of an implant and a crown. Note that the crown 104 extends around and completely covers the free portion of the abutment—e.g. the free outer surface of the abutment extending above the top of the fixture. The lower portion of the crown abuts the fixture, more particularly, the surface of narrow band 126.

The junction created by the lower portion of the crown 104 abutting the narrow band is smooth. The junction is configured to provide a smooth transition from the crown to the fixture, and vice versa.

In the embodiments of FIGS. 1-24, the fixture and the abutment are unitary structures, formed integrally, or formed individually and coupled together to one another before implantation in the maxilla or mandible. For most applications, however, it is desirable to create a multi-piece device having an abutment and fixture that are separate and removably attachable.

In a system using a separately installable fixture a doctor is enabled to implant a fixture, to wait for the fixtures and bone to heal, and to then attach an abutment and crown to the fixture. This delayed assembly permits a fixture to heal before a tooth load is applied. If the entire implant, both fixture and abutment, was installed initially, the patient could only with great difficulty avoid biting down on the implant while the bone heals. Biting forces applied to an implant, especially during the initial fixtures/bone healing phase, can prevent proper healing.

The implants of the following figures (FIGS. 25A et seq.) are all two-piece implants in which the abutment and the fixture are separate and are coupled together after the fixture is embedded in a patient's bone and permitted to heal. In each of the examples of FIGS. 25A et. seq. the abutment and fixture are held together with a screw, and have interengaging binding surfaces that prevent rotation of the abutment with respect to the fixture.

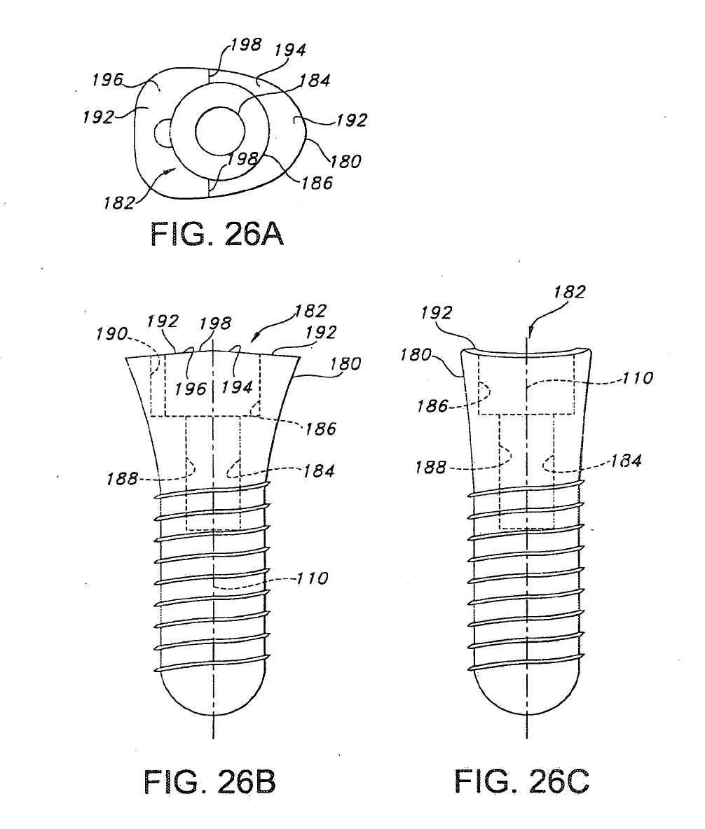

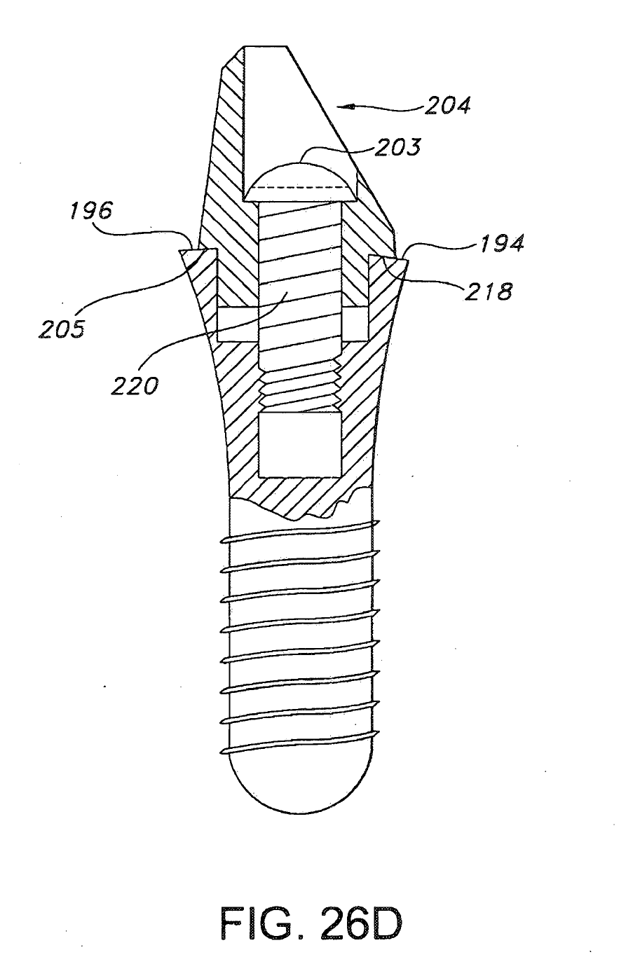

FIGS. 25A-26D show structures that couple the abutment and the fixture.

FIGS. 26A-26C show the fixture portion of a two-piece implant in top, side, and rear views, respectively. Exemplary fixture 180 has a hole 182 that extends axially down the middle of the fixture to a depth of between 3 and 10 mm. This hole is a right circular cylinder and has internal threads 184 that are configured to engage a screw (FIG. 26D) that extends through the abutment (FIGS. 25A-25D) into the fixture.

An upper portion 186 of the hole is a right circular cylinder and has a larger diameter than the lower threaded portion 188 of the hole. This upper portion also has an antirotation structure 190, here shown as a half-circle slot that is formed in the wall of the upper portion of the hole 182. This slot defines a surface that interengages with the abutment to prevent the abutment and the fixture from rotating with respect to each other.

Slot 190 may be shaped as an arc of circle as viewed from above and as best shown in FIG. 26A. The transition between the slot 190 and the upper portion 186 may be rounded or radiused.

The diameter of the upper portion 186 of hole 182 may be between 1.2 and 1.7 larger than the diameter of the lower threaded portion 188 of hole 182.

The upper portion 186 of the hole may have a constant diameter, or it may be tapered inward the farther one goes down upper portion 186 to have a smaller and smaller cross-sectional area. If tapered, the taper angle (the angle between the longitudinal axis of the hole and the wall of the upper portion) may be between 1 and 10 degrees.

Note that the upper surface 192 of the fixture is generally planar, in the form of two intersecting planes 194 and 196. These planes join together at a line 198 that extends across the top of the fixture from one side to another, dividing the top of the fixture into two portions of generally equal area. By generally equal, we mean that the area of the top surface of the fixture on one side of line 198 is between 0.8 and 1.25 times the size of the area on the other side of the line.

In FIGS. 25A-25D, the abutment 200 has a central hole 202 that extends entirely through the abutment. This hole is slightly larger in diameter than the threads of the screw (FIG. 26D) designed to mate with threaded hole 188 in the fixture.

The upper portion 204 of central hole 202 has a larger diameter than the lower portion 206 of central hole 202. The bottom 208 of the upper portion 204 defines a planar surface 210 that is configured to receive and support the head 203 of the screw 205 (FIG. 26D) that holds the abutment and fixture together.

A cylinder 214 extends downward from the bottom surface 216 of the abutment. This cylinder is configured to fit inside the upper portion 186 of the hole 182 in the fixture. The cylinder 214 may be a right circular cylinder, although it may have a taper matching that of the upper portion of the hole in the fixture. Cylinder 214 includes an arcuate projection 215 generally the same in size and orientation as the arcuate slot 190 in the fixture.

FIG. 26D is a partial cross-section of the abutment and fixture of FIGS. 25A-25D and 26A-26C, showing how they are fixed together by screw 205.

Cylinder 214 is inserted into upper portion 186 of hole 182. The head 203 of screw 205 is configured to enter the upper portion 204 of abutment hole 202 and may be received entirely therein such that it does not extend above upper surface 212 of abutment 200.

The lower surface 216 of the abutment 203 from which the cylinder 214 downwardly extends is in the form of two intersecting planes 218 and 220. These planes may be at the same angles with respect to one another and with respect to axis 110 as are planes 194, 196, respectively that form the top of the fixture such that when the fixture and abutment are coupled together, plane 218 abuts and is generally coplanar with plane 194 and plane 220 abuts and is generally coplanar with plane 196. Plane 218 and plane 194 may be parallel, as are planes 220 and 196. Furthermore, the angle between planes 194 and 196 on the fixture is the same as the angle between planes 218 and 220 on the abutment.

The planes 194 and 196 that define the top of the fixture have a greater overall area than the overall area of planes 218 and 220 that define the bottom of the abutment. When the cylinder extending from the abutment is inserted into the upper portion of the hole in the fixture, the planes 194 and 196 defining the top of the fixture extend radially outward beyond the planes 218 and 220 that define the bottom of the abutment. This portion of planes 194 and 196 extending beyond the bottom of the abutment define a narrow band 126 that extends around the implant.

This narrow band 126 that extends outward from the junction of the abutment and the fixture that is formed by the planar top surface of the fixture may have the same characteristics, extent and orientation as the narrow band 126 described as part of the single piece implant of FIGS. 1-24.

There are several alternative fixture and abutment couplings that are also considered beneficial.

For example, rather than having one arcuate projection 215 on the abutment's cylinder that mates with one arcuate slot 190 in the fixture's hole, more may be provided, such as two, three, four, five, six, seven, or even more.

The slot/projection pairs that engage with each other to prevent rotation of the abutment with respect to the fixture may be arranged equiangularly about the longitudinal axis of the implant. For example, if there are two such slot/projection pairs, they may be disposed at 180 degrees with respect to each other about the longitudinal axis. If there are three, they may be located at 120 degrees with respect to each other. If there are four pairs, they may be disposed at 90 degrees, and so on.

In another alternative embodiment, rather than having a cylinder projecting downward from the abutment that, in turn, mates with a similarly shaped hole in the fixture, their positions may be reversed: the cylinder may extend upward from the fixture to be received in and engage a hole extending upward into the bottom of the abutment. In this case, the sizes, shapes and orientations of the cylinder and its receiving hole in FIGS. 25A-26D are the same, merely reversed.

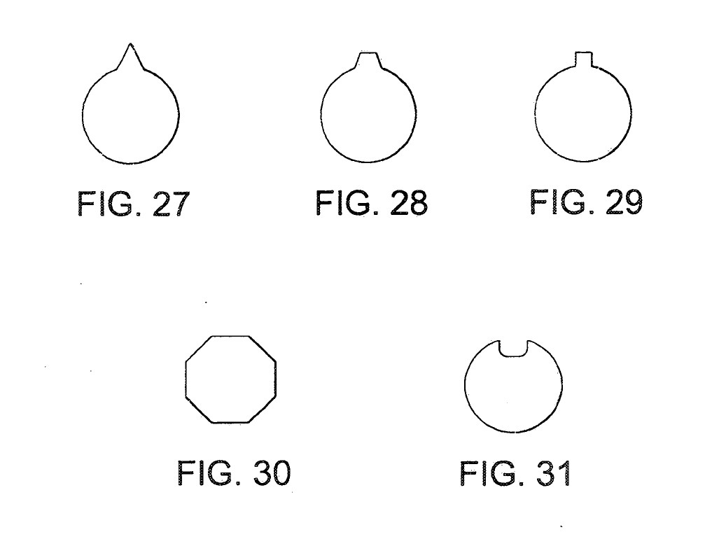

In yet another alternative embodiment, rather than arcuate slots and projections, the slots and projections may be polygonal, for example triangular (FIG. 27), trapezoidal (FIG. 28), or rectangular (FIG. 29).

Instead of the circular cylinder and hole arrangement shown in FIGS. 25-26, the cylinder (and the hole that receives) it may be faceted, defining mating surfaces with longitudinally extending interengaging facets that provide the anti-rotation feature of the mating slots and projections (FIG. 30). If faceted, the facets on the cylinder and in the hole in which it is inserted may define a regular polygon when viewed along the longitudinal axis of the implant.

The circular cylindrical hole and mating cylinder can be circular, ovoid, elliptical, or have any other smooth curvilinear irregular surface that assists in preventing rotation of the abutment with respect to the fixture.

The cylinder, whether extending downward from the abutment, or alternatively extending upward from the fixture, may have protruding surfaces that engage slots or grooves on the hole. The protrusions or projections 215 may be provided on the inner surface of the hole, extending inwardly, and the slots or grooves to which they are mated may be provide on the outer surface of the cylinder. See FIG. 31, for example. In short, the slots 190 and projections 215 may be reversed. Any of the above arrangements and configurations of the mating surfaces of the abutment and the fixture can be combined to provide additional anti-rotation capability. For example, the shapes may have corners such as those illustrated in these figures but may also have rounded engaging surfaces such as those shown in the fixtures of FIGS. 115 et seq., or any combination of corners and curvilinear surfaces.

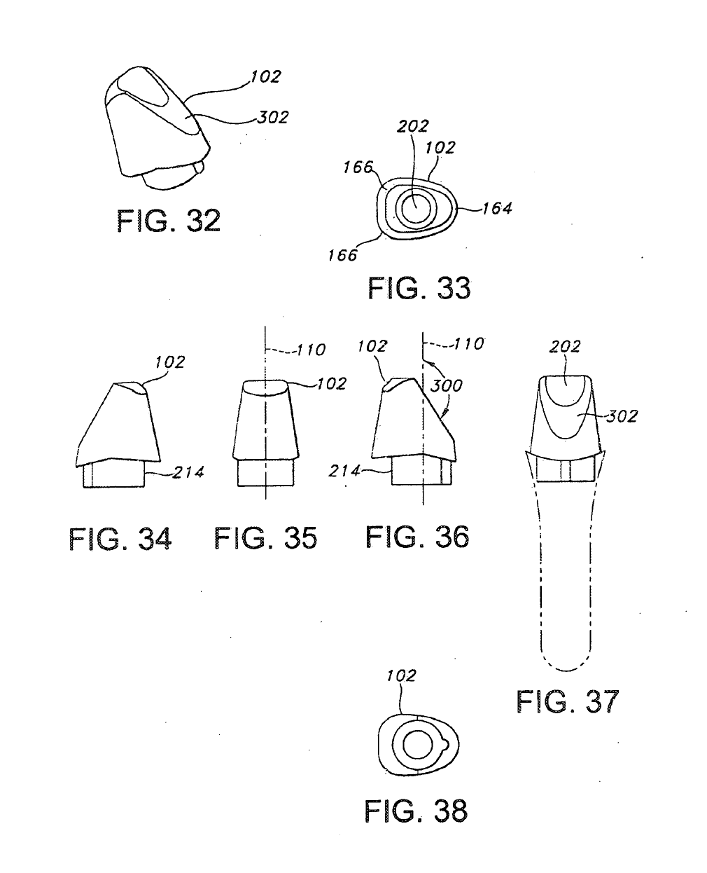

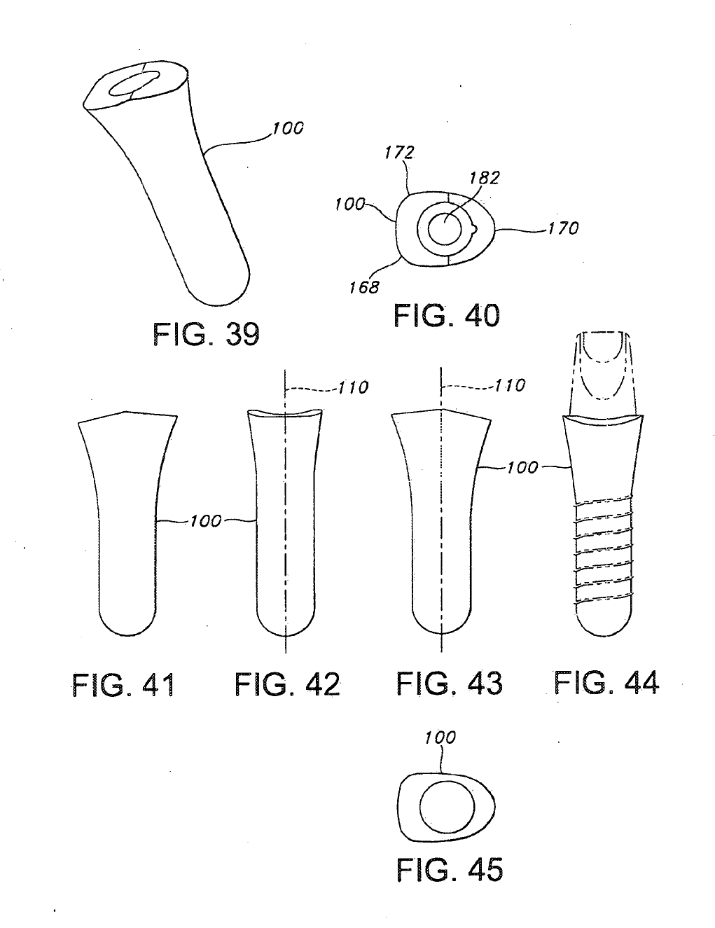

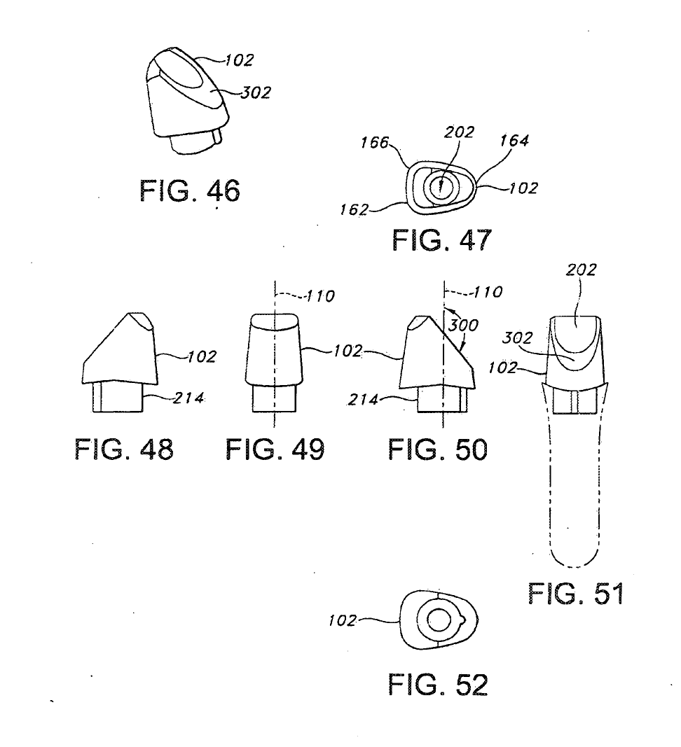

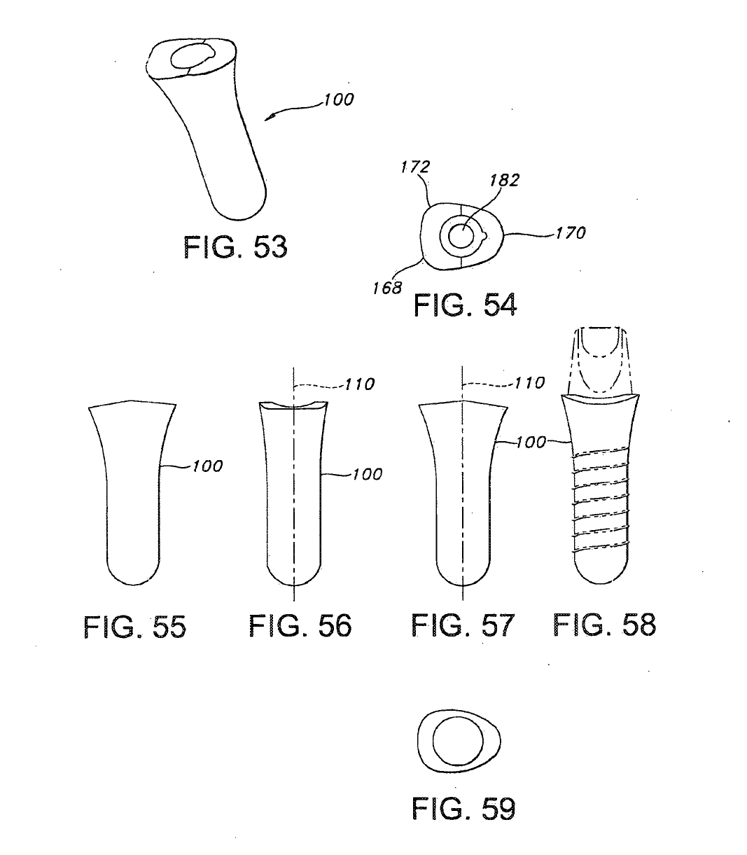

FIGS. 32-59 illustrate two-piece implants that may be used as replacement for cuspids. FIGS. 32-45 illustrate a replacement implant for an upper (i.e. maxillary) cuspid. FIGS. 46-59 illustrate an implant for a lower (i.e. mandibular) cuspid.

The cuspid implants shown herein are two piece implants (not including fasteners), as illustrated herein, and have coupling structures such as those shown in FIGS. 25-31, described above. While they are illustrated as two-piece implants, they may also be provided in single piece form. In single piece form, they would have the identical structural characteristics, capabilities and features as the two piece upper central incisor implant shown in FIGS. 25-31, but would lack the coupling feature (i.e., the holes, cylinders and screws) of FIGS. 25-31.

All the two piece implants (FIGS. 25A et seq.), when assembled, have the same configuration, structures, benefits, shapes, sizes, orientations, and uses as the single piece implants of FIGS. 1-24. The illustrated embodiments differ in the differential characteristics identified in the discussions accompanying each of the FIGS. 32 et. seq. below. Furthermore, each of the two piece fixtures of FIGS. 32 et seq. may have the same illustrated and alternative coupling structures as described above in conjunction with FIGS. 25A-31.

The angle 300 of the planar top 302 of abutment 102 through which hole 202 passes is 135 to 165 degrees with respect to the longitudinal axis 110 of the implant for the upper cuspid and 180 to 150 degrees with respect to the longitudinal axis 510 of the implant for the lower cuspid.

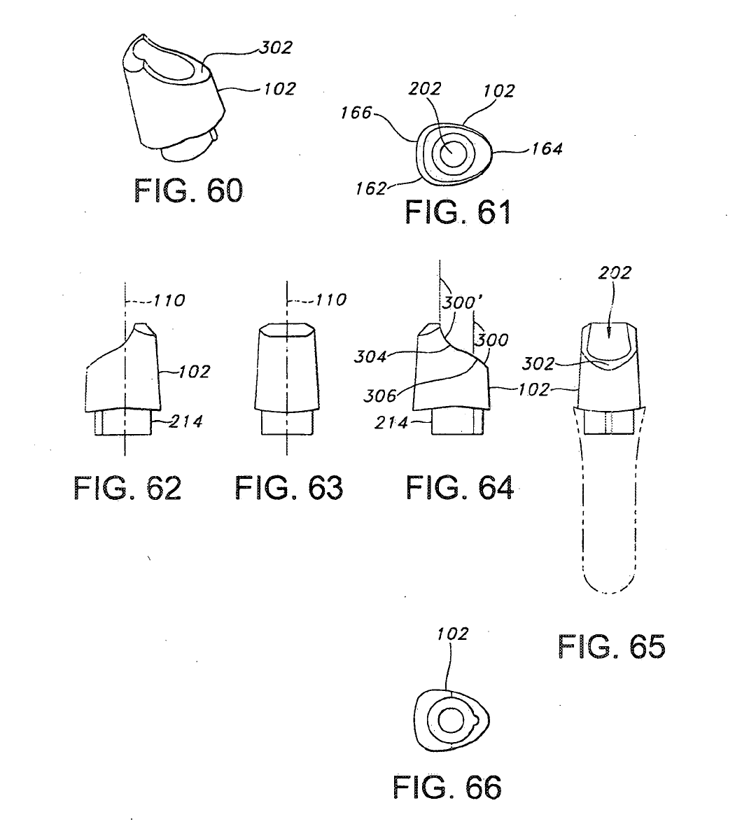

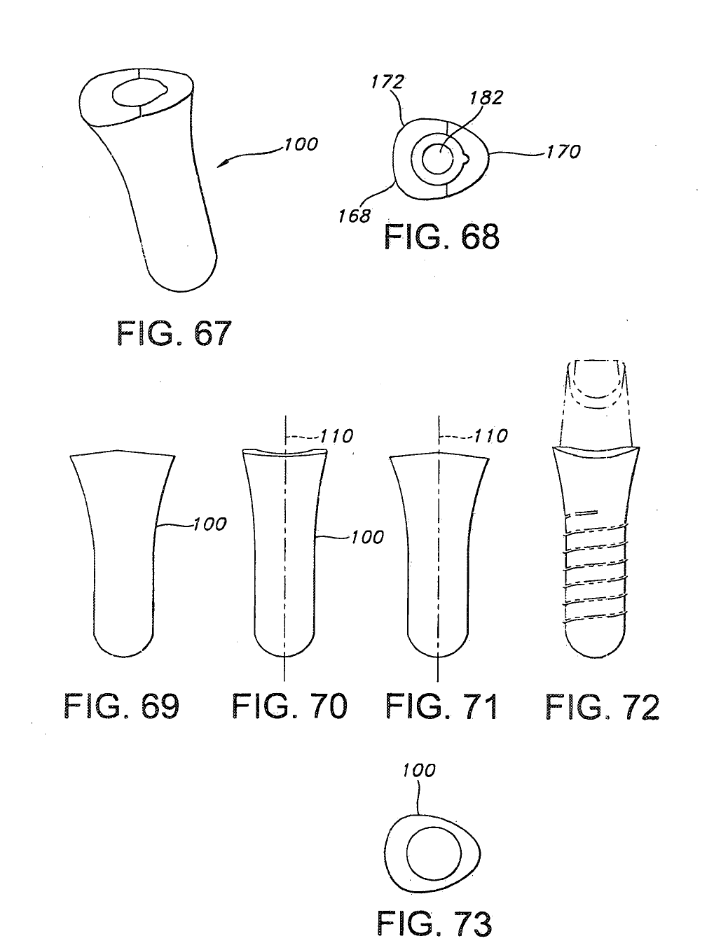

FIGS. 60-73 illustrate a two-piece implant that may be used as replacement for first lower premolars. FIGS. 60-66 illustrate the abutment portion 102 and FIGS. 67-73 illustrate the fixture portion 100. Abutment 102 has an upper surface 302 that unlike the prior examples is not a flat plane, but is a compound concave convex surface as shown in the side view of FIG. 64. A lower portion of surface 302 is disposed at an angle 300 with respect to longitudinal axis 110 of 120 degrees. An upper portion of surface 302 is disposed at an angle 300 prime with respect to longitudinal axis 110 of 160 degrees. An upper portion 304 of surface 302 is concave. A lower portion 306 of surface 302 is convex.

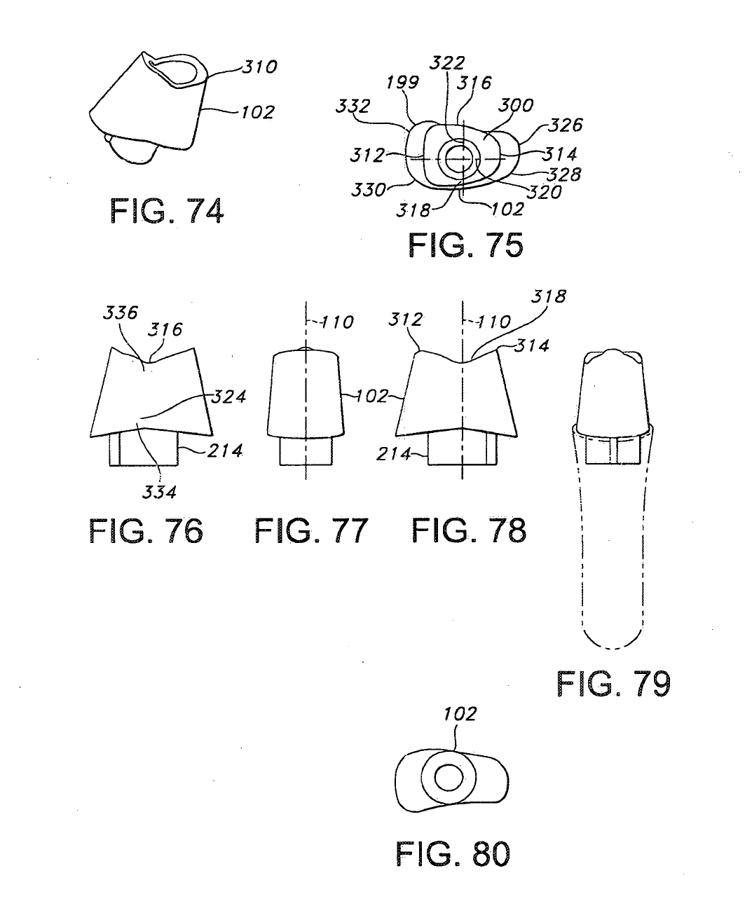

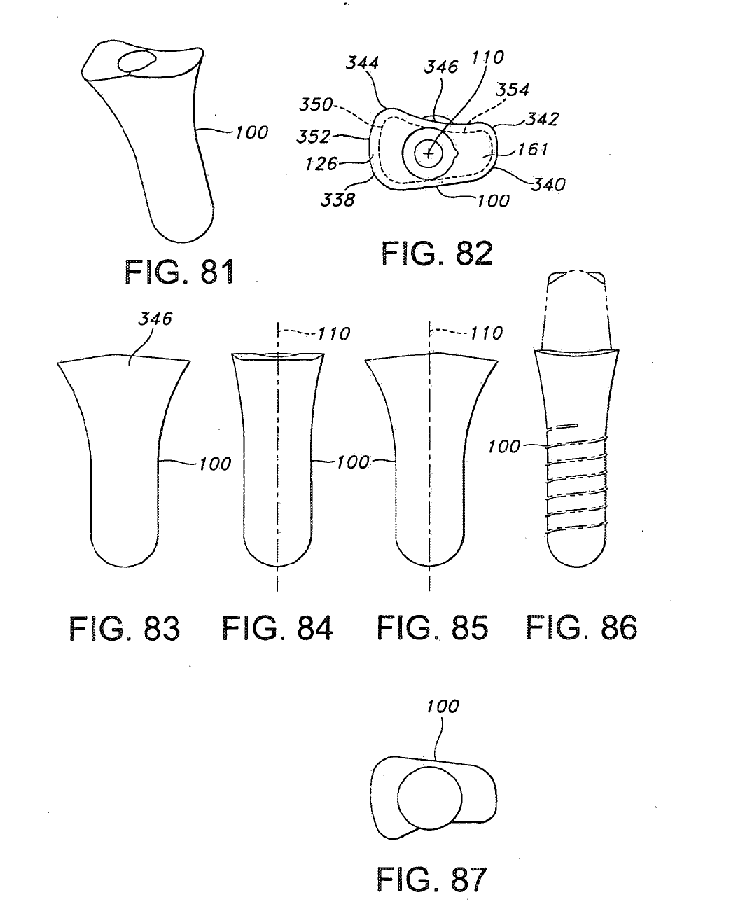

FIGS. 74-87 illustrate a two-piece implant that may be used as a replacement for first upper premolars. FIGS. 74-80 illustrate the abutment 102 portion of the implant and FIGS. 81-87 illustrate the fixture 100 portion of the implant.

Abutment 102 has an upper surface 310 that defines 2 local maxima 312 and 314 and 2 local minima 316 and 318. These are arranged such that the 2 maxima 312 and 314 are generally aligned with and extend along the fore-and-aft axis 320 and the 2 minima 316 and 318 are disposed along the orthogonal side to side axis 322. In this context, fore-and-aft refers to an axis extending from the lingual side to the labial side of the implant and side to side refers to an axis extending perpendicular to that direction along the mandible or maxilla toward adjacent teeth.

In plan view, upper surface 300 of abutment 102 is convex. The lower portion 159 of abutment 102 as seen in plan view (FIG. 75) is convex-concave. It generally has a kidney shape with one side wall 324 that is concave. The lower portion 159 of abutment 102 has four nodes 326, 328, 330, and 332 generally disposed at the four corners of the abutment with two nodes 330 and 332 facing outward on the labial side and two nodes 326 and 328 facing inwards on the lingual side of the abutment. Side wall 324 changes from concave at a lower portion 334 of the side wall to convex at an upper portion 336 of the side wall.

Abutment 100 similarly has an upper surface 161 that is concavo-convex in plan view (FIG. 82). Surface 161 has four nodes 338, 340, 342, and 344 that are disposed about longitudinal axis 110 in the same angular orientation as corresponding nodes 330, 328, 326, and 332, respectively. In a similar fashion, an upward wall portion 346 is concave and is angularly disposed with respect to longitudinal axis 110 in the same location as concave portion 334 of surface 324 of abutment 102 shown in FIG. 74-80. Nodes 338 and 334 face outwardly on a labial wall of the fixture 100 and nodes 340 and 342 face inwardly (lingually) on the opposing side of abutment 100. Top surface 161 of abutment 100 has a kidney shape oriented in the same manner as the kidney shape lower portion 159 of abutment 102.

The fixture concavity and the abutment concavity may be disposed one above the other at the same angular location and on the same side of the implant. In the example shown here, the concavity is on the right side of the implant. The right side of the implant is also the side of the implant closes to the front of the mouth. It is the side of the implant that, when inserted, will face and abut either the first upper cuspid or a first upper cuspid implant.

The shape of the concavity may be sized to receive a portion of the convex side of the adjacent cuspid. In this manner, the concavity permits the cuspid and the first premolar to be fitted together more closely, with a convex sidewall of the cuspid tooth or implant nested inside the concavity of the first upper premolar.

The concavity of the abutment is similarly reduced as one moves in the opposite direction by rising upward from the concave region toward the top of the abutment. Just as with the fixture, this transition from concavity to convexity is gradual, with the radius of curvature gradually increasing until the wall of the abutment flattens. Above the height that it flattens, the sidewall of the abutment becomes convex. At the same time, the cross-sectional shape becomes rounder, and the four nodes are reduced to three nodes at the top of the abutment, as best shown in the top view of the abutment, FIG. 75.

FIG. 82 includes a dashed line 350 that shows the position of lower portion 159 of abutment 102. The space between line 350, the outer most extent of the lower portion of the abutment and upper edge 352 of fixture 100 defines the narrow band 126 in this example. Note that narrow band 126 when projected in the top view (FIG. 82) is concavo-convex and includes an indented or concaved portion 354 unlike the preceding examples.

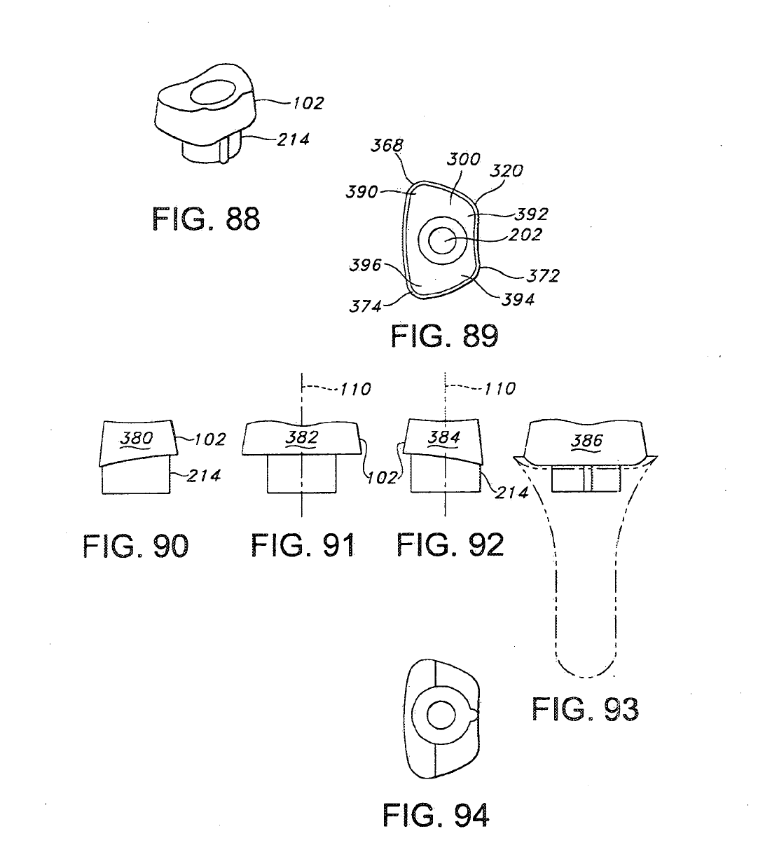

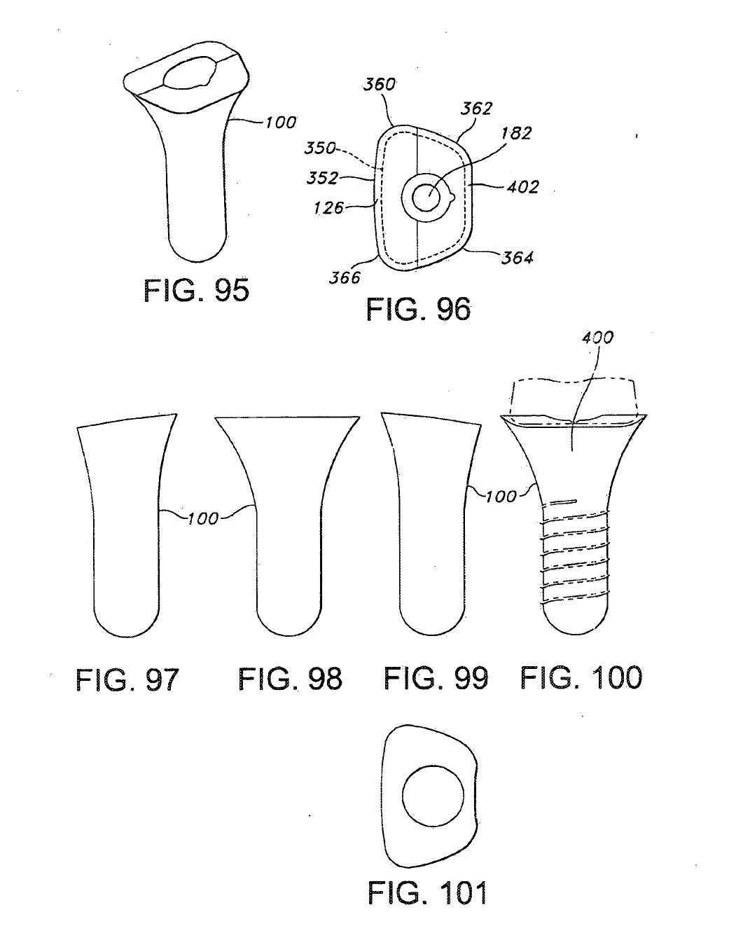

FIGS. 88-101 illustrate a two-piece implant that may be used as a replacement for lower molars (LM). FIGS. 88-93 illustrate the abutment 102 portion, and FIGS. 94-101 illustrate the fixture 100 portion.

The LM implants have four nodes 360, 362, 364, and 366 at the top of the fixture 161, four corresponding nodes 368, 370, 372, and 374 at the bottom 159 of the abutment 102. These nodes on the abutment are angularly aligned with the nodes on the fixture at the bottom of the abutment, and at the top of the abutment. These four nodes are disposed at four angular locations measured in a circumferential direction with respect to the longitudinal axis 110 of the LM implant.

The rounded corners of the abutment 102 that define the nodes typically extend upward and tilt slightly inward, as shown in the FIGURES, to make a four-sided generally pyramidal structure.

The abutment may be a polygonal (for example a quadrilateral or trapezoidal) pyramidal cylinder with rounded corners, as shown herein. Each face of the pyramidal shape 383, 382, 384, and 386 is a sidewall of the abutment. Each sidewall may meet at a corner. These corners where adjacent sidewalls of the abutment meet are rounded. Each corner is one of the four nodes of the abutment.

One sidewall of the abutment, the lingual sidewall 386 faces inward toward the tongue. One sidewall, the facial sidewall 382 faces outward toward the face. The lingual sidewall may be shorter than the facial sidewall. The sidewalls 380 and 384 that join the lingual and facial sidewalls therefore spread apart as they extend forward from the lingual sidewall to the facial sidewall.

The top surface 300, while generally planar and parallel to the longitudinal axis of the implant, has four prominences or peaks 390, 392, 394, and 396 that extend upward from the top surface 300 of the abutment 102. These prominences or peaks (local maxima) are disposed one at each rounded corner of the abutment.

The width of the LM implant's narrow band 126 may be between 0.5 and 1 mm.

Inner or lingual side wall 386 of abutment 102 may be slightly concave, both at the top and at the bottom where it abuts the top of fixture 100. Upper portion 400 of the side wall of fixture 100 may be concave to the same extent as the concavity of abutment 102 thereby defining there between a slightly concave portion 402 of narrow band 126. This concave portion 402 of narrow band 126 is located on the lingual side of the implant fixture 100.

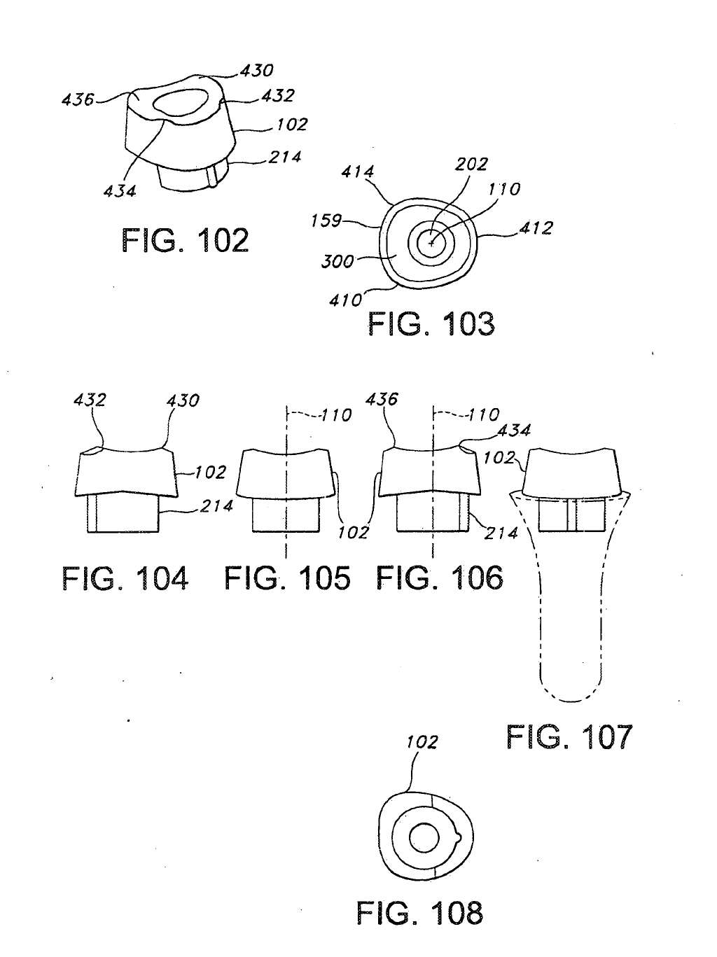

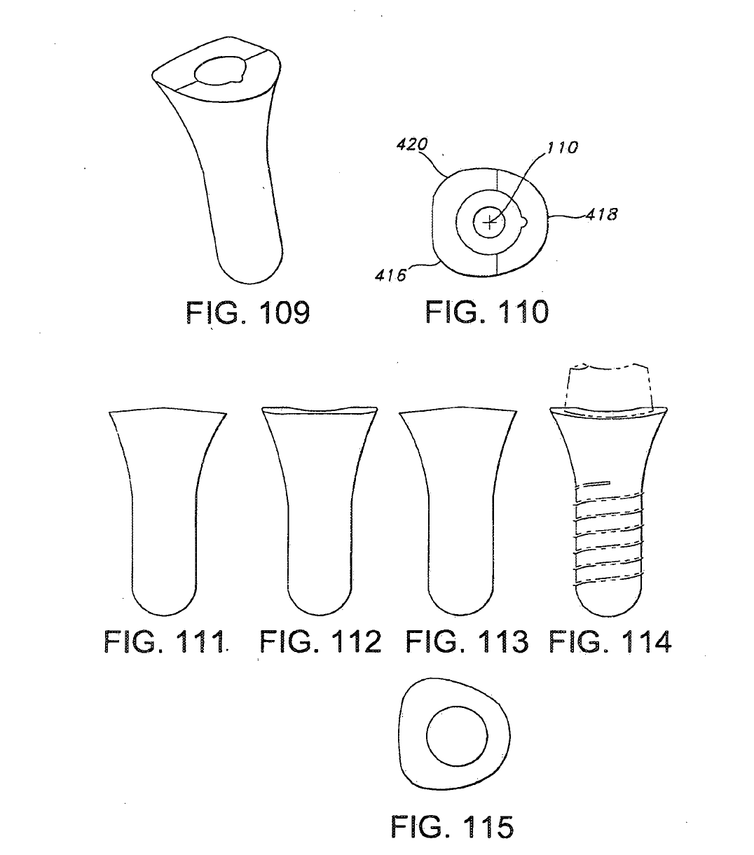

FIGS. 102-115 illustrate a two-piece implant that may be used as a replacement for upper molars (UM). FIGS. 102-108 illustrate the abutment 102 portion of the UM implant and FIGS. 109-115 illustrate the fixture 100 portion of the UM implant.

The UM implant have three nodes 410, 412, and 414 located at the bottom 159 of abutment 102. There are three corresponding nodes 416, 418, and 420 that are angularly disposed about longitudinal axis 110 in the same location as corresponding nodes 410, 412, and 414. UM abutment 102 has four peaks or prominences (or maxima) that extend upward from top surface 300 of that abutment. Each of these four prominences 430, 432, 434, and 436 are spaced apart from adjacent peaks or prominences by an angle of between 70 and 120 degrees about longitudinal axis 110.

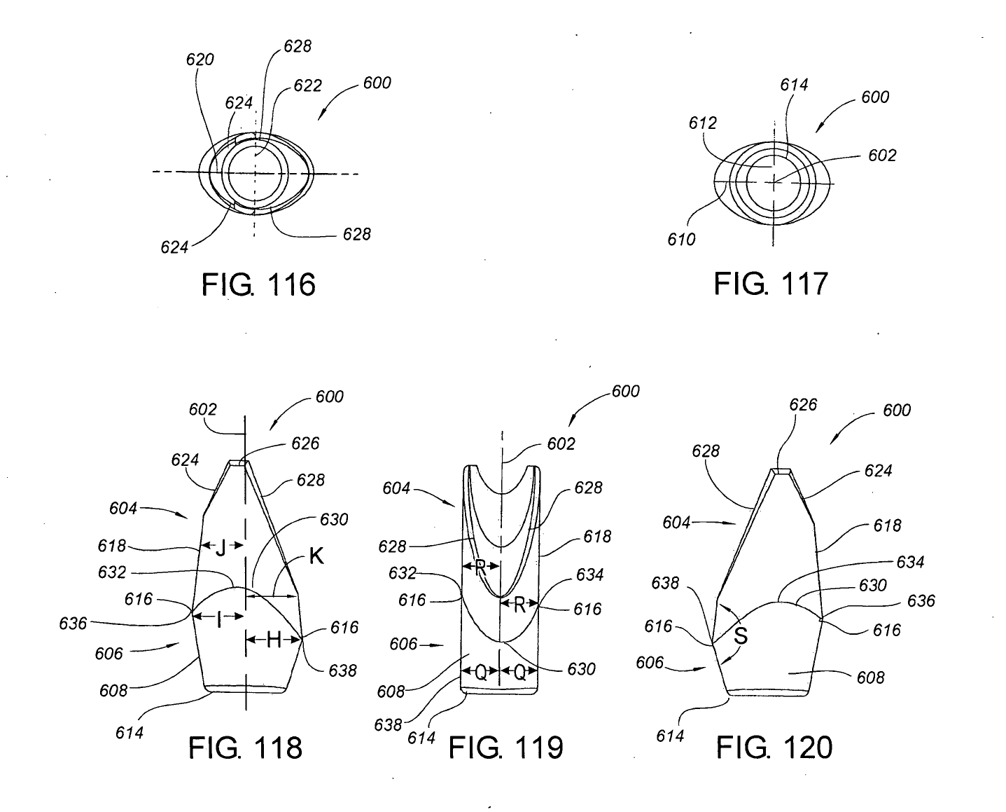

FIGS. 116-123 are top, bottom, left, rear, right, front, perspective, and cross-sectional views, respectively, of abutment 600. The cross-sectional view is taken along a cutting plane that extends front to rear and through the longitudinal axis of the abutment.

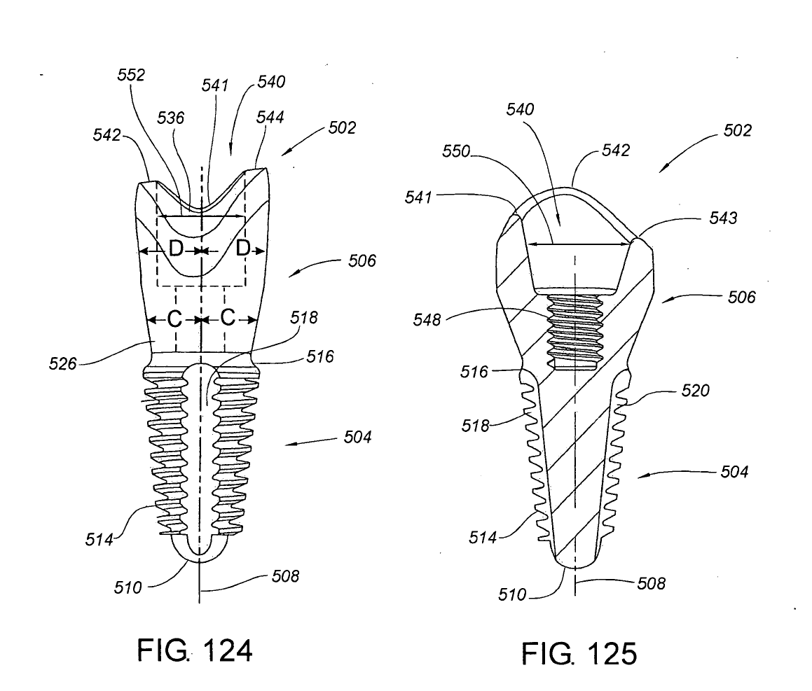

FIGS. 124-130 are front, cross-sectional, rear, left, top, bottom and perspective views of fixture 502. The cross-sectional view is taken along a cutting plane that extends front to rear and through the longitudinal axis of the abutment.

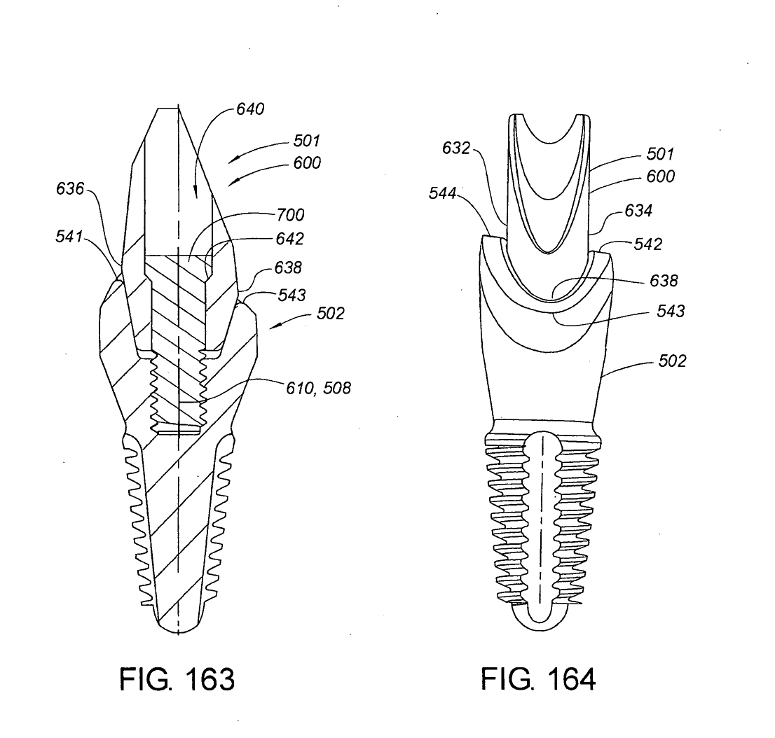

FIGS. 163, 164 illustrate the assembled alternative implant 501 comprised of the abutment 600 of FIGS. 116-123, the fixture 502 of FIGS. 124-130, and a threaded fastener 700. In FIG. 163, the cutting plane extends through the longitudinal central axis of the implant (the axis of both the fixture and the abutment) and front-to-rear. In FIG. 164, the cutting plane extends through the longitudinal central axis of the implant (the axis of both the fixture and the abutment) and side-to-side.

An identical (but mirror image) implant to the one of FIGS. 116-130, 163, 164 can be used to replace lateral incisor #10. This implant is identical in all respects to implant 501 but in mirror image form and therefore has not been separately illustrated and described herein.

Referring now to FIGS. 124-130, a dental fixture, here shown as lateral incisor fixture 502 is illustrated. Fixture 502 includes a lower portion 504 that is formed integral with an upper portion 506. Fixture 502 includes a longitudinal axis 508 that extends from the lower hemispherical tip 510 of the lower portion 504 to the top of fixture 502.

Lower portion 504 is generally circular in longitudinal cross-section having a smaller diameter at a lower end of portion 504 and a larger diameter at the upper end of portion 504. Portion 504 is generally conical with an included flare angle of 12 degrees. This angle may be symmetric about the longitudinal axis 508 of the lower portion 504, such that the cone defined by the major diameter of the threads extends outward from the longitudinal axis 508 by 6 degrees.

This taper permits the threads to be progressively wedged into the maxilla with each successive turn of fixture 502 about its longitudinal axis. As fixture 502 is rotated, it extends deeper into the bone and extends farther outward in a direction normal to the longitudinal axis 508 of fixture 502, causing each turn of thread 514 to wedge more firmly into the bone. In an alternative arrangement, the fixture can be press fit into the prepared hole (also called an “osteotomy”).

Lower fixture portion 504 is threaded over substantially all of its length. Thread 514 extends from the upper part of hemispherical tip 510 to the upper end of the threads located generally at the longitudinal midpoint 516 of fixture 502.

Thread 514 has an asymmetric profile, best shown in FIG. 124. Thread 514 is a single helical thread that extends the length of lower portion 504 of fixture 502 and has a pitch of 0.576 mm, a depth of 0.5 mm, and a length in an axial direction of 6.0 mm. It flares outward at an angle A of 6 degrees from the longitudinal axis (FIG. 127) as it extends upward.

Thread 514 is broken by two longitudinal semi-circular grooves 518, 520 that are provided on the outer surface of fixture portion 504. The grooves are disposed at an angle B of 180 degrees from one another (FIG. 129) as measured in a plane normal to the longitudinal axis 508. Groove 518 extends vertically along the outer front surface of fixture portion 504. Groove 520 extends vertically along the outer rear surface of fixture portion 504. The thread is broken by these grooves (i.e. it does not extend across the grooves). When the fixture is screwed into the bone of the patient's mouth, grooves 518, 520 provide a longitudinally extending void into which bone may grow. Bone that is encouraged to grow into grooves 518, 520 prevents the rotation of the fixture when the fixture is twisted about its longitudinal axis. These grooves also allow for fluid evacuation when press fit into the osteotomy. They also ensure the threads do not come through the facial bone of the maxilla.

The upper portion 506 of fixture 502 is substantially the same length (measured in a longitudinal direction) as lower portion 504. The outer surface profile of upper portion 506 differs from portion 504, however. The outer surface 526 of the lower end of upper portion 506 is circular in cross-section with an outer diameter approximately the same as the root diameter of threads 514. As upper portion 506 extends upward toward its upper end, however, this cross-sectional profile changes from a circular profile to a generally oblate and elliptical profile. The outer surface 528 of the upper end of upper portion 506 is generally elliptical in cross-section.

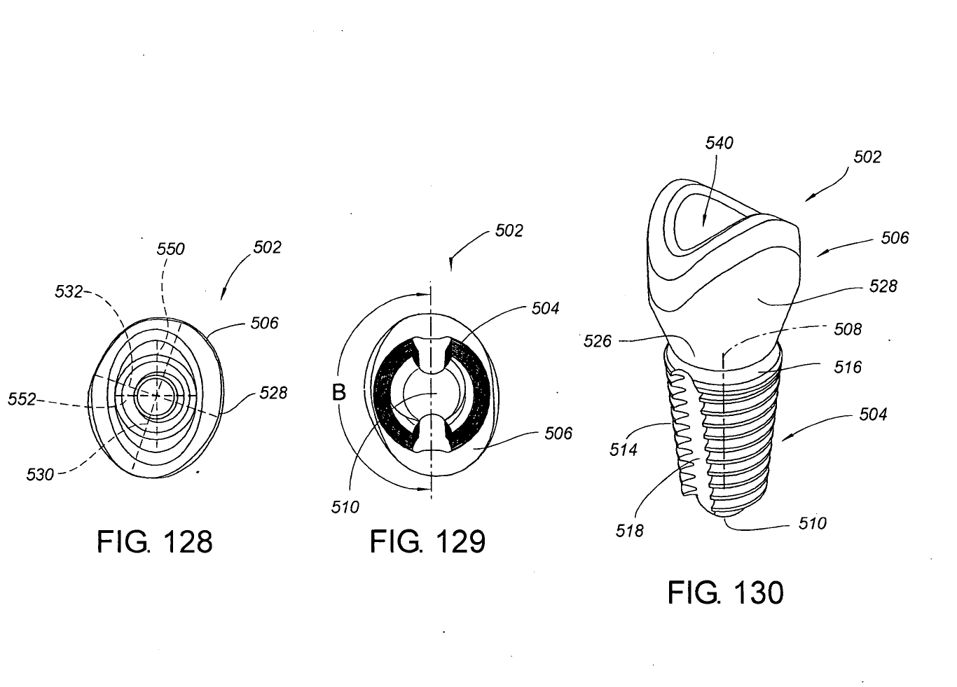

The outer surface 528 has a major axis 530 and a minor axis 532 (FIG. 128), with the major axis 530 extending generally front-to-rear in a facial-to-lingual direction when installed in the patient's mouth, and minor axis 532 extending generally left-to-right in a mesial-distal direction when installed in the patient's mouth.

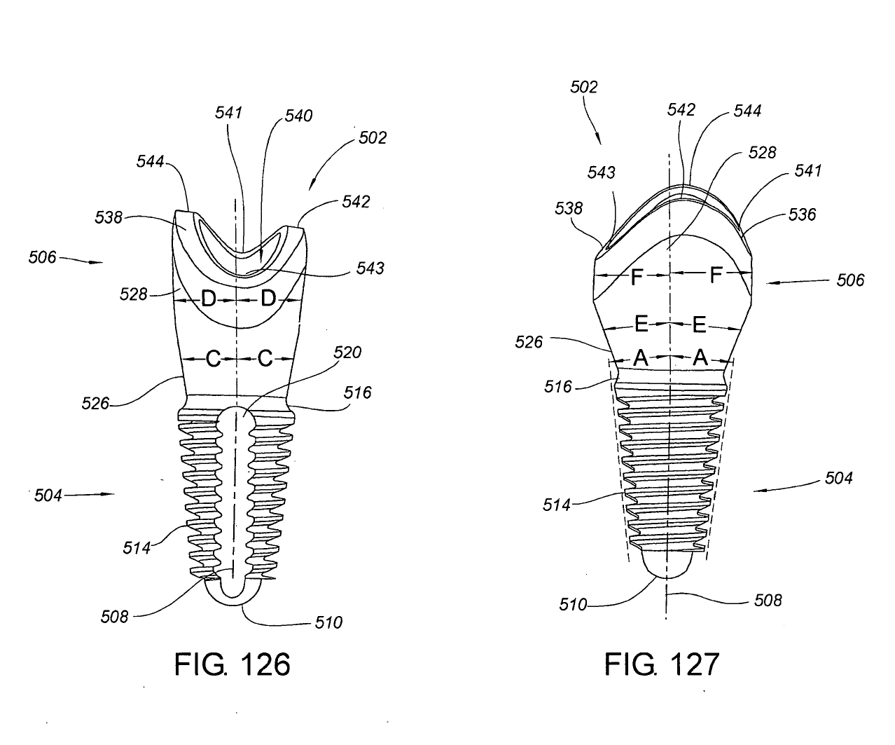

When viewed in front view and rear view (FIGS. 124, 126, respectively), the left and right side walls of upper portion 506 adjacent to thread 514 flare outward in the mesial and distal directions at an angle C of about 9-11 degrees with respect to the longitudinal axis 508 as they extend upward. About halfway up upper portion 506, the sidewalls flare outward at a slightly smaller angle D of about 3-7 degrees with respect to longitudinal axis 508.

When viewed in side view (FIGS. 125, 127), the side walls of the upper portion 506 at the left and right ends of the major axis flare outward in the lingual and buccal directions at an angle E of about 20-22 degrees from the longitudinal axis 508 as they extend upward. About halfway up upper portion 506, the sidewalls flare inward at a smaller angle F of 1-7 degrees with respect to the longitudinal axis 508.

The top surface of the fixture is in the form of two intersecting planar surfaces, a front surface 536, and a rear surface 538 that are pierced by an irregularly shaped hole 540 extending downward in the axial direction into upper portion 506 of fixture 502. Surfaces 536, 538 intersect to define two local maxima (or peaks) 542, 544 of the fixture on the left and right side of the fixture, respectively. These two maxima define the uppermost extent of the fixture on each side.

The two surfaces 536, 538 of top surface of fixture 502 are radiused or curved where they intersect and do not meet at a sharp line (for example as illustrated in the embodiment of FIG. 20 in which the front and rear surfaces of the top of the fixture intersect along a line that defines maxima 134, 135). In the embodiment of FIGS. 116-124, this radiused intersection provides two curved crests or peaks (i.e. maxima 542, 544) located on opposite sides of the top of the fixture. Surfaces 536, 538 are not curved to the same degree where they meet. Instead, they are curved more steeply on the left side of the fixture 502 such that the local maximum 542 is not as high as the local maximum 544 on the other side of the fixture 502.

Similarly, the two surfaces 536, 538 intersect hole 540 at two local minima 541, 543 located at the front and back, respectively, of fixture 502. The rim of hole 540, where it intersects top surfaces 536, 538 defines a continuously curved path around the upper edge of hole 540 between local maxima 542, 544 disposed on the left and right sides, respectively, of the fixture 502 and local minima 541, 543 located at the front and back, respectively, of fixture 502.

Hole 540 is irregularly shaped, having a cross-sectional profile at its upper end that is substantially elliptical with a major axis extending front to rear and the minor axis extending left to right. As one descends into hole 540, the hole transitions from a substantially elliptical shape to a substantially circular shape having a diameter that may be less than half the length of the minor axis at the top of the fixture. As one descends into hole 540, the major axis is reduced in length at a rate greater than the minor axis is reduced in length. In other words, the circular bottom of hole 540 flares outward in a front to rear direction at a rate greater than it flares outward in a side to side direction as one ascends from the bottom of hole 540 to the top of hole 540. It is this differential rate of flaring that transitions the hole from a circular cross-section at its base to a generally elliptical cross-section at its upper end.

The configuration of hole 540 has several advantages. First, by tapering the hole in this manner, a dental abutment (discussed later herein) can be coupled more firmly to fixture 502 by the wedging effects and the frictional engagement of the external surface 608 of the lower portion of the abutment 600 to the inner wall of hole 540. Furthermore, by providing hole 540 into an irregular, noncircular longitudinal cross-section over substantially all of its length, the rotation of the abutment with respect to the fixture can be eliminated. Even further, by providing hole 540 with a profile in cross section that has a continuous curve over substantially all of its length (in this case a generally elliptical surface) the sharp corners or other protrusions that serve as anti-rotation structures of FIGS. 27-31 herein, can be eliminated, and a closer mating between the sidewall of hole 540 and the outer wall of the abutment (discussed below) can be provided as well as a reduction in stress risers by the reduction in sharp transitions (e.g. corners) and the provision of a larger surface area to reduce localized stress. By more closely mating the abutment to hole 540 in the fixture, voids or gaps between the abutment and the fixture can be reduced or eliminated, thus reducing or eliminating the ability for biological matter to accumulate in these voids or gaps and provide a reservoir for infection.

Hole 540 has a generally flat bottom (FIG. 125) into which a second threaded hole 548 extends. Hole 548 is smaller in diameter than the bottom of hole 540 and serves to anchor the abutment inserted into hole 540 in place.

The sidewall of hole 540 is formed as a smooth continuously curved surface having no sharp transitions such as edges or corners between intersecting planes that could create voids and gaps that accumulate biological matter and provide a reservoir for infection. The cross section of hole 540 is elliptical in cross section at its upper end, and tapers smoothly to a circular cross section at its lower end. The elliptical major axis 550 (FIGS. 125, 128) of hole 540 at its upper end is oriented generally front-to-rear (i.e. facial-to-lingual) and its minor axis 552 (FIGS. 124, 128) is oriented generally side-to-side (mesial-to-distal). The major and minor axes (530, 532) of the outer surface of the upper portion 506 and the major and minor axes (550, 552) of the hole 540 are generally aligned, but rotationally displaced from each other by an angle G (FIG. 128) of about 35 degrees about the longitudinal axis 508.

FIGS. 116-123 illustrate a dental abutment 600 that is configured to engage the dental fixture illustrated in FIGS. 124-130. Dental abutment 600 is an elongate structure having a longitudinal axis 602. It is formed as a unitary monolithic elongated body that has an upper portion 604 and a lower portion 606.

Lower portion 606 is generally cylindrical and has a smooth continuous external surface 608 that is revolved around the longitudinal axis 602 and tapers outwardly over its entire length from the bottom of lower portion 606 to the top of lower portion 606. The lower end of lower portion 606 is circular in axial cross-section. The upper end of lower portion 606 is generally elliptical in axial cross-section. The major axis 610 (FIG. 117) of the elliptical cross-section of abutment 600 extends front-to-rear (e.g. facial-to-lingual). The minor axis 612 of the elliptical cross-section of abutment 600 (FIG. 117) extends side-to-side (e.g. mesial-to-distal).

In order to achieve this circular cross-section to elliptical cross-section construction, the front and rear (i.e. facial, lingual) sides of surface 608 flare outward in an upward direction more than the left and right (i.e. mesial, distal) sides of surface 608. In particular, the left and right sides of surface 608, best shown in FIGS. 119 and 121 extend vertically, parallel to longitudinal axis 602. In particular, the left and right sides of surface 608, best shown in FIGS. 119 and 121 extend vertically, generally parallel to longitudinal axis 602, but with a slight outward flare in the upward direction providing an angle Q that may be between 1 and 5 degrees. In some configurations, angle Q may be between 0.5 and 10 degrees or between 0.5 and 20 degrees. Thus the length of the minor axis 612 of the upper portion of the elliptical cross-section is equal to the diameter of the cross-section of the circular cross-section of lower portion 606. The major axis 610 of the elliptical cross-section is greater than the diameter of the circular bottom of the lower portion 606. To provide a major axis 610 having a greater length, the rear portion of surface 608 of lower portion 606 flares outward at an angle H (FIG. 118) with respect to the longitudinal axis 602, and the front portion of surface 608 of lower portion 606 flares outward at an angle I with respect to the longitudinal axis 602. Angles H and I may be constant over the entire height of lower portion 606, from the bottom surface 614 of abutment 600 to the top 616 of lower portion 606. Angle H may be between 14 and 21 degrees. Angle I may be between 7 and 13 degrees. Alternatively, angles H and I may be between 10 and 20 or between 0.5 and 20 degrees.

Referring to FIG. 120, an angle S is defined between upper portion 604 and lower portion 606 of abutment 600. This angle is between 135 and 170 degrees on the lingual side of the abutment. It is between 135 and 175 degrees on the facial side of the abutment. It is between 115 and 180 degrees on the mesial side and distal side of the abutment.

The upper portion 604 of abutment 600 is similar to lower portion 606 in that it has a smooth continuous external surface 618 that is revolved around the longitudinal axis 602 and tapers inwardly over its entire length from the bottom of upper portion 604 to the top of upper portion 604. The lower end of external surface 618, like the upper end of external surface 608 is elliptical having a major axis and a minor axis that are substantially the same as the major and minor axes of lower portion 606.

The lower end of upper portion 604 is generally elliptical in axial cross-section. It has a major axis 620 (FIG. 116) and a minor axis 622 that are disposed in the same angular position about longitudinal axis 602 as are major axis 610 and minor axis 612 of lower portion 606. Thus, when viewing the top or the bottom (FIGS. 116, 117) of abutment 600, the major axes appear superimposed one over the other and likewise the minor axes appear superimposed one over the other. The upper end of lower portion 606 and the lower end of upper portion 604 define ellipses that have major and minor axes of substantially the same length that are disposed in substantially the same location about the longitudinal axis 602 of abutment 600.

Surface 618 tapers inwardly as one traverses surface 618 of upper portion 604 from the lower end of upper portion 604 to the upper end of upper portion 604. The front portion of surface 618 tapers inwardly at an angle J of 6 degrees (FIG. 118). The rear portion of surface 618 tapers inwardly at an angle K of 6 degrees. In another configuration, angles J and K may be between 6 and 8 degrees. In yet another configuration, angles J and K may be between 0.5 and 10 degrees. The left and right sides of surface 618 taper inwardly at an angle R (FIG. 119) of between 0.5 and 6 degrees. In other configurations R may be between 0.5 and 10 degrees.

The top of abutment 600 is defined by three generally planar surfaces: a front surface 624, a top surface 626, and a rear surface 628. These planar surfaces intersect the front, top, and rear portions of surface 618, forming the upper limits of surface 618.

The intersection 630 of upper portion 604 and lower portion 606 of abutment 600 defines a continuous curving junction line that extends around the entire periphery of abutment 600.

The intersection 630 is highest on the left and right sides of abutment 600 where it reaches two local maxima 632, 634 on the right and left sides of abutment 600, respectively. In one embodiment, illustrated here, local maximum 632 of intersection 630 is higher than local maximum 634 of intersection 630.

The intersection 630 is lowest on the front and the rear of abutment 600 where it reaches two local minima 636, 638 at the front and the back sides of abutment 600, respectively. In one embodiment, illustrated here, local minima 636 of intersection 630 is higher than local minima 638 of intersection 630.

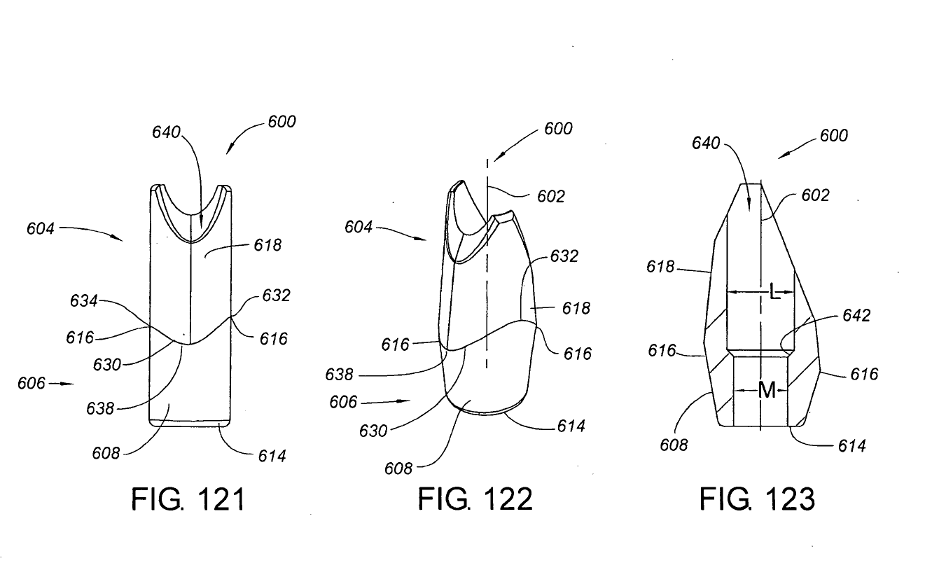

An aperture 640 is provided that extends downward and completely through abutment 600 that is concentric with longitudinal axis 602 and with slightly elliptical bottom surface 614 of abutment 600. This aperture is best shown in FIG. 123, which is a cross-sectional view of abutment 600. Aperture 640 extends into surfaces 624, 626, and 628 of abutment 600. Aperture 640 has a constant first diameter L in the upper portion of abutment 600 that extends downward generally to intersection 630. A chamfer 642 is provided at the bottom of this upper portion of aperture 640. The lower portion of aperture 640 extends through the bottom of abutment 600 and has a smaller diameter M. This portion of aperture 640 extends approximately from intersection 630 through the bottom surface 614 of abutment 600. Diameter L may be 2.5 mm and diameter M may be 2 mm in all the implants herein.

When the implant is assembled, with abutment 600 inserted into fixture 502, a threaded fastener (not shown) is inserted into aperture 640 and is threadedly engaged with the threaded portion of the aperture in fixture 502. The head of the threaded fastener engages chamfer 642 thereby holding the abutment 600 into fixture 502.

FIGS. 163-164 show the fixture 502 and abutment 600 of FIGS. 116-130 in assembled form as it would exist in the patient's mouth. The implant 501, as assembled, includes three components: fixture 502, abutment 600, and threaded fastener 700.

The implant is assembled by inserting the lower portion 606 of abutment 600 into hole 540 of fixture 502. The inside surface of hole 540 is identical in contours to the external surface 608 of lower portion 606, such that no voids or gaps are provided between the two mating surfaces. The dimensions of the mating surfaces, including cross-sectional areas, degree of ellipticality, diameter of their circular bases, and the various angles at which they flare outward and upward are the same.

The inside surface of hole 540 is configured to receive lower portion 606 until lower portion 606 is wedged inside hole 540. In this position, the longitudinal axis 602 of abutment 600 is coaxial with a longitudinal axis 508 of fixture 502. Furthermore, threaded hole 548 of fixture 502 is also coaxial with longitudinal axis 602 of abutment 600 as well as coaxial with threaded fastener 700.

The abutment and fixture are sized to ensure that a gap of approximately 0.25 mm remains between the circular bottom 614 of abutment 600 and the circular bottom of hole 540. This gap ensures that tightening threaded fastener 700 will ensure complete and full frictional engagement of the inside surface of hole 540 and surface 608 of lower portion 606.

The inside surface of hole 540 is configured to receive lower portion 606 until the line that defines the intersection 630 of the outwardly flaring external surface 608 and the inwardly flaring external surface 618 is disposed immediately adjacent to and slightly above the rim of hole 540. The intersection 630 is disposed axially above the top surface of the fixture a distance of between 0.0 and 1.5 mm around the entire periphery of the implant. This includes on the facial and lingual sides shown in FIG. 163 (illustrating the minima 636, 638 of the intersection 630 disposed this distance above the top surface of the fixture), and on the mesial and distal sides shown in FIG. 164 (illustrating the maxima 632, 634 of the intersection 630 disposed this distance above the top surface of the fixture), and at all places in between.

The top surface of the fixture extends radially outward from the intersection 630 a distance of between 0.5 and 1.5 mm around the entire periphery of the implant. This includes on the mesial and distal sides (shown in FIG. 164) and on the facial and lingual sides (shown in FIG. 163) and at all places in between.

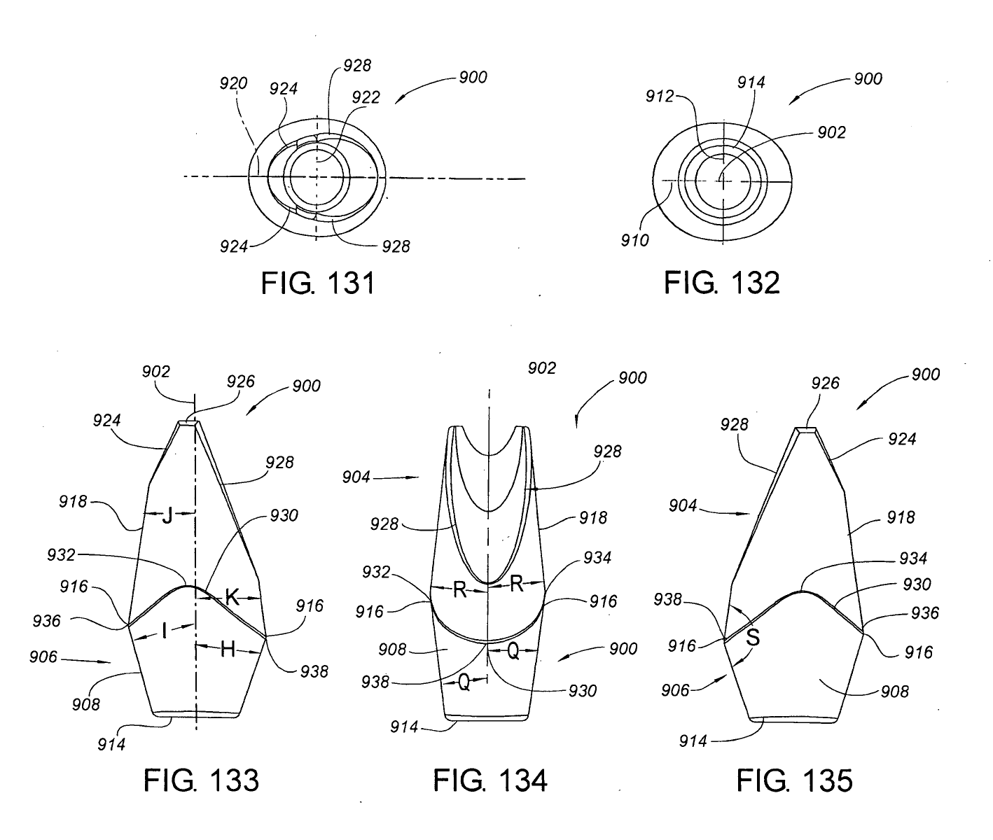

FIGS. 131-138 are top, bottom, right, back, left, front, perspective, and cross-sectional views, respectively, of abutment 900. The cross-sectional view is taken along a cutting plane that extends front to rear and through the longitudinal axis of the abutment.

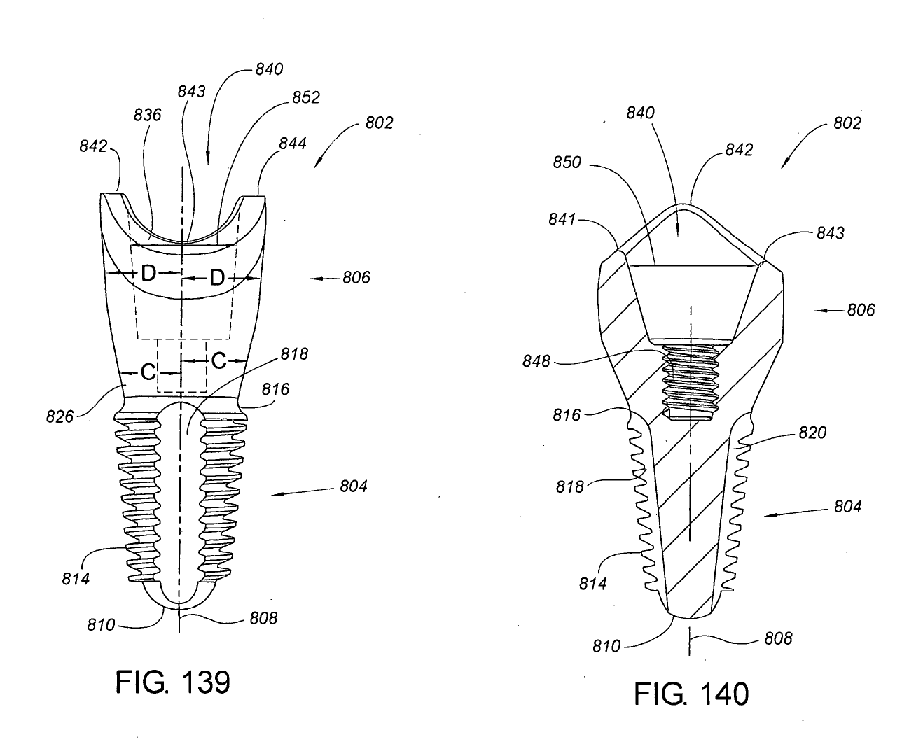

FIGS. 139-146 are front, cross-sectional, rear, left, top, bottom and perspective views of fixture 802. The cross-sectional view is taken along a cutting plane that extends front to rear and through the longitudinal axis of the abutment.

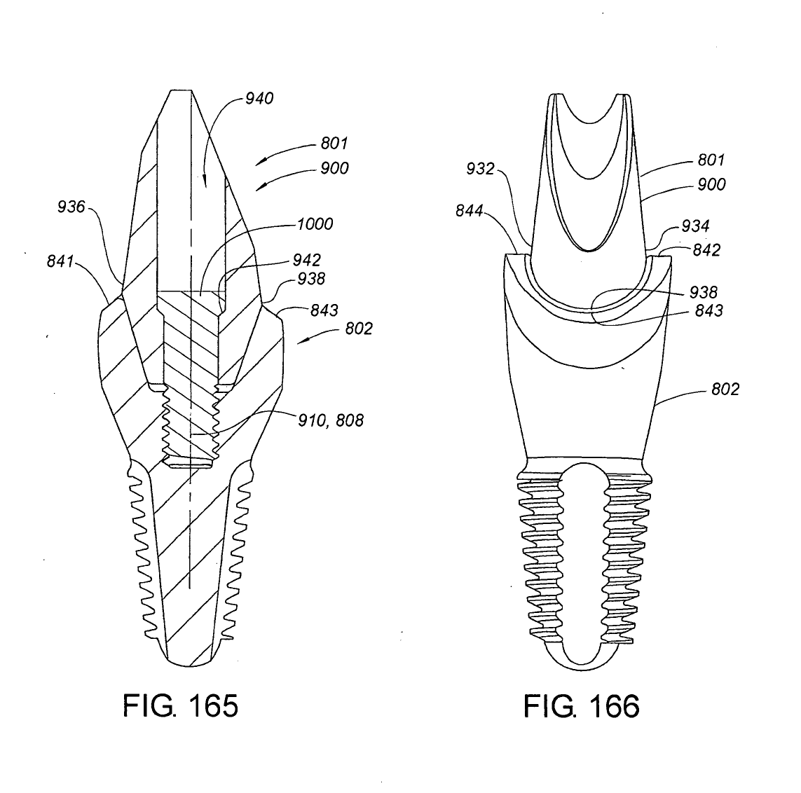

FIGS. 165, 166 illustrate the assembled alternative implant 801 comprised of the abutment 900 of FIGS. 131-138, the fixture 802 of FIGS. 139-146, and a threaded fastener 1000. In FIG. 165, the cutting plane extends through the longitudinal central axis of the implant (the axis of both the fixture and the abutment) and front-to-rear. In FIG. 166, the cutting plane extends through the longitudinal central axis of the implant (the axis of both the fixture and the abutment) and side-to-side.

An identical (but mirror image) implant to the one of FIGS. 131-146, 165, 166 can be used to replace central incisor #9. This implant is identical in all respects to implant 801 but in mirror image form and therefore has not been separately illustrated and described herein.

Referring now to FIGS. 139-146, a dental fixture, here shown as central incisor fixture 802 is illustrated. Fixture 802 includes a lower portion 804 that is formed integral with an upper portion 806. Fixture 802 includes a longitudinal axis 808 that extends from the lower hemispherical tip 810 of the lower portion 804 to the top of fixture 802.

Lower portion 804 is generally circular in longitudinal cross-section having a smaller diameter at a lower end of portion 804 and a larger diameter at the upper end of portion 804. Portion 804 is generally conical with an included flare angle of 12 degrees. This angle may be symmetric about the longitudinal axis 808 of the lower portion 804, such that the cone defined by the major diameter of the threads extends outward from the longitudinal axis 808 by 6 degrees.

This taper permits the threads to be progressively wedged into the maxilla or mandible with each successive turn of fixture 802 about its longitudinal axis. As fixture 802 is rotated, it extends deeper into the bone and extends farther outward in a direction normal to the longitudinal axis 808 of fixture 802, causing each turn of thread 814 to wedge more firmly into the bone. In an alternative arrangement, the fixture can be press fit into the aperture.

Lower fixture portion 804 is threaded over substantially all of its length. Thread 814 extends from the upper part of hemispherical tip 810 to the upper end of the threads located generally at the longitudinal midpoint 816 of fixture 802.

Thread 814 has an asymmetric profile, best shown in FIG. 139. Thread 814 is a single helical thread that extends the length of lower portion 804 of fixture 802 and has a pitch of 0.576 mm, a depth of 0.5 mm, and a length in an axial direction of 6.0 mm. It flares outward at an angle A of 6 degrees from the longitudinal axis (FIG. 142) as it extends upward.

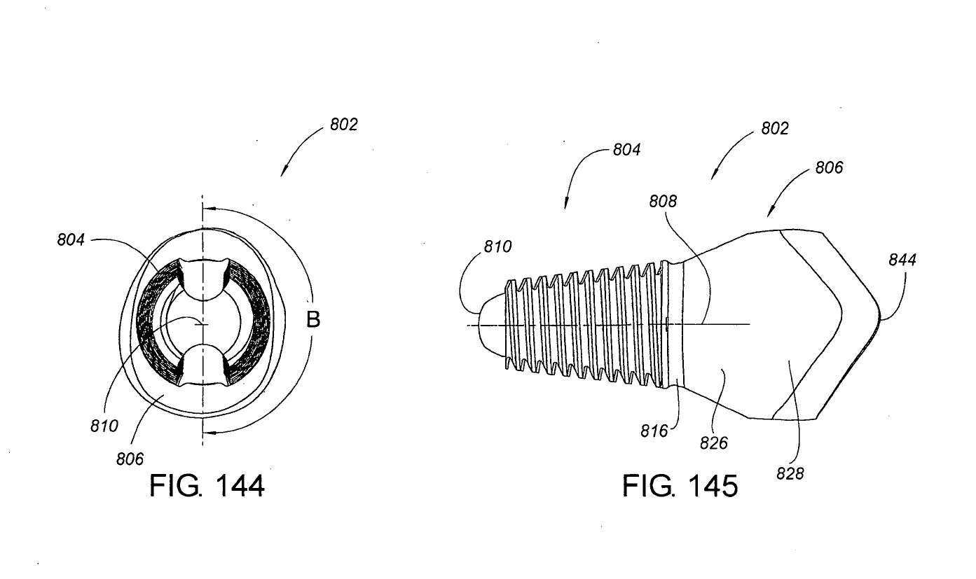

Thread 814 is broken by two longitudinal semi-circular grooves 818, 820 that are provided on the outer surface of fixture portion 804. The grooves are disposed at an angle B of 180 degrees from one another (FIG. 144) as measured in a plane normal to the longitudinal axis 808. Groove 818 extends vertically along the outer front surface of fixture portion 804. Groove 820 extends vertically along the outer rear surface of fixture portion 804. The thread is broken by these grooves (i.e. it does not extend across the grooves). When the fixture is screwed into the bone of the patient's mouth, grooves 818, 820 provide a longitudinally extending void into which bone may grow. Bone that is encouraged to grow into grooves 818, 820 prevents the rotation of the fixture when the fixture is twisted about its longitudinal axis. The longitudinally extending voids also permit fluid in the osteotomy in which the fixture is screwed or pressed to escape when the fixture is inserted.

The upper portion 806 of fixture 802 is substantially the same length (measured in a longitudinal direction) as lower portion 804. The outer surface profile of upper portion 806 differs from portion 804, however. The outer surface 826 of the lower end of upper portion 806 is circular in cross-section with an outer diameter approximately the same as the root diameter of threads 814. As upper portion 806 extends upward toward its upper end, however, this cross-sectional profile changes from a circular profile to a generally oblate and elliptical profile. The outer surface 828 of the upper end of upper portion 806 is generally elliptical in cross-section.

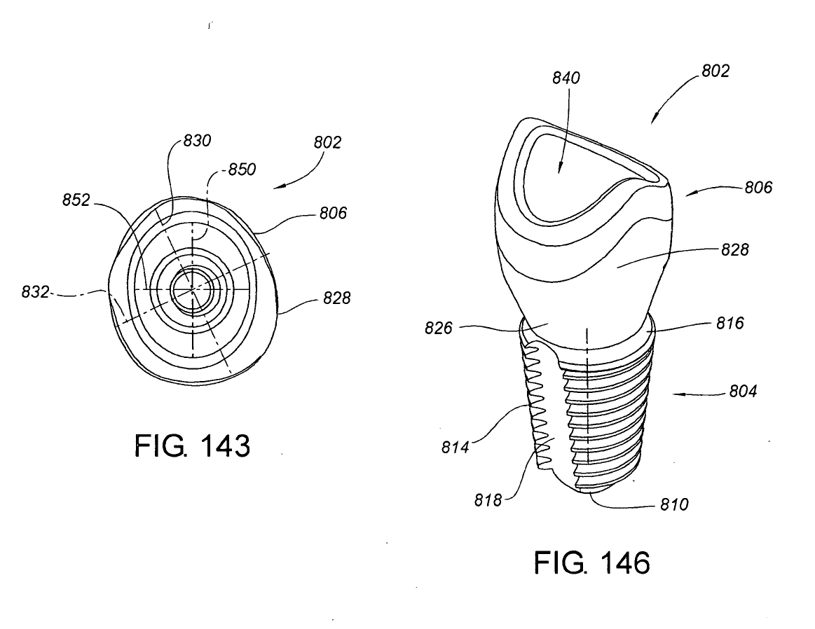

The outer surface 828 has a major axis 830 and a minor axis 832 (FIG. 143), with the major axis 830 extending generally front-to-rear in a facial-to-lingual direction when installed in the patient's mouth, and minor axis 832 extending generally left-to-right in a mesial-distal direction when installed in the patient's mouth.

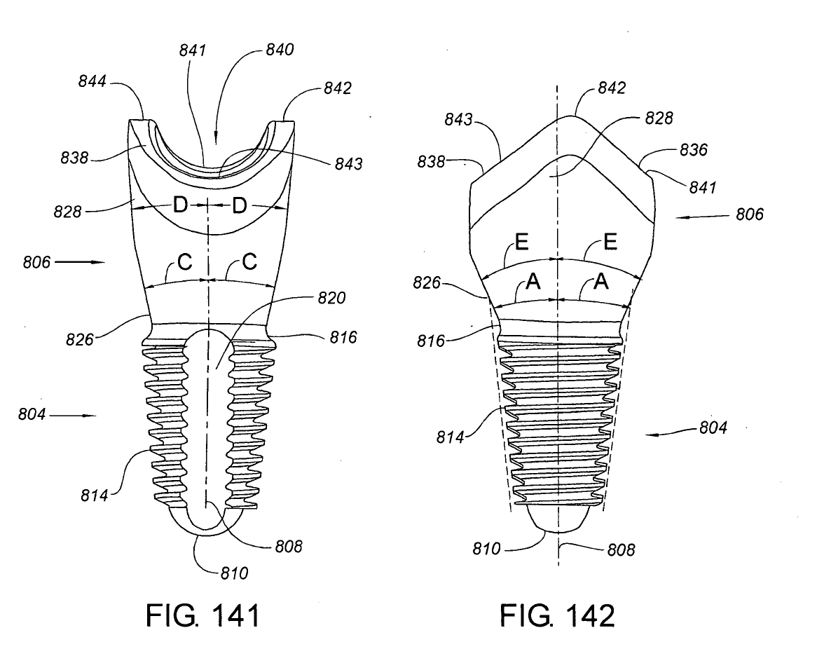

When viewed in front view and rear view (FIGS. 139, 141, respectively), the left and right side walls of upper portion 806 adjacent to thread 814 flare outward in the mesial and distal directions at an angle C that may be between 11 and 13 degrees with respect to the longitudinal axis 808 as they extend upward. About halfway up upper portion 806, the sidewalls flare inward at a slightly smaller angle D that may be between 3 and 5 degrees with respect to longitudinal axis 808.

When viewed in side view (FIGS. 140, 142), the side walls of the upper portion 806 at the left and right ends of the major axis flare outward in the lingual and buccal directions at an angle E of about 21-25 degrees from the longitudinal axis 808 as they extend upward. About halfway up upper portion 806, the sidewalls extend generally vertically, parallel to the longitudinal axis, although they may be rounded as shown on the upper right hand portion of upper portion 806.

The top surface of the fixture is in the form of two intersecting planar surfaces, a front surface 836, and a rear surface 838 that are pierced by an irregularly shaped hole 840 extending downward in the axial direction into upper portion 806 of fixture 802. Surfaces 836, 838 intersect to define two local maxima (or peaks) 842, 844 of the fixture on the left and right side of the fixture, respectively. These two maxima define the uppermost extent of the fixture on each side.

The two surfaces 836, 838 of top surface of fixture 802 are radiused or curved where they intersect and do not meet at a sharp line (for example as illustrated in the embodiment of FIG. 20 in which the front and rear surfaces of the top of the fixture intersect along a line that defines maxima 134, 135). In the embodiment of FIGS. 131 139, this radiused intersection provides two curved crests or peaks (i.e. maxima 842, 844) located on opposite sides of the top of the fixture. Surfaces 836, 838 are not curved to the same degree where they meet. Instead, they are curved more steeply on the left side of the fixture 802 such that the local maximum 842 is slightly higher than the local maximum 844 on the other side of the fixture 802.

Similarly, the two surfaces 836, 838 intersect hole 840 at two local minima 841, 843 located at the front and back, respectively, of fixture 802. The rim of hole 840, where it intersects top surfaces 836, 838 defines a continuously curved path around the upper edge of hole 840 between local maxima 842, 844 disposed on the left and right sides, respectively, of the fixture 802 and local minima 841, 843 located at the front and back, respectively, of fixture 802.

Hole 840 is irregularly shaped, having a cross-sectional profile at its upper end that is substantially elliptical with a major axis extending front to rear and the minor axis extending left to right. As one descends into hole 840, the hole transitions from a substantially elliptical shape to a substantially circular shape having a diameter that may be less than half the length of the minor axis at the top of the fixture. As one descends into hole 840, the major axis is reduced in length at a rate greater than the minor axis is reduced in length. In other words, the circular bottom of hole 840 flares outward in a front to rear direction at a rate greater than it flares outward in a side to side direction as one ascends from the bottom of hole 840 to the top of hole 840. It is this differential rate of flaring that transitions the hole from a circular cross-section at its base to an elliptical cross-section at its upper end.

The configuration of hole 840 has several advantages. First, by tapering the hole in this manner, a dental abutment (discussed later herein) can be coupled more firmly to fixture 802 by the wedging effects and the frictional engagement of the external surface 908 of the lower portion of the abutment 900 to the inner wall of hole 840. Furthermore, by providing hole 840 into an irregular, noncircular longitudinal cross-section over substantially all of its length, the rotation of the abutment with respect to the fixture can be eliminated. Even further, by providing hole 840 with a profile in cross section that has a continuous curve over substantially all of its length (in this case a generally elliptical surface) the sharp corners or other protrusions that serve as anti-rotation structures of FIGS. 27-31 herein, can be eliminated, and a closer mating between the sidewall of hole 840 and the outer wall of the abutment (discussed below) can be provided as well as a reduction in stress risers by the reduction in sharp transitions (e.g. corners) and the provision of a larger surface area to reduce localized stress. By more closely mating the abutment to hole 840 in the fixture, voids or gaps between the abutment and the fixture can be reduced or eliminated, thus reducing or eliminating the ability for biological matter to accumulate in these voids or gaps and provide a reservoir for infection. This tapering also allows for a greater wall thickness and better force distribution to the bone.

Hole 840 has a generally flat bottom (FIG. 140) into which a second threaded hole 848 extends. Hole 848 is smaller in diameter than the bottom of hole 840 and serves to anchor the abutment inserted into hole 840 in place.

The sidewall of hole 840 is formed as a smooth continuously curved surface having no sharp transitions such as edges or corners between intersecting planes that could create voids and gaps that accumulate biological matter and provide a reservoir for infection. The cross section of hole 840 is elliptical in cross section at its upper end, and tapers smoothly to a circular cross section at its lower end. The elliptical major axis 850 (FIGS. 140, 143) of hole 840 at its upper end is oriented generally front-to-rear (i.e. facial-to-lingual) and its minor axis 852 (FIGS. 139, 143) is oriented generally side-to-side (mesial-to-distal). The major and minor axes (830, 832) of the outer surface of the upper portion 806 and the major and minor axes (850, 852) of the hole 840 are generally aligned, but rotationally displaced from each other by an angle G (FIG. 143) of about 35 degrees about the longitudinal axis 808.

FIGS. 131-146 illustrate a dental abutment 900 that is configured to engage the dental fixture illustrated in FIGS. 139-146. Dental abutment 900 is an elongate structure having a longitudinal axis 902. It is formed as a unitary monolithic elongated body that has an upper portion 904 and a lower portion 906.

Lower portion 906 is generally cylindrical and has a smooth continuous external surface 908 that is revolved around the longitudinal axis 902 and tapers outwardly over its entire length from the bottom of lower portion 906 to the top of lower portion 906. The lower end of lower portion 906 is circular in axial cross-section. The upper end of lower portion 906 is generally elliptical in axial cross-section. The major axis 910 (FIG. 132) of the elliptical cross-section of abutment 900 extends front-to-rear (e.g. facial-to-lingual). The minor axis 912 of the elliptical cross-section of abutment 900 (FIG. 132) extends side-to-side (e.g. mesial-to-distal).

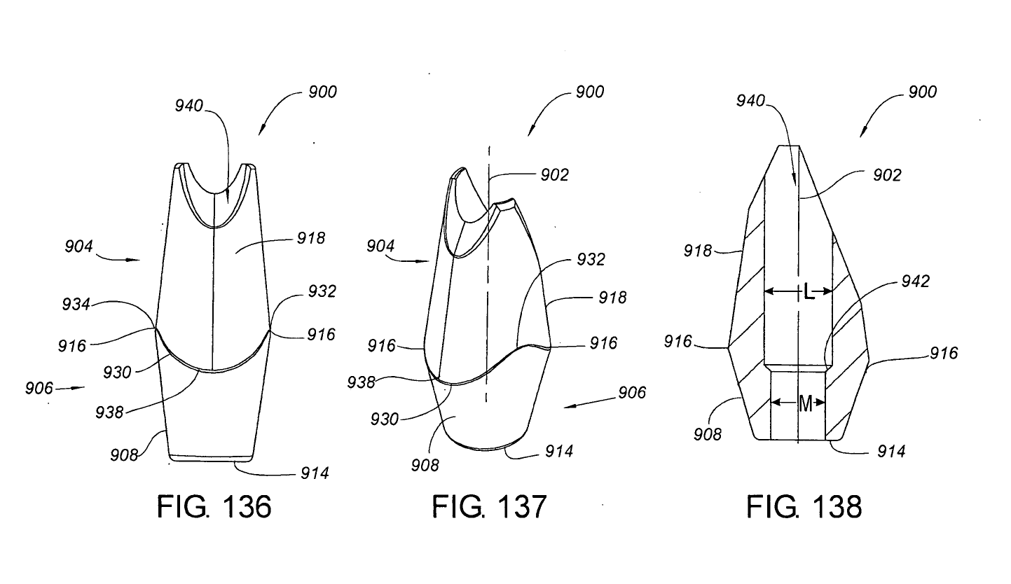

In order to achieve this circular cross-section to elliptical cross-section construction, the front and rear (i.e. facial, lingual) sides of surface 908 flare outward in an upward direction more than the left and right (i.e. mesial or distal) sides of surface 908. In particular, the left and right sides of surface 908, best shown in FIGS. 134 and 136 extend vertically, generally parallel to longitudinal axis 902, but with a slight outward flare in the upward direction providing an angle Q that may be between 3 and 9 degrees. In some configurations, angle Q may be between 0.5 and 10 degrees or between 0.5 and 20 degrees. Thus the length of the minor axis 912 of the upper portion of the elliptical cross-section is slightly greater than the diameter of the circular bottom of lower portion 906. The major axis 910 of the elliptical cross-section is greater than the diameter of the circular bottom of the lower portion 906. To provide a major axis 910 having a greater length, the rear portion of surface 908 of lower portion 906 flares outward at an angle H, that may be between 17 and 21 degrees (FIG. 133) with respect to the longitudinal axis 902, and the front portion of surface 908 of lower portion 906 flares outward at an angle I, that may be between 13 and 19 degrees with respect to the longitudinal axis 902. Angles H and I may be constant over the entire height of lower portion 906, from the bottom surface 914 of abutment 900 to the top 916 of lower portion 906. Alternatively, angles H and I may be between 10 and 20 or between 0.5 and 20 degrees.

Referring to FIG. 135, an angle S is defined between upper portion 904 and lower portion 906 of abutment 900. This angle is between 135 and 170 degrees on the lingual side of the abutment. It is between 135 and 175 degrees on the facial side of the abutment. It is between 115 and 180 degrees on the mesial side and distal side of the abutment.

The upper portion 904 of abutment 900 is similar to lower portion 906 in that it has a smooth continuous external surface 918 that is revolved around the longitudinal axis 902 and tapers inwardly over its entire length from the bottom of upper portion 904 to the top of upper portion 904. The lower end of external surface 918, and the upper end of external surface 908 are elliptical in cross-section having major axes and minor axes that are substantially the same.

The lower end of upper portion 904 is generally elliptical in axial cross-section. It has a major axis 920 (FIG. 131) and a minor axis 922 that are disposed in the same angular position about longitudinal axis 902 as are major axis 910 and minor axis 912 of lower portion 906. Thus, when viewing the top or the bottom (FIGS. 131, 132) of abutment 900, the major axes appear superimposed one over the other and likewise the minor axes appear superimposed one over the other. The upper end of lower portion 906 and the lower end of upper portion 904 define ellipses that have major and minor axes of substantially the same length that are disposed in substantially the same location about the longitudinal axis 902 of abutment 900.

Surface 918 tapers inwardly as one traverses surface 918 of upper portion 904 from the lower end of upper portion 904 to the upper end of upper portion 904. The front portion of surface 918 tapers inwardly at an angle J, that may be between 5 and 11 degrees. The rear portion of surface 918 tapers inwardly at an angle K, that may be between 5 and 11 degrees. In another configuration, angles J and K may be between 0.5 and 10 degrees. The left and right sides of surface 918 taper inwardly at an angle R (FIG. 134) of between 0.5 and 6 degrees. In other configurations R may be between 0.5 and 10 degrees.

The top of abutment 900 is defined by three generally planar surfaces: a front surface 924, a top surface 926, and a rear surface 928. These planar surfaces intersect the front, top, and rear portions of surface 918, forming the upper limits of surface 918.

The intersection 930 of upper portion 904 and lower portion 906 of abutment 900 defines a continuous curving junction line that extends around the entire periphery of abutment 900.

The intersection 930 is highest on the left and right sides of abutment 900 where it reaches two local maxima 932, 934 on the right and left sides of abutment 900, respectively. In one embodiment, illustrated here, local maximum 932 of intersection 930 is at substantially the same height as local maximum 934 of intersection 930.

The intersection 930 is lowest on the front and the rear of abutment 900 where it reaches two local minima 936, 938 at the front and the back sides of abutment 900, respectively. In one embodiment, illustrated here, local minima 936 of intersection 930 is higher than local minima 938 of intersection 930.

An aperture 940 is provided that extends downward and completely through abutment 900 that is concentric with longitudinal axis 902 and with elliptical bottom surface 914 of abutment 900. This aperture is best shown in FIG. 138, which is a cross-sectional view of abutment 900. Aperture 940 extends into surfaces 924, 926, and 928 of abutment 900. Aperture 940 has a constant first diameter L in the upper portion of abutment 900 that extends downward generally to intersection 930. A chamfer 942 is provided at the bottom of this upper portion of aperture 940. The lower portion of aperture 940 extends through the bottom of abutment 900 and has a smaller diameter M. This portion of aperture 940 extends approximately from intersection 930 through the bottom surface 914 of abutment 900.

When the implant is assembled, with abutment 900 inserted into fixture 802, a threaded fastener (not shown) is inserted into aperture 940 and is threadedly engaged with the threaded portion of the aperture in fixture 802. The head of the threaded fastener engages chamfer 942 thereby holding the abutment 900 into fixture 802.

FIGS. 165-166 show the fixture 802 and abutment 900 of FIGS. 131-146 in assembled form as it would exist in the patient's mouth. The implant 801, as assembled, includes three components: fixture 802, abutment 900, and threaded fastener 1000.

The implant is assembled by inserting the lower portion 906 of abutment 900 into hole 840 of fixture 802. The inside surface of hole 840 is identical in contours to the external surface 908 of lower portion 906, such that no voids or gaps are provided between the two mating surfaces. The dimensions of the mating surfaces, including cross-sectional areas, degree of ellipticality, diameter of their circular bases, and the various angles at which they flare outward and upward are the same.

The inside surface of hole 840 is configured to receive lower portion 906 until lower portion 906 is wedged inside hole 840. In this position, the longitudinal axis 902 of abutment 900 is coaxial with a longitudinal axis 808 of fixture 802. Furthermore, threaded hole 848 of fixture 802 is also coaxial with longitudinal axis 902 of abutment 900 as well as coaxial with threaded fastener 1000.

The abutment and fixture are sized to ensure that a gap of approximately 0.25 mm remains between the circular bottom of abutment 900 and the circular bottom of hole 840. This gap ensures that tightening threaded fastener 1000 will ensure complete and full frictional engagement of the inside surface of hole 840 and surface 908 of lower portion 906.

The inside surface of hole 840 is configured to receive lower portion 906 until the line that defines the intersection 930 of the outwardly flaring external surface 908 and the inwardly flaring external surface 918 is disposed immediately adjacent to the rim of hole 840. The intersection 930 is disposed axially above the top surface of the fixture a distance of between 0.0 and 1.5 mm around the entire periphery of the implant. This includes on the facial and lingual sides shown in FIG. 165 (illustrating the minima 936, 938 of the intersection 930 disposed this distance above the top surface of the fixture), and on the mesial and distal sides shown in FIG. 166 (illustrating the maxima 932, 934 of the intersection 930 disposed this distance above the top surface of the fixture), and at all places in between.

The top surface of the fixture extends radially outward from the intersection 930 a distance of between 0.5 and 1.5 mm around the entire periphery of the implant. This includes on the mesial and distal sides (shown in FIG. 166) and on the facial and lingual sides (shown in FIG. 165) and at all places in between.

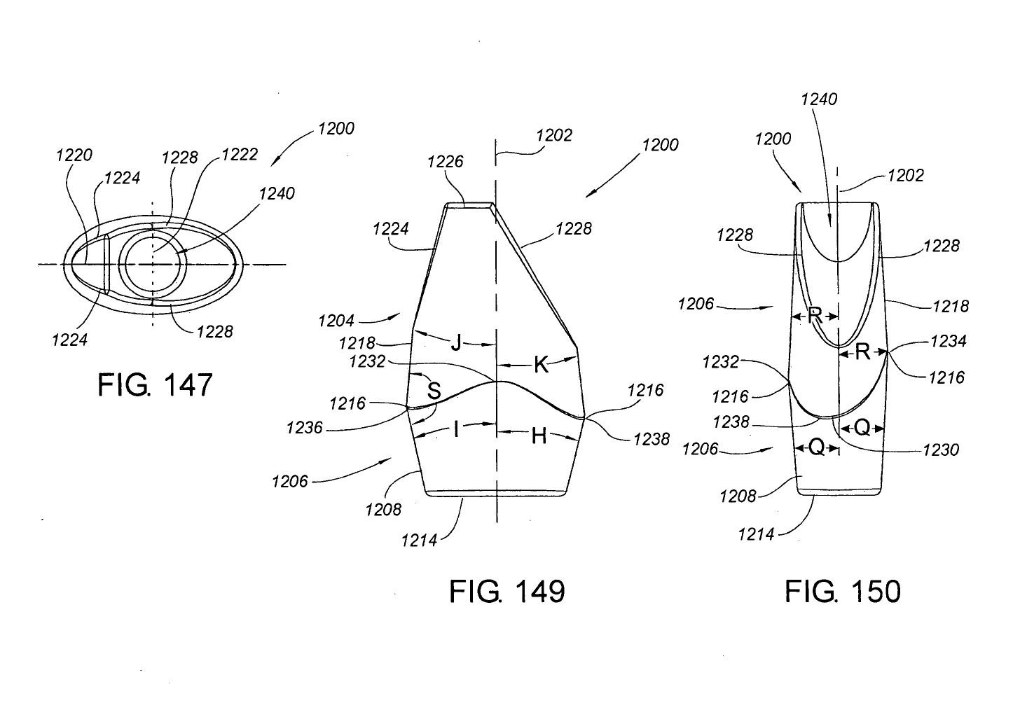

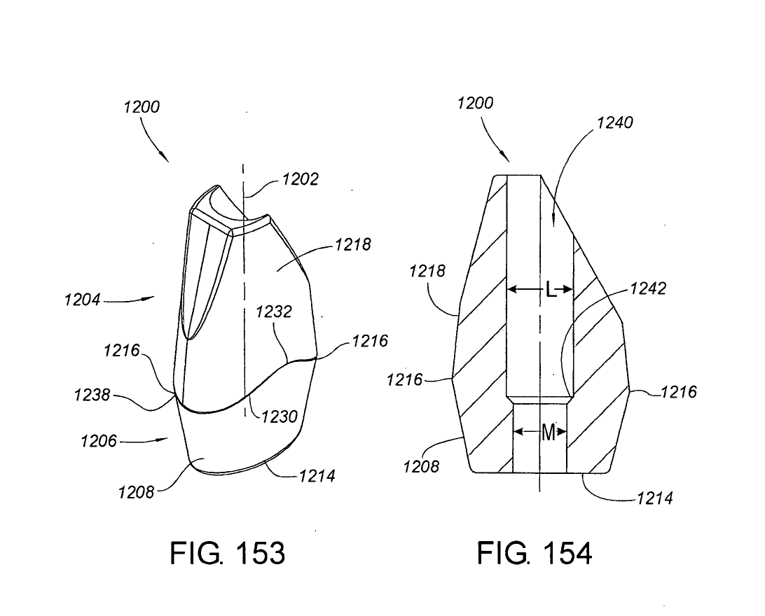

FIGS. 147-154 are top, bottom, right, back, left, front, perspective, and cross-sectional views, respectively, of abutment 1200. The cross-sectional view is taken along a cutting plane that extends front to rear and through the longitudinal axis of the abutment.

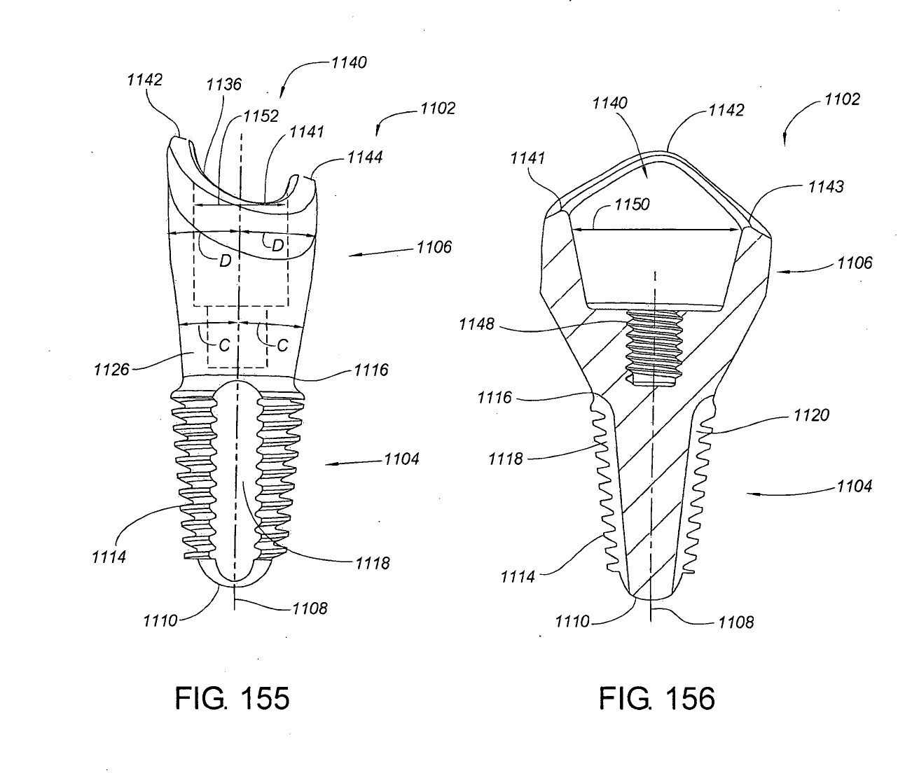

FIGS. 155-162 are front, cross-sectional, rear, left, top, bottom and perspective views of fixture 1102. The cross-sectional view is taken along a cutting plane that extends front to rear and through the longitudinal axis of the abutment.

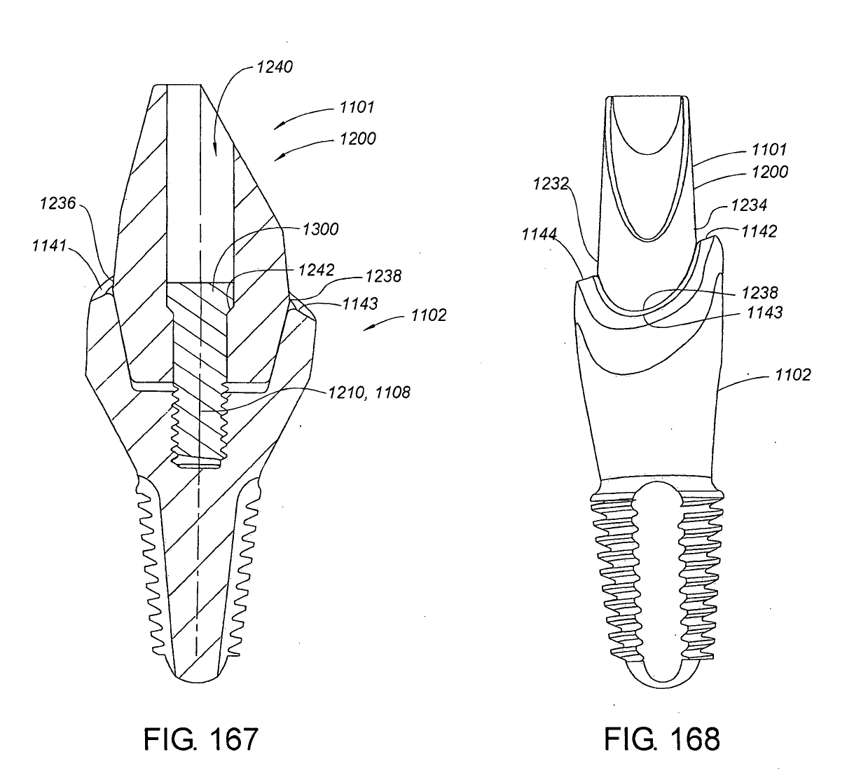

FIGS. 167, 168 illustrate the assembled alternative implant 1101 comprised of the abutment 1200 of FIGS. 147-154, the fixture 1102 of FIGS. 155-162, and a threaded fastener 1300. In FIG. 167, the cutting plane extends through the longitudinal central axis of the implant (the axis of both the fixture and the abutment) and front-to-rear. In FIG. 168, the cutting plane extends through the longitudinal central axis of the implant (the axis of both the fixture and the abutment) and side-to-side.

An identical (but mirror image) implant to the one of FIGS. 147-162, 167, 168 can be used to replace cuspid #11. This implant is identical in all respects to implant 1101 but in mirror image form and therefore has not been separately illustrated and described herein.

Referring now to FIGS. 155-162, a dental fixture, here shown as cuspid fixture 1102 is illustrated. Fixture 1102 includes a lower portion 1104 that is formed integral with an upper portion 1106. Fixture 1102 includes a longitudinal axis 1108 that extends from the lower hemispherical tip 1110 of the lower portion 1104 to the top of fixture 1102.

Lower portion 1104 is generally circular in longitudinal cross-section having a smaller diameter at a lower end of portion 1104 and a larger diameter at the upper end of portion 1104. Portion 1104 is generally conical with an included flare angle of 12 degrees. This angle may be symmetric about the longitudinal axis 1108 of the lower portion 1104, such that the cone defined by the major diameter of the threads extends outward from the longitudinal axis 1108 by 6 degrees.

This taper permits the threads to be progressively wedged into the maxilla or mandible with each successive turn of fixture 1102 about its longitudinal axis. As fixture 1102 is rotated, it extends deeper into the bone and extends farther outward in a direction normal to the longitudinal axis 1108 of fixture 1102, causing each turn of thread 1114 to wedge more firmly into the bone. In an alternative arrangement, the fixture can be press fit into the aperture.

Lower fixture portion 1104 is threaded over substantially all of its length. Thread 1114 extends from the upper part of hemispherical tip 1110 to the upper end of the threads located generally at the longitudinal midpoint 1116 of fixture 1102.

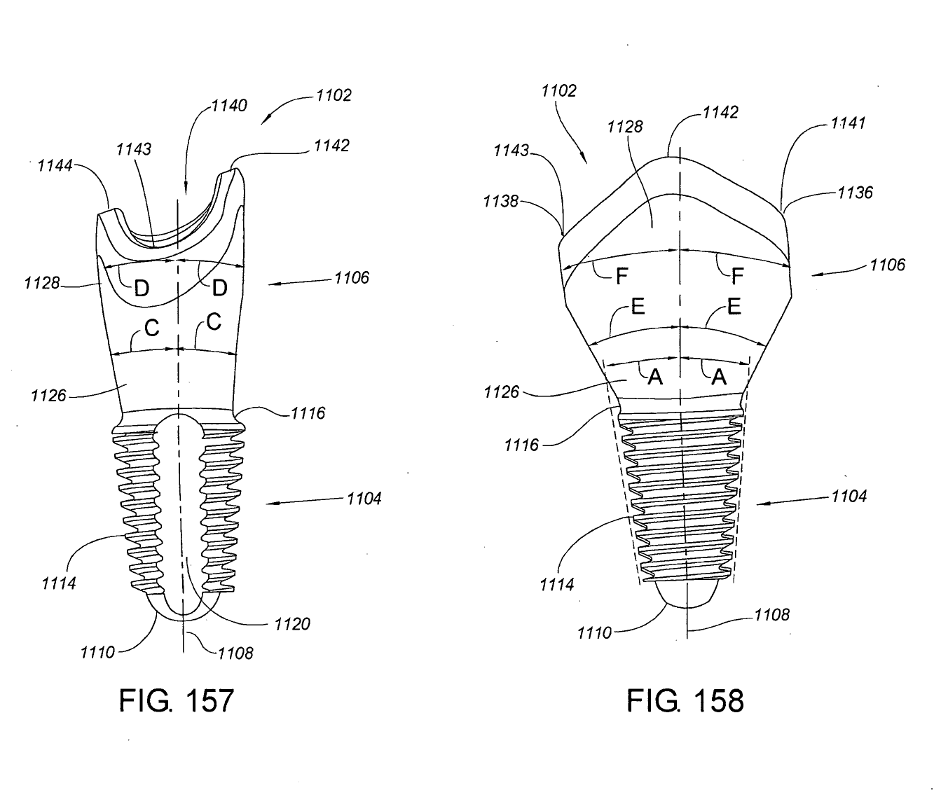

Thread 1114 has an asymmetric profile, best shown in FIG. 155. Thread 1114 is a single helical thread that extends the length of lower portion 1104 of fixture 1102 and has a pitch of 0.576 mm, a depth of 0.5 mm, and a length in an axial direction of 6.0 mm. It flares outward at an angle A of 6 degrees from the longitudinal axis (FIG. 158) as it extends upward.

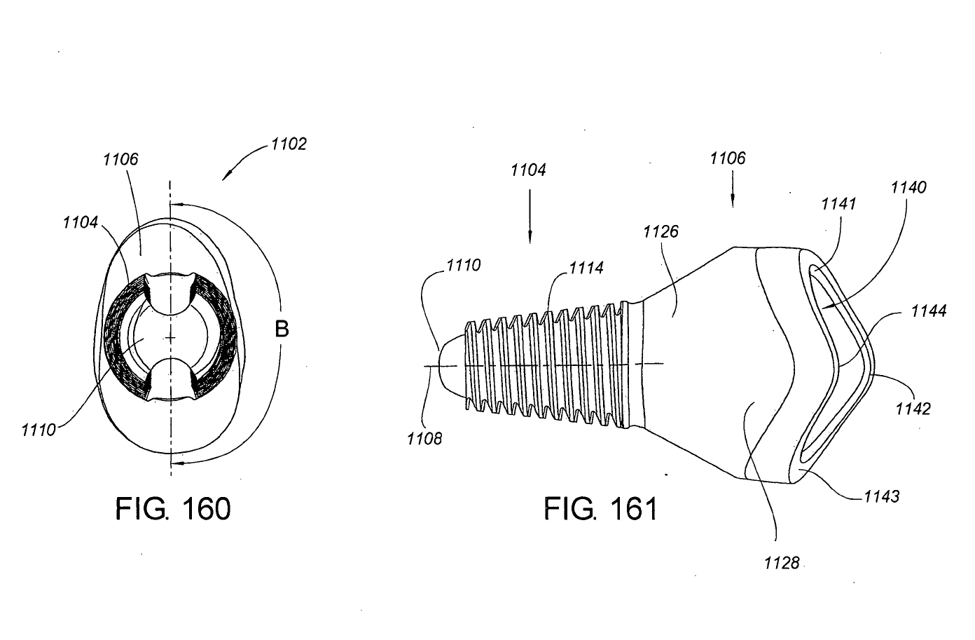

Thread 1114 is broken by two longitudinal semi-circular grooves 1118, 1120 that are provided on the outer surface of fixture portion 1104. The grooves are disposed at an angle B of 180 degrees from one another (FIG. 160) as measured in a plane normal to the longitudinal axis 1108. Groove 1118 extends vertically along the outer front surface of fixture portion 1104. Groove 1120 extends vertically along the outer rear surface of fixture portion 1104. The thread is broken by these grooves (i.e. it does not extend across the grooves). When the fixture is screwed into the bone of the patient's mouth, grooves 1118, 1120 provide a longitudinally extending void into which bone may grow. Bone that is encouraged to grow into grooves 1118, 1120 prevents the rotation of the fixture when the fixture is twisted about its longitudinal axis. These grooves also allow for fluid evacuation when press fit into the osteotomy. They also ensure the threads do not come through the facial bone of the maxilla.

The upper portion 1106 of fixture 1102 is substantially the same length (measured in a longitudinal direction) as lower portion 1104. The outer surface profile of upper portion 1106 differs from portion 1104, however. The outer surface 1126 of the lower end of upper portion 1106 is circular in cross-section with an outer diameter approximately the same as the root diameter of threads 1114. As upper portion 1106 extends upward toward its upper end, however, this cross-sectional profile changes from a circular profile to a generally oblate and elliptical profile. The outer surface 1128 of the upper end of upper portion 1106 is generally elliptical in cross-section.

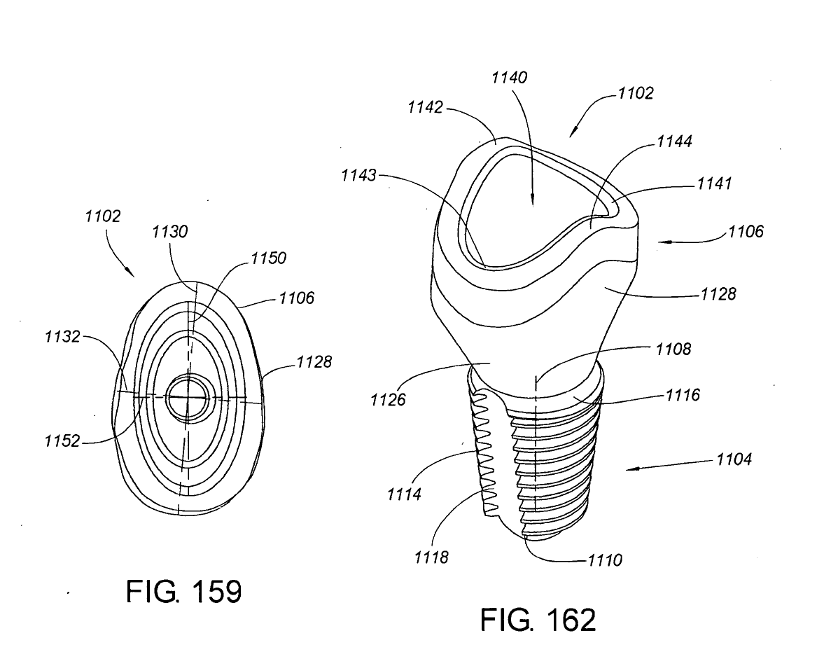

The outer surface 1128 has a major axis 1130 and a minor axis 1132 (FIG. 159), with the major axis 1130 extending generally front-to-rear in a facial-to-lingual direction when installed in the patient's mouth, and minor axis 1132 extending generally left-to-right in a mesial-distal direction when installed in the patient's mouth.

When viewed in front view and rear view (FIGS. 155, 157, respectively), the left and right side walls of upper portion 1106 adjacent to thread 1114 flare outward in the mesial and distal directions at an angle C, that may be between 4 and 9 degrees with respect to the longitudinal axis 1108 as they extend upward. About halfway up upper portion 1106, the sidewalls flare outward at a slightly smaller angle D, that may be between 0.5 and 11 degrees with respect to longitudinal axis 1108.

When viewed in side view (FIGS. 156, 158), the side walls of the upper portion 1106 at the left and right ends of the major axis flare outward in the lingual and buccal directions at an angle E, that may be between 26 and 30 degrees from the longitudinal axis 1108 as they extend upward. About halfway up upper portion 1106, the sidewalls flare outward at a smaller angle F, that may be between 0.5 and 8 degrees with respect to the longitudinal axis 1108.

The top surface of the fixture is in the form of two intersecting planar surfaces, a front surface 1136, and a rear surface 1138 that are pierced by an irregularly shaped hole 1140 extending downward in the axial direction into upper portion 1106 of fixture 1102. Surfaces 1136, 1138 intersect to define two local maxima (or peaks) 1142, 1144 of the fixture on the left and right side of the fixture, respectively. These two maxima define the uppermost extent of the fixture on each side.

The two surfaces 1136, 1138 of top surface of fixture 1102 are radiused or curved where they intersect and do not meet at a sharp line (for example as illustrated in the embodiment of FIG. 20 in which the front and rear surfaces of the top of the fixture intersect along a line that defines maxima 150, 151). In the embodiment of FIGS. 147-155, this radiused intersection provides two curved crests or peaks (i.e. maxima 1142, 1144) located on opposite sides of the top of the fixture. Surfaces 1136, 1138 are not curved to the same degree where they meet. Instead, they are curved more steeply on the left side of the fixture 1102 such that the local maximum 1142 is higher than the local maximum 1144 on the other side of the fixture 1102.

Similarly, the two surfaces 1136, 1138 intersect hole 1140 at two local minima 1141, 1143 located at the front and back, respectively, of fixture 1102. The rim of hole 1140, where it intersects top surfaces 1136, 1138 defines a continuously curved path around the upper edge of hole 1140 between local maxima 1142, 1144 disposed on the left and right sides, respectively, of the fixture 1102 and local minima 1141, 1143 located at the front and back, respectively, of fixture 1102.

Hole 1140 is irregularly shaped, having a cross-sectional profile at its upper end that is substantially elliptical with a major axis extending front to rear and the minor axis extending left to right. As one descends into hole 1140, the hole transitions from a substantially elliptical shape to either a substantially circular shape or a substantially elliptical shape (as shown herein) having a diameter that may be less than half the length of the minor axis at the top of the fixture. As one descends into hole 1140, the major axis is reduced in length at a rate greater than the minor axis is reduced in length. In other words, the circular (or elliptical) bottom of hole 1140 flares outward in a front to rear direction at a rate greater than it flares outward in a side to side direction as one ascends from the bottom of hole 1140 to the top of hole 1140. It is this differential rate of flaring the transitions the hole from a circular (or smaller elliptical) cross-section at its base to an elliptical cross-section at its upper end.

The configuration of hole 1140 has several advantages. First, by tapering the hole in this manner, a dental abutment (discussed later herein) can be coupled more firmly to fixture 1102 by the wedging effects and the frictional engagement of the external surface 1208 of the lower portion of the abutment 1200 to the inner wall of hole 1140. Furthermore, by providing hole 1140 into an irregular, noncircular longitudinal cross-section over substantially all of its length, the rotation of the abutment with respect to the fixture can be eliminated. Even further, by providing hole 1140 with a profile in cross section that has a continuous curve over substantially all of its length (in this case a generally elliptical surface) the sharp corners or other protrusions that serve as anti-rotation structures of FIGS. 27-31 herein, can be eliminated, and at closer mating between the sidewall of hole 1140 and the outer wall of the abutment (discussed below) can be provided as well as a reduction in stress risers by the reduction in sharp transitions (e.g. corners) and the provision of a larger surface area to reduce localized stress. By more closely mating the abutment to hole 1140 in the fixture, voids or gaps between the abutment and the fixture can be reduced or eliminated, thus reducing or eliminating the ability for biological matter to accumulate in these voids or gaps and provide a reservoir for infection. This tapering also allows for a greater wall thickness and better force distribution to the bone.

Hole 1140 has a generally flat bottom (FIG. 156) into which a second threaded hole 1148 extends. Hole 1148 is smaller in diameter than the bottom of hole 1140 and serves to anchor the abutment inserted into hole 1140 in place.

The sidewall of hole 1140 is formed as a smooth continuously curved surface having no sharp transitions such as edges or corners between intersecting planes that could create voids and gaps that accumulate biological matter and provide a reservoir for infection. The cross section of hole 1140 is elliptical in cross section at its upper end, and tapers smoothly to a circular cross section at its lower end. The elliptical major axis 1150 (FIGS. 156, 159) of hole 1140 at its upper end is oriented generally front-to-rear (i.e. facial-to-lingual) and its minor axis 1152 (FIGS. 155, 159) is oriented generally side-to-side (mesial-to-distal). The major and minor axes (1130, 1132) of the outer surface of the upper portion 1106 and the major and minor axes (1150, 1152) of the hole 1140 are generally aligned, but rotationally displaced from each other by an angle G (FIG. 159) of about 5 degrees about the longitudinal axis 1108.

FIGS. 147-154 illustrate a dental abutment 1200 that is configured to engage the dental fixture illustrated in FIGS. 155-162. Dental abutment 1200 is an elongate structure having a longitudinal axis 1202. It is formed as a unitary monolithic elongated body that has an upper portion 1204 and a lower portion 1206.

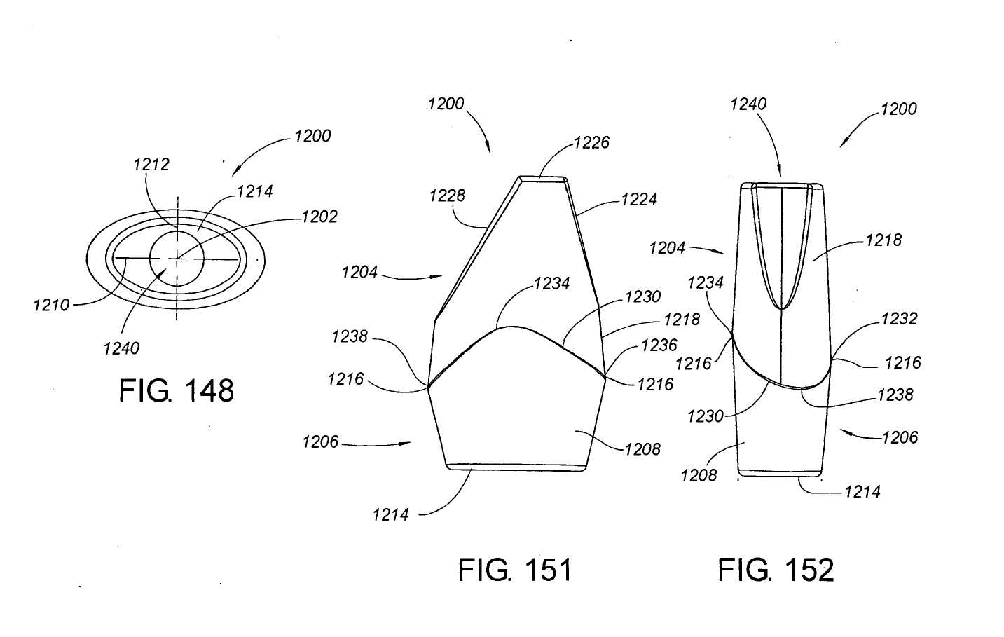

Lower portion 1206 is generally cylindrical and has a smooth continuous external surface 1208 that is revolved around the longitudinal axis 1202 and tapers outwardly over its entire length from the bottom of lower portion 1206 to the top of lower portion 1206. The lower end of lower portion 1206 is generally elliptical in axial cross-section. The upper end of lower portion 1206 is generally elliptical in axial cross-section, but is less elongated than the cross-section at the upper end. The major axis 1210 (FIG. 148) of the elliptical cross-sections of abutment 1200 extend generally front-to-rear (e.g. facial-to-lingual). The minor axis 1212 of the upper and lower elliptical cross-sections of abutment 1200 (FIG. 148) extend generally side-to-side (e.g. mesial-to-distal).

In order to achieve this more elongate upper elliptical cross-section to less elongate lower elliptical cross-section construction, the front and rear (i.e. facial, lingual) sides of surface 1208 flare outward in an upward direction more than the left and right (i.e. mesial or distal) sides of surface 1208. In particular, the left and right sides of surface 1208, best shown in FIGS. 150 and 152 extend vertically, generally parallel to longitudinal axis 1202, but with a slight outward flare in the upward direction providing an angle Q that may be between 1 and 7 degrees. In some configurations, angle Q may be between 0.5 and 10 degrees or between 0.5 and 20 degrees. Thus the length of the minor axis 1212 of the upper elliptical cross-section of lower portion 1206 is slightly greater than the minor axis of the lower elliptical cross-section of lower portion 1206. The major axis 1210 of the upper elliptical cross-section is greater than the diameter of the elliptical bottom of the lower portion 1206. To provide a major axis 1210 having a greater length, the rear portion of surface 1208 of lower portion 1206 flares outward at an angle H (FIG. 149) with respect to the longitudinal axis 1202, and the front portion of surface 1208 of lower portion 1206 flares outward at an angle I with respect to the longitudinal axis 1202. Angles H and I may be constant over the entire height of lower portion 1206, from the bottom surface 1214 of abutment 1200 to the top 1216 of lower portion 1206. Angle H may be between 11 and 18 degrees and angle I may be between 9 and 16 degrees. Alternatively, angles H and I may be between 10 and 20 or between 0.5 and 20 degrees.

Referring to FIG. 149, an angle S is defined between upper portion 1204 and lower portion 1206 of abutment 1200. This angle is between 135 and 170 degrees on the lingual side of the abutment. It is between 135 and 175 degrees on the facial side of the abutment. It is between 115 and 180 degrees on the mesial side and distal side of the abutment.

The upper portion 1204 of abutment 1200 is similar to lower portion 1206 in that it has a smooth continuous external surface 1218 that is revolved around the longitudinal axis 1202 and tapers inwardly over its entire length from the bottom of upper portion 1204 to the top of upper portion 1204. The lower end of external surface 1218, and the upper end of external surface 1208 may have major and minor axes that are substantially the same.

The lower end of upper portion 1204 is generally elliptical in axial cross-section. It has a major axis 1220 (FIG. 147) and a minor axis 1222 that are disposed in the same angular position about longitudinal axis 1202 as are major axis 1210 and minor axis 1212 of lower portion 1206. Thus, when viewing the top or the bottom (FIGS. 147, 148) of abutment 1200, the major axes appear superimposed one over the other and likewise the minor axes appear superimposed one over the other. The upper end of lower portion 1206 and the lower end of upper portion 1204 define ellipses that have major and minor axes of substantially the same length that are disposed in substantially the same location about the longitudinal axis 1202 of abutment 1200.

Surface 1218 tapers inwardly as one traverses surface 1218 of upper portion 1204 from the lower end of upper portion 1204 to the upper end of upper portion 1204. The front portion of surface 1218 tapers inwardly at an angle J of 6 degrees, or between 3 and 9 degrees. The rear portion of surface 1218 tapers inwardly at an angle K of 6 degrees, or between 3 and 9 degrees. In another configuration, angles J and K may be between 0.5 and 10 degrees. The left and right sides of surface 1218 taper inwardly at an angle R (FIG. 150) of between 0.5 and 6 degrees. In other configurations R may be between 0.5 and 10 degrees.

The top of abutment 1200 is defined by three generally planar surfaces: a front surface 1224, a top surface 1226, and a rear surface 1228. These planar surfaces intersect the front, top, and rear portions of surface 1218, forming the upper limits of surface 1218.

The intersection 1230 of upper portion 1204 and lower portion 1206 of abutment 1200 defines a continuous curving junction line that extends around the entire periphery of abutment 1200.

The intersection 1230 is highest on the left and right sides of abutment 1200 where it reaches two local maxima 1232, 1234 on the right and left sides of abutment 1200, respectively. In one embodiment, illustrated here, local maximum 1232 of intersection 1230 is lower than local maximum 1234 of intersection 1230.

The intersection 1230 is lowest on the front and the rear of abutment 1200 where it reaches two local minima 1236, 1238 at the front and the back sides of abutment 1200, respectively. In one embodiment, illustrated here, local minima 1236 of intersection 1230 is higher than local minima 1238 of intersection 1230.

An aperture 1240 is provided that extends downward and completely through abutment 1200 that is concentric with longitudinal axis 1202 and with elliptical bottom surface 1214 of abutment 1200. This aperture is best shown in FIG. 154, which is a cross-sectional view of abutment 1200. Aperture 1240 extends into surfaces 1224, 1226, and 1228 of abutment 1200. Aperture 1240 has a constant first diameter L in the upper portion of abutment 1200 that extends downward generally to intersection 1230. A chamfer 1242 is provided at the bottom of this upper portion of aperture 1240. The lower portion of aperture 1240 extends through the bottom of abutment 1200 and has a smaller diameter M. This portion of aperture 1240 extends approximately from intersection 1230 through the bottom surface 1214 of abutment 1200.

When the implant is assembled, with abutment 1200 inserted into fixture 1102, a threaded fastener (not shown) is inserted into aperture 1240 and is threadedly engaged with the threaded portion of the aperture in fixture 1102. The head of the threaded fastener engages chamfer 1242 thereby holding the abutment 1200 into fixture 1102.

FIGS. 167-168 show the fixture 1102 and abutment 1200 of FIGS. 147-162 in assembled form as it would exist in the patient's mouth. The implant 1101, as assembled, includes three components: fixture 1102, abutment 1200, and threaded fastener 1300.

The implant is assembled by inserting the lower portion 1206 of abutment 1200 into hole 1140 of fixture 1102. The inside surface of hole 1140 is identical in contours to the external surface 1208 of lower portion 1206, such that no voids or gaps are provided between the two mating surfaces. The dimensions of the mating surfaces, including cross-sectional areas, degree of ellipticality, diameters of their circular bases (or major and minor axes of their elliptical bases), and the various angles at which they flare outward and upward are the same.

The inside surface of hole 1140 is configured to receive lower portion 1206 until lower portion 1206 is wedged inside hole 1140. In this position, the longitudinal axis 1202 of abutment 1200 is coaxial with a longitudinal axis 1108 of fixture 1102. Furthermore, threaded hole 1148 of fixture 1102 is also coaxial with longitudinal axis 1202 of abutment 1200 as well as coaxial with threaded fastener 1300.

The abutment and fixture are sized to ensure that a gap of approximately 0.25 mm remains between the elliptical bottom of abutment 1200 and the elliptical bottom of hole 1140. This gap ensures that tightening threaded fastener 1300 will ensure complete and full frictional engagement of the inside surface of hole 1140 and surface 1208 of lower portion 1206.

The inside surface of hole 1140 is configured to receive lower portion 1206 until the line that defines the intersection 1230 of the outwardly flaring external surface 1208 and the inwardly flaring external surface 1218 is disposed immediately adjacent to the rim of hole 1140. The intersection 1230 is disposed axially above the top surface of the fixture a distance of between 0.0 and 1.5 mm around the entire periphery of the implant. This includes on the facial and lingual sides shown in FIG. 167 (illustrating the minima 1236, 1238 of the intersection 1230 disposed this distance above the top surface of the fixture), and on the mesial and distal sides shown in FIG. 168 (illustrating the maxima 1232, 1234 of the intersection 1230 disposed this distance above the top surface of the fixture), and at all places in between.

The top surface of the fixture extends radially outward from the intersection 1230 a distance of between 0.5 and 1.5 mm around the entire periphery of the implant. This includes on the mesial and distal sides (shown in FIG. 168) and on the facial and lingual sides (shown in FIG. 167) and at all places in between.

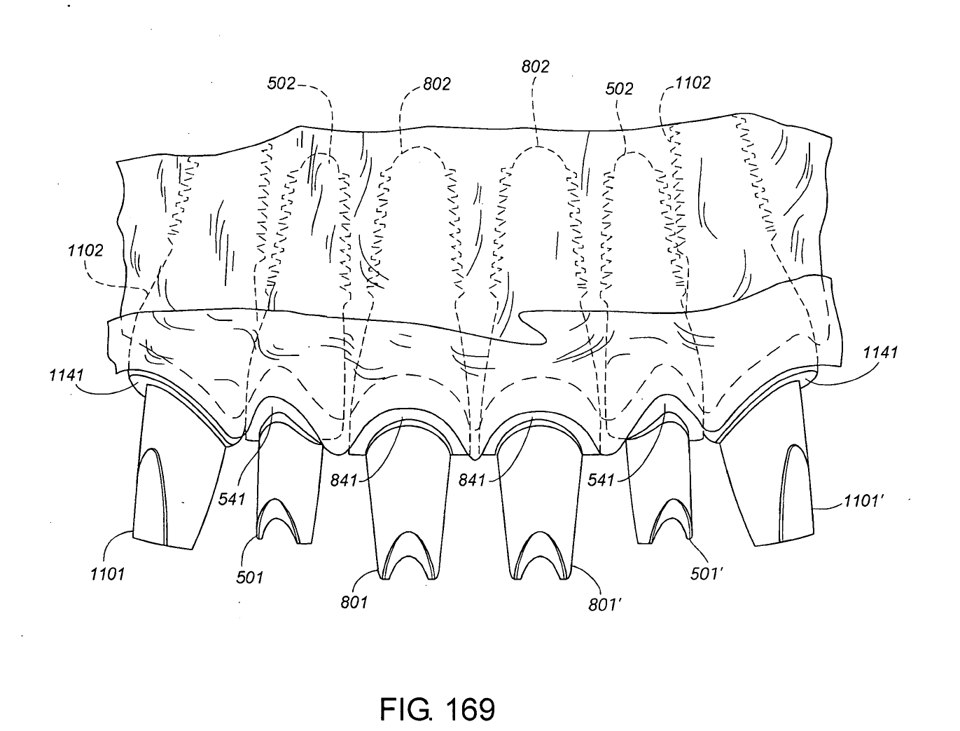

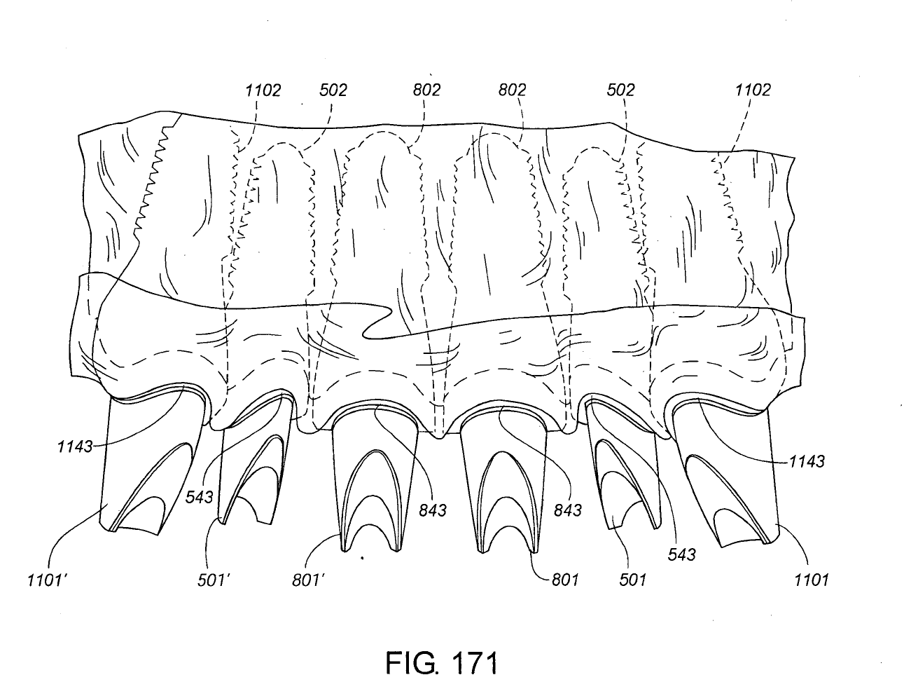

FIGS. 169, 170, and 171 are facial, bottom (incisal) and lingual views, respectively, of a maxilla having a plurality of embedded implants. These implants include a #6 cuspid implant 1101, a #7 lateral incisor implant 501, a #8 central incisor implant 801, a #9 central incisor implant 801′, a #10 lateral incisor implant 501′, and a #11 cuspid implant 1101′.

Implant 1101 is illustrated and described above in FIGS. 147-160 and (assembled) in FIGS. 167-168. Implant 501 is illustrated above in FIGS. 116-130 and (assembled) in FIGS. 163-164. Implant 801 is illustrated above in FIGS. 131-146 and (assembled) in FIGS. 165-166. Implants 1101′, 501′ and 801′ are mirror images of and are configured identically to implants 1101, 501, and 801, respectively.

FIGS. 169-171 illustrate a system of implants held in a predetermined orientation in a patient's mouth and showing the relative location of each implant with respect to its adjacent implants. In FIGS. 169-171, six implants are shown, each of the six being disposed in a healed maxilla—a maxilla in which the bone and soft tissues have grown into and around the implants. Each implant is positioned in a predetermined spatial relationship to the adjacent implants on either side. The implants are placed in osteotomies in the patient's mouth that are formed in the apertures of missing teeth. Each of the implants 1101, 501, 801, 801′, 501′, 1101′ is placed in a suitably enlarged hole from which a tooth has been removed, either intentionally or accidentally. Thus, their locations correspond to the locations of pre-existing teeth and are disposed in the same positions as those teeth along the curvature of the dental arch of the maxilla.

While a system of six implants is described herein, it should be understood that six implants may be used in a single patient's mouth in order to use the system of implants described herein. However any one or all of the implants from the system may be used. Furthermore, a system of implants may also include more than the six implants shown here.

The implants of the system are not placed and oriented accidentally or at random, but are located in known and predetermined positions with respect to each other (i.e. predetermined relative positions), such that the contours and surface features of the implants mimic the contours of the teeth that the implants replace, and the contours and surface features of adjacent implants are in specific predetermined positions with respect to each other. The predetermined relative positions with respect to each other are predetermined relative positions within the preexisting holes.

The implants are placed at predetermined positions within the apertures created by the removal of teeth to align the implants with respect to each other in a manner that encourages the growth of soft tissue around the implants in a specific configuration. One does not merely insert an implant until it bottoms out in the hole. Instead, one places an implant in the aperture from which a tooth has been removed, inserts it in that aperture to a predetermined depth that positions it in that aperture relative to an adjacent implant or tooth in a preferred position, and particularly, in the predetermined relative positions described below and illustrated in FIGS. 169-171.

The predetermined relative position may include a predetermined front to back (facial to lingual) relative position as well as a predetermined relative height (depth) within the implant's aperture with respect to the adjacent implant or aperture.

Each of the implants 1101, 501, 801, 801′, 501′, 1101′ of the system is specially configured to match the characteristics of the tooth it replaces. These characteristics include the mesial/distal width of the tooth it replaces, the facial/lingual width of the tooth it replaces, the contours of the CRJ of the tooth it replaces, and the location of the CRJ of the teeth on either side.

Each of the implants 1101, 501, 801, 801′, 501′, 1101′ comprises a fixture with an overall mesial/distal width that is less than the facial/lingual width of that fixture.

Each of the implants 1101, 501, 801, 801′, 501′, 1101′ comprises an abutment with an overall mesial/distal width that is less than the facial/lingual width of that abutment.

Each of the implants 1101, 501, 801, 801′, 501′, 1101′ comprises a fixture with a top surface having local minima on the lingual and facial sides and local maxima on the mesial and distal sides.

When installed in the osteotomies in the patient's mouth as shown in FIGS. 169-171, the local maxima 844 of the two central incisor implants 801, 801′ are disposed at the same height (i.e. The same incisal position) and maxima 844 are located directly adjacent to each other in the facial-lingual directions.

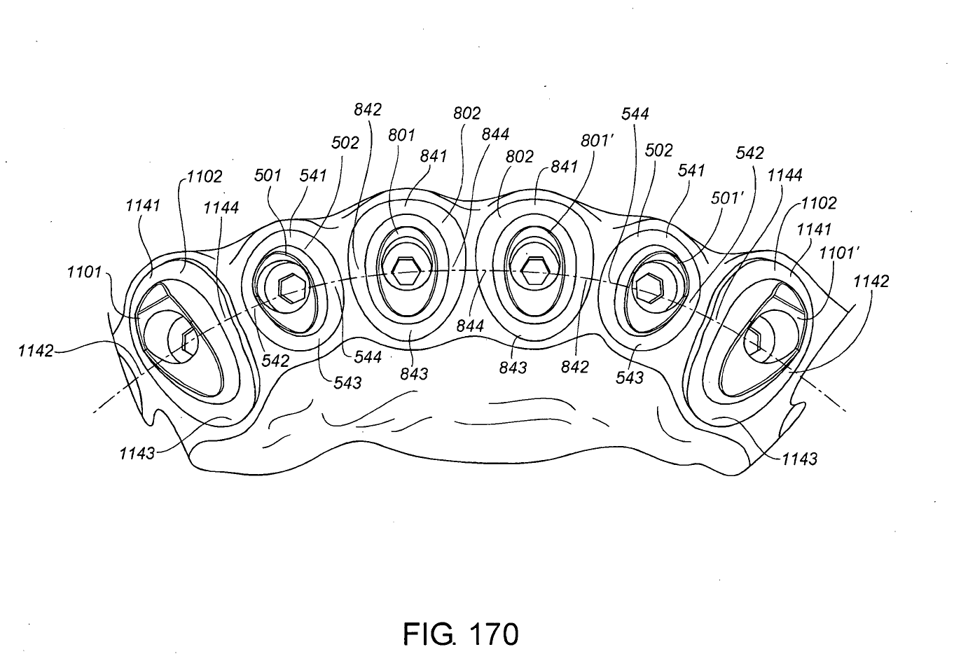

The adjacent maxima 842, 544 of the adjacent implant pairs 801, 501, and 801′, 501′ are offset slightly such that the maxima 544 of implants 501, 501′ are disposed more cervically along the longitudinal axis of the implant than the maxima 842 of the implants 801, 801′ and 842, 544 are located directly adjacent to each other in the facial-lingual direction (see FIG. 170).

The adjacent maxima 542,1144 of the adjacent implant pairs 501, 1101 and 501′, 1101′ are offset slightly such that the maxima 542 of implants 501, 501′ are disposed more cervically along the longitudinal axis of the implant than the maxima 1144 of the implants 1101, 1101′ and maxima 542, 1144 are located directly adjacent to each other in the facial-lingual direction.

The overall length of implants 801, 801′, 1101, 1101′ in a direction parallel to the longitudinal axis of the implants is greater than the overall length of implants 501, 501′.

The overall width of the implants 501, 501′ in the lingual-facial direction is less than the overall width of the implants 1101, 1101′, 801, 801′ in the lingual-facial direction.

The overall width of the implants 501, 501′ in the mesial-distal direction is less than the overall width of the implants 1101, 1101′, 801, 801′ in the mesial-distal direction.

The incisal height of implants 501, 501′ is less than the incisal height of implants 1101, 1101′, 801, 801′.

Implants 1101, 501, 801, 801′, 501′, and 1101′ are mounted with respect to each other in the maxilla such that the maxima 542, 544, 842, 844, 1142, 1144 define an arc, indicated by the dash-dot line in FIG. 170. This arc substantially follows the curvature of the dental arch of the maxilla.

Implants 1101, 1101′, 801, 801′ extend farther forward (i.e. in the facial direction) from their maxima than implants 501, 501′ extend forward from their maxima. Similarly, since the maxima follow the curvature of the dental arch of the maxilla, implants 1101, 1101′, 801, 801′ extend farther forward (i.e. in the facial direction) from the curvature of the dental arch of the maxilla than implants 501, 501′ extend forward from curvature of the dental arch of the maxilla.

Having described many alternative embodiments, it will become apparent that various modifications can be made without departing from the scope of the invention as defined in the accompanying claims.

We claim:

1. An oral implant for mounting in a patient's maxilla or mandible, comprising:
an abutment having a longitudinal axis, the abutment having a first portion extending upward from a junction line and a second portion extending downward from the junction line; wherein the junction line defines the intersection between the first and second portions and extends circumferentially about the entire periphery of the abutment;
wherein the first portion has a surface that extends about the entire periphery of the abutment, said surface terminating at the junction line, said surface further tapering inwardly in a direction extending upwardly from the junction line; and
wherein the second portion has a surface that extends about the entire periphery of the abutment, said surface terminating at the junction line, said surface further tapering inwardly in a direction extending downwardly from the junction line; and
a fixture having a longitudinal axis, the fixture being configured to be embedded in the patient's maxilla or mandible;
wherein the fixture has a top surface with an aperture therein, said aperture extending downwardly into the fixture and tapering inwardly in a direction extending downwardly into the fixture.

2. The implant of claim 1, wherein the surface of the first portion of the abutment tapers inwardly at an angle of between 0.5 and 10 degrees with respect to the longitudinal axis and wherein the surface of the second portion of the abutment tapers inwardly at an angle of between 0.5 and 20 degrees with respect to the longitudinal axis.

3. The implant of claim 1, wherein an inward angle of taper of both a mesial and a distal side of the first portion with respect to the longitudinal axis of the abutment is between 0.5 and 6 degrees.

4. The implant of claim 1, wherein an inward angle of taper of a lingual side of the first portion with respect to the longitudinal axis of the abutment is between 6 and 8 degrees.

5. The implant of claim 1, wherein an inward angle of taper of a facial side of the first portion with respect to the longitudinal axis of the abutment is between 6 and 8 degrees.

6. The implant of claim 1, wherein an inward angle of taper of a facial side of the second portion with respect to the longitudinal axis of the abutment is between 10 and 20 degrees.

7. The implant of claim 1, wherein an inward angle of taper of a lingual side of the second portion with respect to the longitudinal axis of the abutment is between 10 and 20 degrees.

8. The implant of claim 1, wherein an inward angle of taper of both a mesial and a distal side of the second portion with respect to the longitudinal axis of the abutment is between 0.5 and 10 degrees.

9. The implant of claim 1 wherein the junction line is higher on both the mesial side and the distal side than it is on both the lingual and facial sides.

10. The implant of claim 1 wherein the top edge of the aperture is between 0.0 and 1.5 mm below the junction line around substantially all the periphery of the abutment.

11. The implant of claim 1, wherein the top surface of the fixture extends radially outward from the abutment a relatively constant distance of between 0.5 and 1.5 mm about the complete periphery of the fixture.

12. The implant of claim 1, wherein the abutment defines a through hole extending through the abutment with a longitudinal axis coaxial with the longitudinal axis of the abutment.

13. The implant of claim 12, wherein the through hole has an internal shoulder axially disposed above a minima of the junction line and below a maxima of the junction line, wherein a threaded aperture is disposed at the bottom of the aperture in the fixture, and further wherein the implant further comprises a threaded fastener having a head abutting the shoulder and a threaded portion threaded into the threaded aperture.

14. The implant of claim 1 wherein the second portion of the abutment has a first plurality of nodes and the first portion of the abutment has a second plurality of nodes and further wherein the first plurality of nodes are aligned with the second plurality of nodes at the junction line.

15. The implant of claim 14 wherein the first portion of the abutment has a generally elliptical axial cross section and the second portion of the abutment has a generally elliptical axial cross section.

16. The implant of claim 15 wherein the major axes of the generally elliptical cross sections of both the first and second portions extend in a lingual-facial direction.

17. The implant of claim 16, wherein the junction line has peaks disposed at the mesial and distal sides of the abutment and valleys disposed at the lingual and facial sides of the abutment.

18. The implant of claim 1, wherein an angle between the first portion and the second portion on both a mesial and a distal side of the abutment is between 115 and 180 degrees, wherein the angle lies in a plane that includes the longitudinal axis.

19. The implant of claim 1, wherein an angle between the first portion and the second portion on the lingual side of the abutment is between 135 and 170 degrees, wherein the angle lies in a plane that includes the longitudinal axis.

20. The implant of claim 1, wherein an angle between the first portion and the second portion on the facial side of the abutment is between 135 and 175 degrees, wherein the angle lies in a plane that includes the longitudinal axis.

21. The implant of claim 1, wherein the fixture has a lower portion configured to be received in an osteotomy to a first depth, the lower portion defining at least one longitudinal groove extending substantially the entire length of the lower portion.

22. The implant of claim 1, wherein the abutment defines a facial plane extending from the top of the abutment down a facial side of the abutment.

23. The implant of claim 1, wherein the abutment defines a lingual plane extending from the top of the abutment down a lingual side of the abutment.

24. The implant of claim 1, wherein the aperture of the fixture has a bottom, and further wherein a threaded aperture extends longitudinally into the bottom of the aperture, and further wherein the threaded aperture has a flat bottom.

25. The implant of claim 24, wherein the fixture has threads on its outer surface, said threads extending upward, said threads having an upper terminus below the flat bottom of the threaded aperture.

26. The implant of claim 1, wherein a top surface of the fixture defines at least one maximum and at least one minimum, and a hole extending through the abutment has an internal shoulder axially disposed above the at least one minimum of the top surface and below the at least one maximum of the top surface.

27. A system of implants for implantation into a maxilla in a plurality of tooth apertures previously occupied by natural teeth, the system comprising:
a first implant having a fixture with an upper surface defining a first mesial maximum, a first distal maximum, a first facial minimum, and a first lingual minimum;
a second implant having a fixture with an upper surface defining a second mesial maximum, a second distal maximum, a second facial minimum, and a second lingual minimum;
wherein the first implant is configured to be disposed in a first tooth aperture, wherein the second implant is configured to be disposed in a second tooth aperture,
wherein the first tooth aperture is immediately adjacent to and mesial to the second tooth aperture, and further
wherein the first and second implants are configured to be held in predetermined relative positions with respect to each other within their respective apertures when they are fixed in a maxilla.

28. The system of implants of claim 27, wherein the first implant is configured to be received in a central incisor aperture, and wherein the second implant is configured to be received in a lateral incisor aperture when the first and second implants are in said predetermined relative positions.

29. The system of implants of claim 28, wherein the first distal maximum is higher than the second mesial maximum when the first and second implants are in said predetermined relative positions.

30. The system of implants of claim 28, wherein the overall width in a facial-lingual direction of the first implant is greater than the overall width in a facial-lingual direction of the second implant when the first and second implants are in said predetermined relative positions.

31. The system of implants of claim 28, wherein the first implant extends farther forward in a facial direction than the second implant when the first and second implants are in said predetermined relative positions.

32. The system of implants of claim 28, wherein the overall width in a mesial-distal direction of the first implant is greater than the overall width in a mesial-distal direction of the second implant when the first and second implants are in said predetermined relative positions.

33. The system of implants of claim 28, wherein the first implant extends farther in a lingual direction than the second implant when the first and second implants are in said predetermined relative positions.

34. The system of implants of claim 27, wherein the first implant is configured to be received in a lateral incisor aperture, and wherein the second implant is configured to be received in a cuspid aperture when the first and second implants are in said predetermined relative positions.

35. The system of implants of claim 34, wherein the first distal maximum is lower than the second mesial maximum when the first and second implants are in said predetermined relative positions.

36. The system of implants of claim 34, wherein the overall width in a facial-lingual direction of the first implant is less than the overall width in a facial-lingual direction of the second implant when the first and second implants are in said predetermined relative positions.

37. The system of implants of claim 34, wherein the second implant extends farther forward in a facial direction than the first implant when the first and second implants are in said predetermined relative positions.

38. The system of implants of claim 34, wherein the overall width in a mesial-distal direction of the first implant is less than the overall width in a mesial-distal direction of the second implant when the first and second implants are in said predetermined relative positions.

39. The system of implants of claim 34, wherein the second implant extends farther in a lingual direction than the first implant when the first and second implants are in said predetermined relative positions.

40. The system of implants of claim 27, wherein an overall width of the first implant in the facial-lingual direction is greater than an overall width of the first implant in the mesial-distal direction, and further wherein an overall width of the second implant in the facial-lingual direction is greater than an overall width of the second implant in the mesial-distal direction when the first and second implants are in said predetermined relative positions.

41. A system of implants for implantation into a maxilla in a plurality of tooth apertures previously occupied by natural teeth, the system comprising:
a first implant having a fixture with an upper surface defining two first maxima, said first maxima being disposed on opposite sides of the implant along a mesial/distal axis, a first facial minimum and a second lingual minimum;
a second implant having a fixture with an upper surface defining two second maxima, said second maxima being disposed on opposite sides of the implant along a mesial/distal axis, a second facial minimum, and a second lingual minimum;
wherein the first implant is configured to be disposed in a first tooth aperture,
wherein the second implant is configured to be disposed in a second tooth aperture,
wherein the first tooth aperture is immediately adjacent to the second tooth aperture, and further
wherein the first and second implants are configured to be held in predetermined relative positions with respect to each other within their respective apertures when they are fixed in a maxilla.

42. The system of implants of claim 41, wherein the first implant is configured to be received in a left central incisor aperture, and wherein the second implant is configured to be received in a right central incisor aperture when the first and second implants are in said predetermined relative positions.

43. The system of implants of claim 41, wherein one of the first maxima is adjacent to one of the second maxima and further wherein the two adjacent maxima are at the same height when the first and second implants are in said predetermined relative positions.

44. The system of implants of claim 41, wherein the overall width in a facial-lingual direction of the first implant is the same as the overall width in a facial-lingual direction of the second implant when the first and second implants are in said predetermined relative positions.

45. The system of implants of claim 42, wherein the first implant extends the same distance forward in a facial direction as the second implant when the first and second implants are in said predetermined relative positions.

46. The system of implants of claim 42, wherein the overall width in a mesial-distal direction of the first implant is the same as the overall width in a mesial-distal direction of the second implant when the first and second implants are in said predetermined relative positions.

47. The system of implants of claim 42, wherein the first implant extends the same distance in a lingual direction as the second implant when the first and second implants are in said predetermined relative positions.

48. The system of implants of claim 43, wherein another of the first maxima and another of the second maxima are disposed at different heights from said adjacent ones of said first maxima.
